(19) United States
(12) Patent Application Publication
(10) Pub. No.: US 2025/0110571 A1
(43) Pub. Date: Apr. 3, 2025

(54) Devices, Methods, and Graphical User Interfaces for Providing Feedback Relating to Real-World Objects

(71) Applicant: Apple Inc., Cupertino, CA (US)

(72) Inventors: William A. Sorrentino, III, Mill Valley, CA (US); Taylor G. Carrigan, San Francisco, CA (US); Agatha Y. Yu, Oakland, CA (US); Alan C. Dye, San Francisco, CA (US); Darius A. Satongar, Staffordshire (GB); Hugo D. Verweij, Portola Valley, CA (US); Jack Schulze, Los Altos, CA (US); James N. Jones, San Francisco, CA (US); Jamie L. Myrold, Chicago, IL (US); Jonathan A. Topf, London (GB); Joseph A. Malia, Isle of Wight (GB); Myra Haggerty, San Mateo, CA (US); Timo Arnall, San Francisco, CA (US)

(21) Appl. No.: 18/895,177

(22) Filed: Sep. 24, 2024

Related U.S. Application Data
(60) Provisional application No. 63/541,751, filed on Sep. 29, 2023.

(51) Int. Cl. G06F 3/01; G06F 3/16

(52) U.S. Cl. CPC G06F 3/017; G06F 3/012; G06F 3/165

(57) ABSTRACT

While outputting audio content, a wearable audio output device detects a gesture performed by a hand of a user of the wearable audio output device. In response to detecting the gesture, the wearable audio output device performs a first operation corresponding to the gesture in accordance with a determination that the gesture is detected within a respective distance of a side of the user's head and is a first type of hand gesture determined based at least in part on a shape of the hand during performance of the gesture. In response to detecting the gesture, the wearable audio output device forgoes performing the first operation in accordance with a determination that the gesture is not the first type of hand gesture determined based at least in part on a shape of the hand during performance of the gesture.

### RELATED APPLICATIONS

This application claims priority to U.S. Provisional Patent Application No. 63/541,751, filed Sep. 29, 2023, which is hereby incorporated by reference in its entirety.

### TECHNICAL FIELD

This relates generally to ear-worn devices such as earbuds and headphones, including but not limited to ear-worn devices that provide feedback related to real-world objects, provide indication of alert conditions, adjust modification of ambient sound, perform operations corresponding to gestures, and/or provide feedback indicating that sensors are occluded.

### BACKGROUND

Audio output devices, including wearable audio output devices such as headphones and earphones, are widely used to provide audio outputs to a user. But conventional methods of providing audio outputs are cumbersome, inefficient, and limited. Additionally, conventional audio output devices are unable to detect and provide feedback about real-world objects or detect and respond to air gestures.

In some cases, conventional ear-worn audio output devices are incapable of detecting user gestures directed at real-world objects. Such conventional ear-worn audio output devices are unable to provide audio feedback corresponding to the real-world objects.

In some cases, wearable audio output devices are incapable of detecting alert conditions related to spatial context of a user. In other cases, the wearable audio output devices do not automatically provide audio feedback about the alert conditions and/or modify a magnitude of ambient sound from the physical environment (e.g., so that the user may better hear sounds related to the alert conditions). In some cases, the wearable audio output devices are incapable of detecting air gestures (e.g., hand gestures performed near the user's head). Such devices are unable to perform operations corresponding to the air gestures.

In some cases, wearable devices are incapable of determining that respective sensors are occluded (e.g., fully or partly occluded). In other cases, the wearable devices are unable to provide feedback to the user that the respective sensors are occluded.

In addition, conventional methods take longer and require more user interaction than necessary, thereby wasting energy and providing an inefficient human-machine interface. Conserving device energy is particularly important in battery-operated devices.

### SUMMARY

Accordingly, there is a need for wearable devices (e.g., wearable audio output devices, ear-worn devices, and/or other types wearable devices) and associated electronic devices with improved methods and interfaces for controlling and interacting with, such as providing feedback corresponding to real-world objects, alert conditions, and/or sensor occlusion, and/or performing operations responsive to air gestures. Such methods and interfaces optionally complement or replace conventional methods for controlling operation of wearable devices. Such methods and interfaces reduce the number, extent, and/or nature of the inputs from a user and produce a more efficient human-machine interface. For battery-operated systems and devices, such methods and interfaces conserve power and increase the time between battery charges.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device is, includes, and/or is in communication with a wearable audio output device (e.g., in-ear earphones, earbuds, over-ear headphones, etc.). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at an ear-worn audio output device that includes one or more sensors and one or more audio output components. The method includes detecting a user gesture via the one or more sensors of the ear-worn audio output device. The method also includes, in response to detecting the user gesture, in accordance with a determination that the user gesture is a first type of gesture and is directed to a first real-world object, providing first audio feedback corresponding to the first real-world object via the one or more audio output components, and, in accordance with a determination that the user gesture is the first type of gesture and is directed to a second real-world object, providing second audio feedback corresponding to the second real-world object via the one or more audio output components.

In accordance with some embodiments, a method is performed at a wearable audio output device. The method includes, while the wearable audio output device has a first physical arrangement relative to a respective body part of a user in which a magnitude of ambient sound from the physical environment is modified by the wearable audio output device to have a first ambient-sound audio level, detecting an alert condition relating to spatial context of the user. The method also includes, in response to detecting the alert condition: providing audio feedback about the alert condition and changing one or more properties of the wearable audio output device to modify the magnitude of ambient sound from the physical environment to have a second ambient-sound audio level that is louder than the first ambient-sound audio level.

In accordance with some embodiments, a method is performed at a wearable audio output device. The method includes, while outputting audio content, detecting a gesture performed by a hand of a user of the wearable audio output device. The method also includes, in response to detecting the gesture: in accordance with a determination that the gesture is detected within a respective distance of a side of the user's head and is a first type of hand gesture determined based at least in part on a shape of the hand during performance of the gesture, performing a first operation corresponding to the gesture, and, in accordance with a determination that the gesture is not the first type of hand gesture determined based at least in part on a shape of the hand during performance of the gesture, forgoing performing the first operation.

In accordance with some embodiments, a method is performed at a wearable device that includes one or more sensors. The method includes, while the wearable device is being worn by a user, detecting the occurrence of one or more events that indicate that the device is in a context in which a respective sensor of the one or more sensors could be used to perform a respective operation. The method also includes, in response to detecting the occurrence of the one or more events: in accordance with a determination that the respective sensor is occluded, providing feedback to the user indicating that the respective sensor is occluded, and, in accordance with a determination that the respective sensor is not occluded, performing the operation based on information detected by the respective sensor of the one or more sensors.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices that include or are in communication with one or more sensors, one or more input devices, and/or one or more audio output devices are provided with improved methods and interfaces for providing audio/haptic feedback, thereby increasing the effectiveness, efficiency, and user satisfaction with such devices. Such methods and interfaces may complement or replace conventional methods for providing audio/haptic feedback.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

Figure (“FIG.”) 1A is a block diagram illustrating a portable multifunction device with a touch-sensitive display in accordance with some embodiments.

FIG. 1B is a block diagram illustrating example components for event handling in accordance with some embodiments.

FIGS. 1C-1D illustrate various examples of a computer system in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIG. 3B illustrates physical features of an example wearable audio output device in accordance with some embodiments.

FIG. 3C is a block diagram of an example wearable audio output device in accordance with some embodiments.

FIG. 3D illustrates example audio control by a wearable audio output device in accordance with some embodiments.

FIG. 3E illustrates example audio control by another wearable audio output device in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5R illustrate example user interfaces and user interactions involving real-world objects and feedback from wearable devices in accordance with some embodiments.

FIGS. 6A-6H illustrate example user interactions involving real-world objects and feedback from wearable devices in accordance with some embodiments.

FIGS. 7A-7K illustrate example user interactions with wearable devices involving various alert conditions in accordance with some embodiments.

FIGS. 8A-8P illustrate example user interactions with wearable devices in accordance with some embodiments.

FIGS. 9A-9K illustrate example user interactions with wearable devices in accordance with some embodiments.

FIGS. 10A-10D are flow diagrams of a process for providing audio feedback related to real-world objects in accordance with some embodiments.

FIGS. 11A-11C are flow diagrams of a process for providing audio feedback about alert conditions in accordance with some embodiments.

FIGS. 12A-12D are flow diagrams of a process for performing operations in response to air gestures in accordance with some embodiments.

FIGS. 13A-13B are flow diagrams of a process for providing feedback indicating sensor(s) are occluded in accordance with some embodiments.

### DESCRIPTION OF EMBODIMENTS

As noted above, wearable devices, including wearable audio output devices such as headphones, earbuds, and earphones, are widely used to provide outputs to users. Many wearable devices are incapable of detecting user gestures (e.g., air gestures and/or gestures directed to real-world objects) and/or alert conditions. The methods, systems, and user interfaces/interactions described herein improve wearable device capabilities in multiple ways. For example, embodiments disclosed herein describe improved ways to obtain feedback about real-world objects and/or alert conditions at the wearable devices and to provide improved user interfaces for controlling the wearable devices.

The processes described below enhance the capabilities and operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

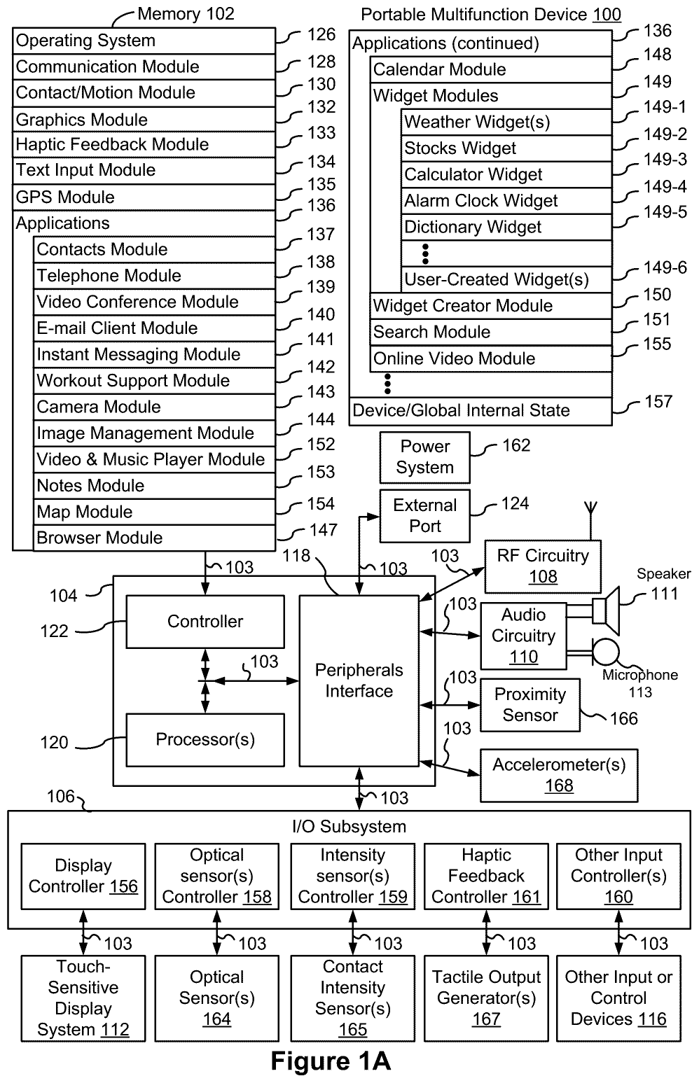

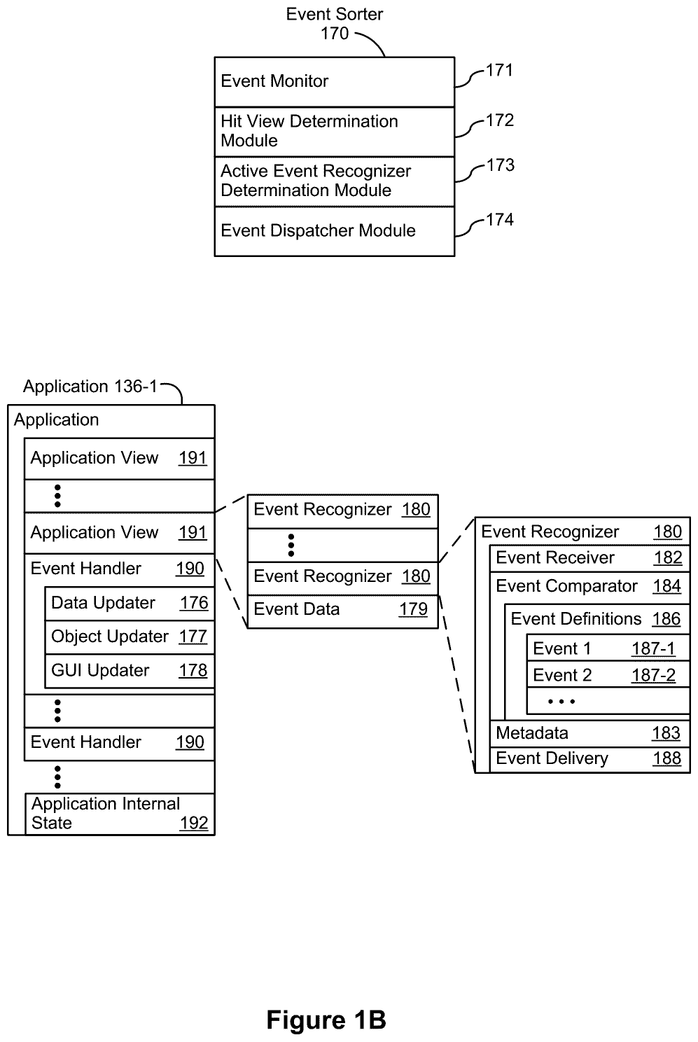

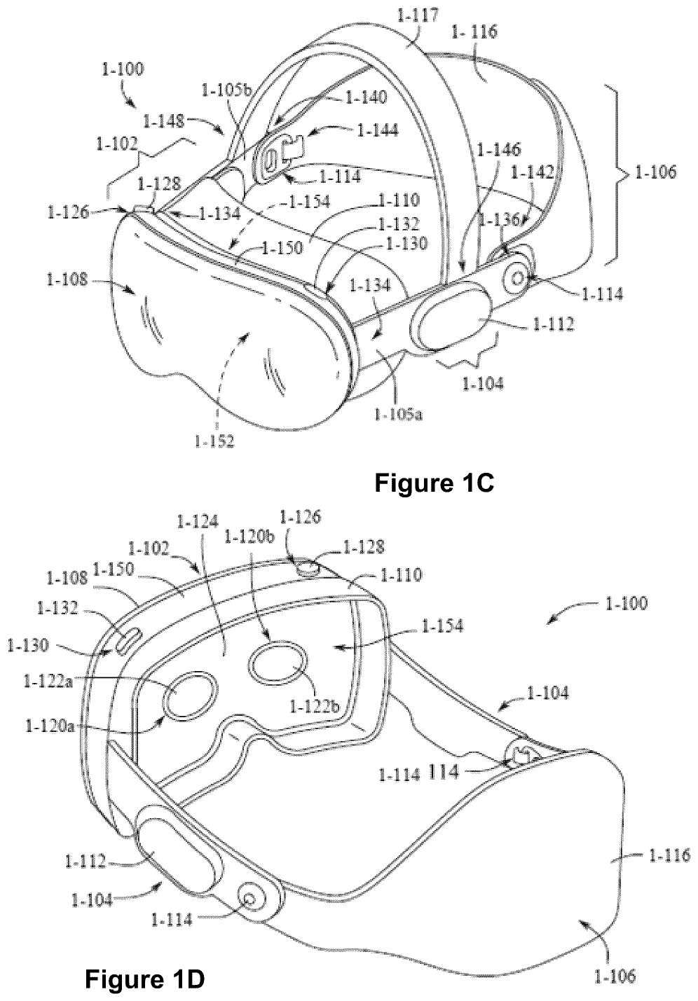

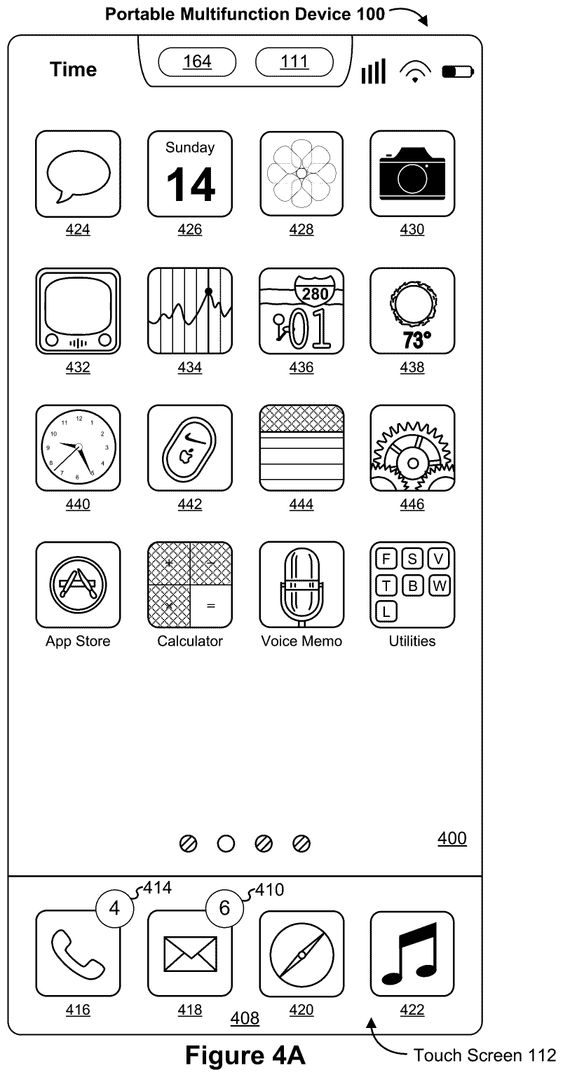

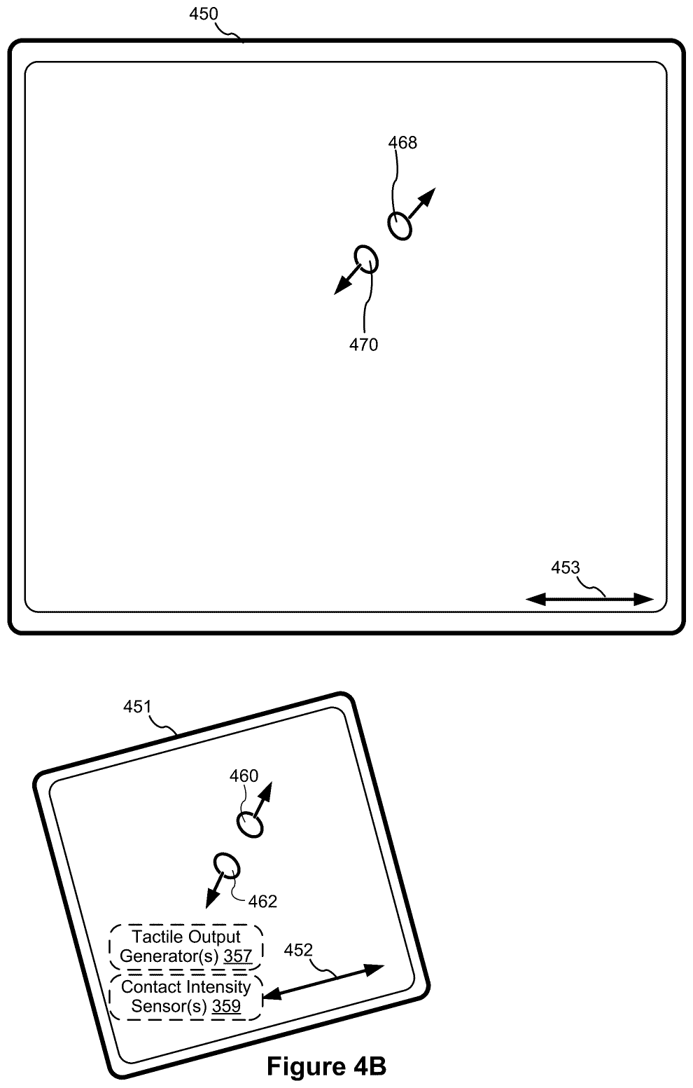

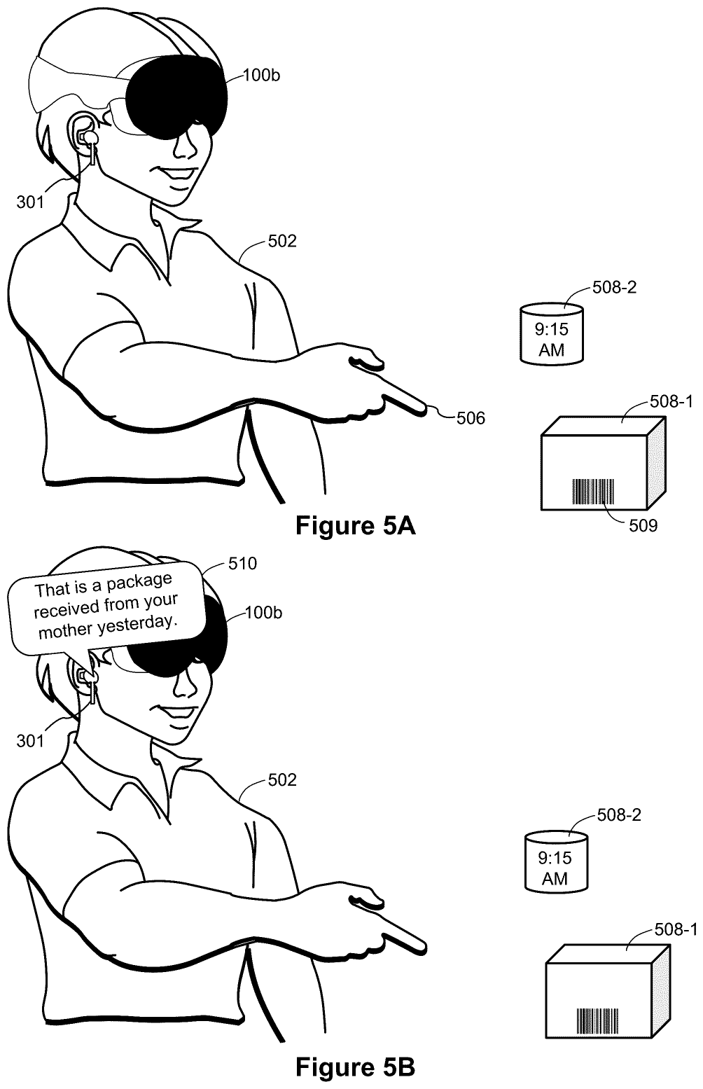

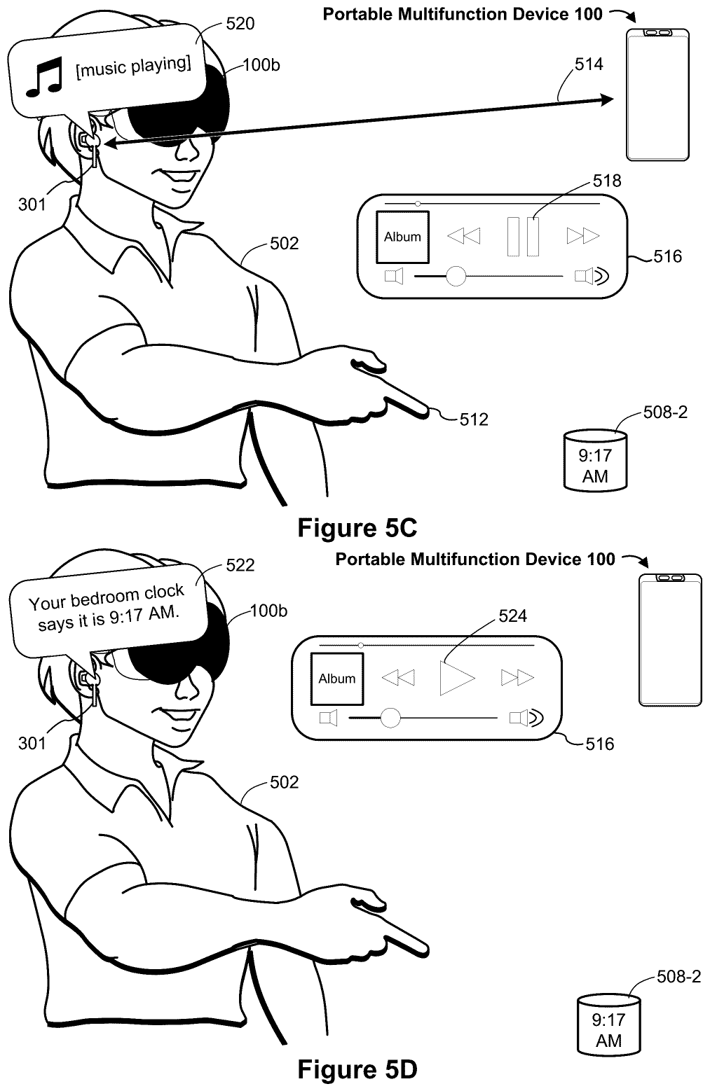

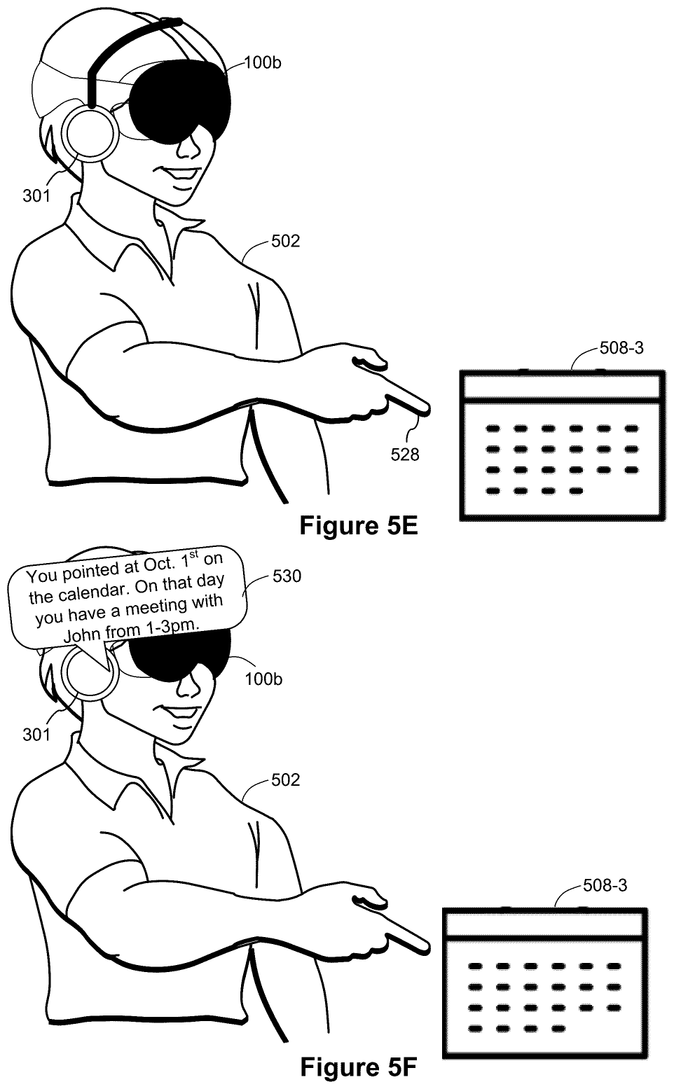

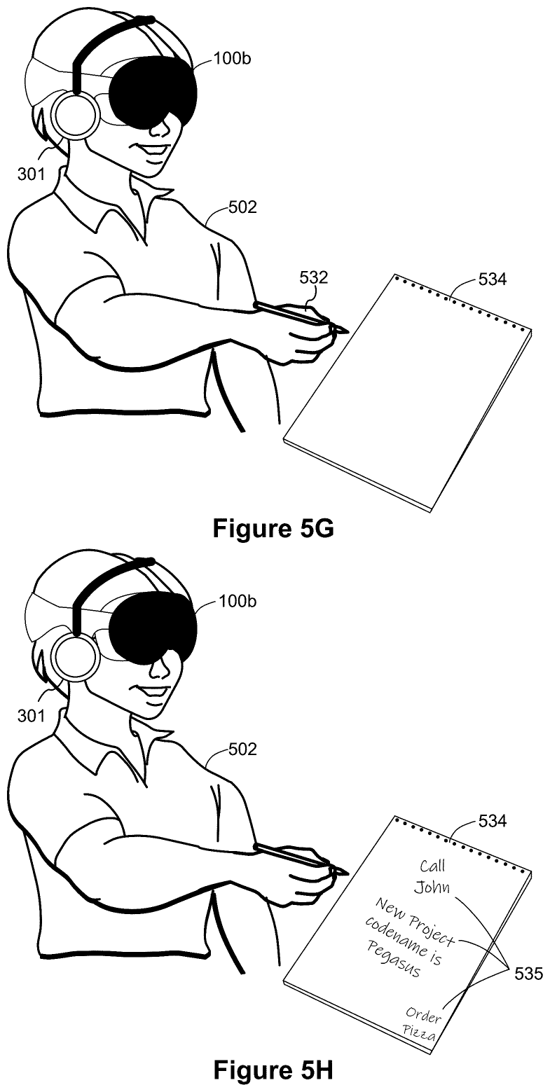

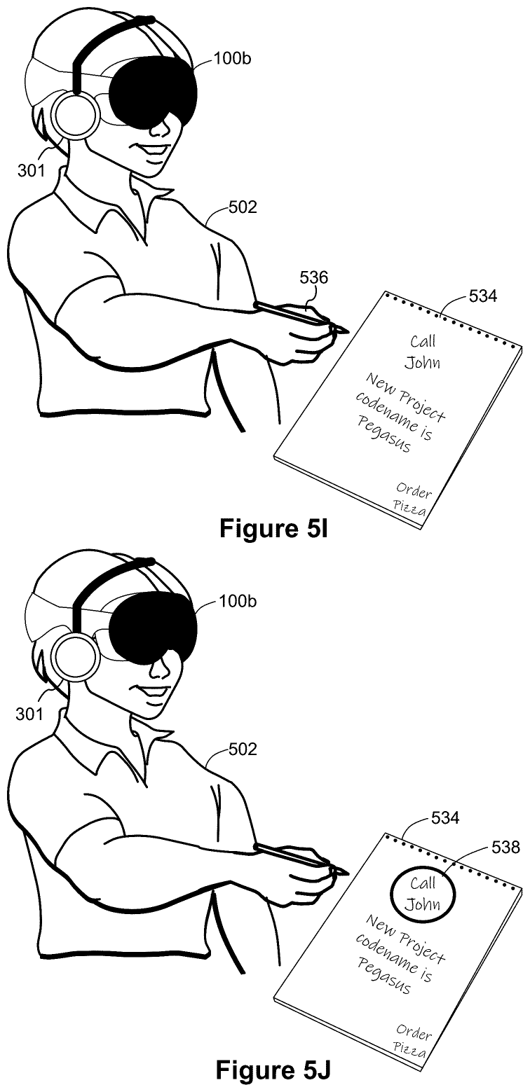

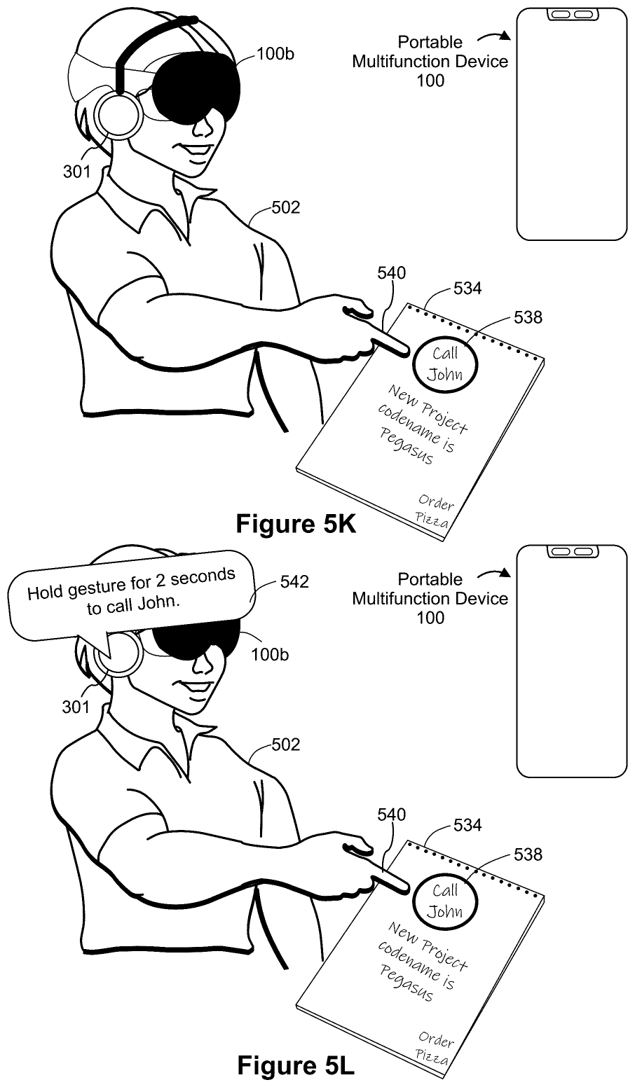

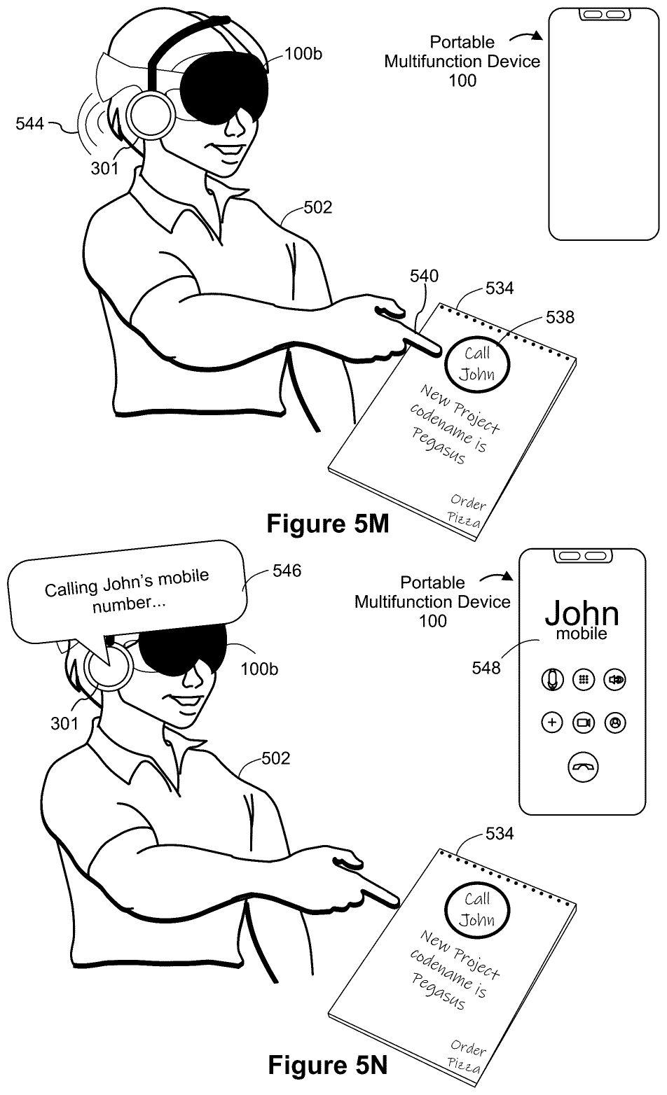

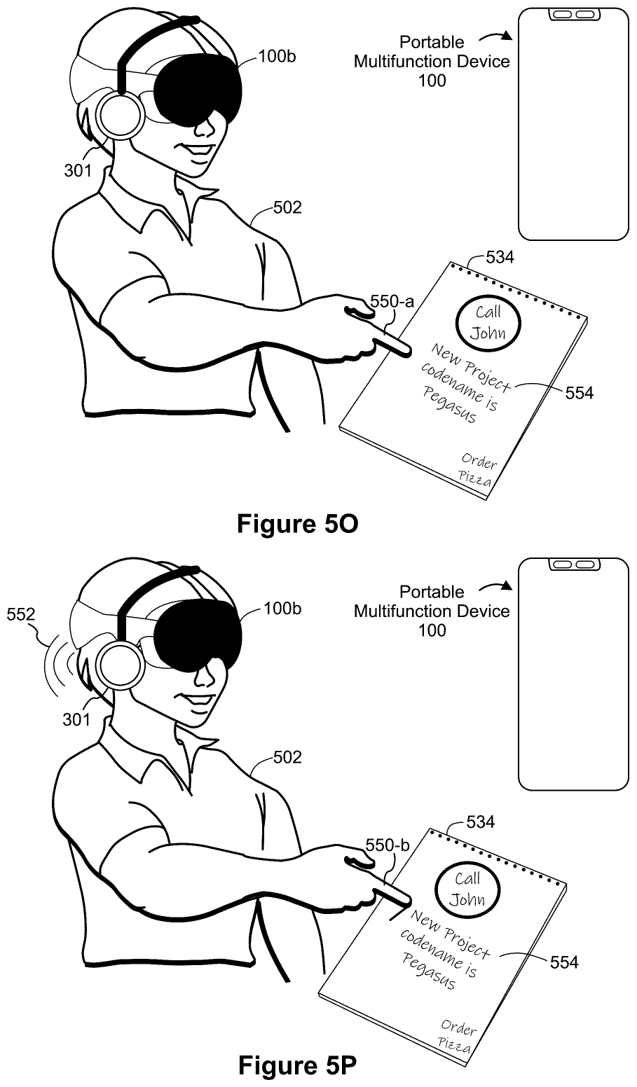

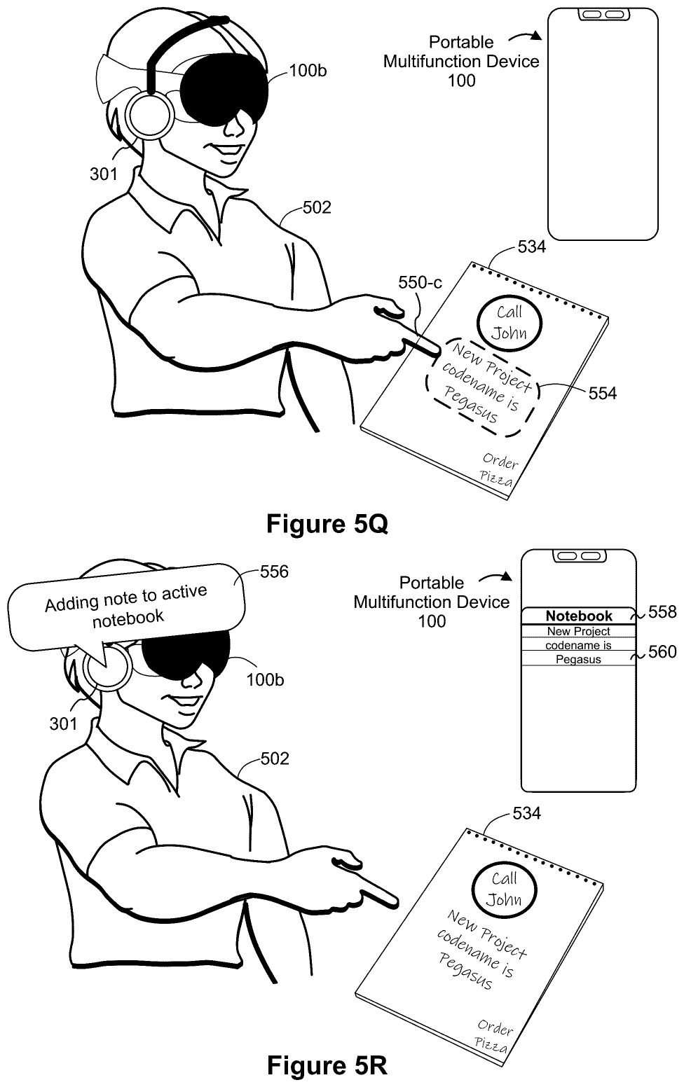

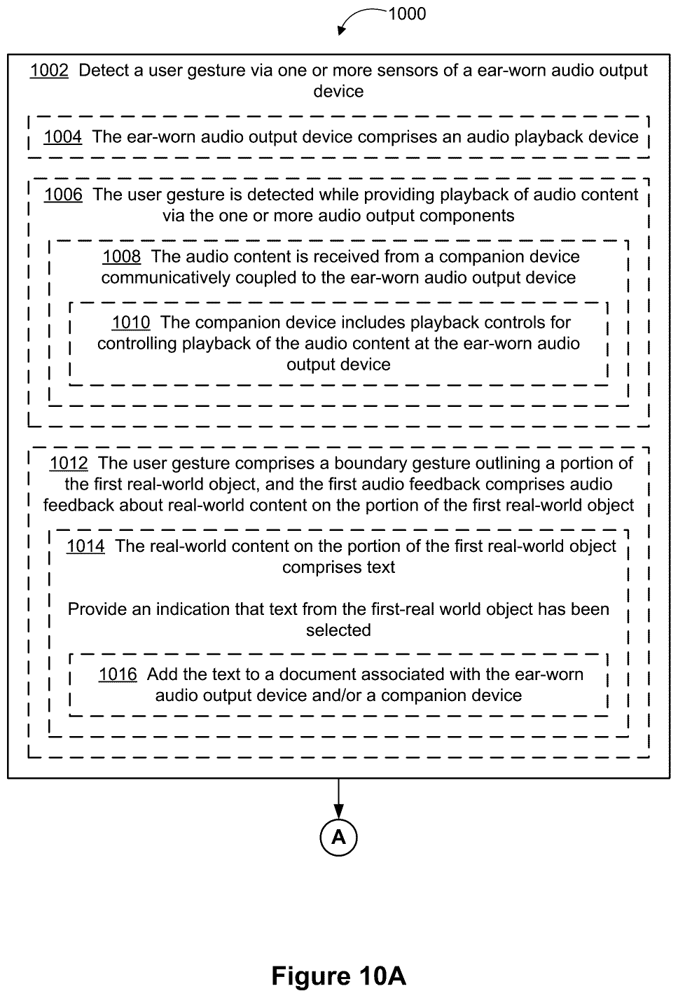

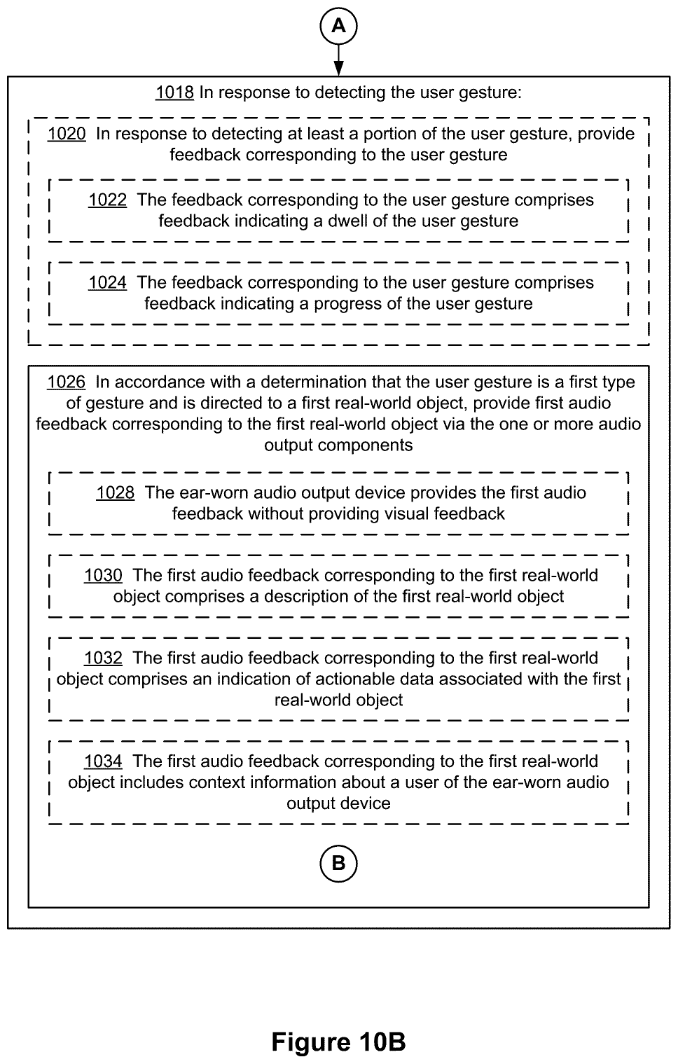

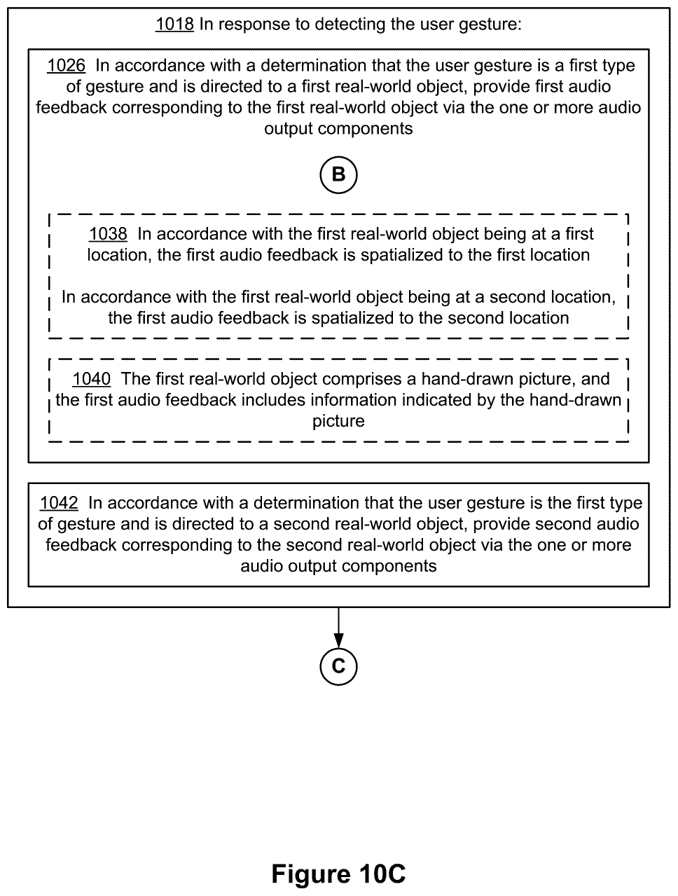

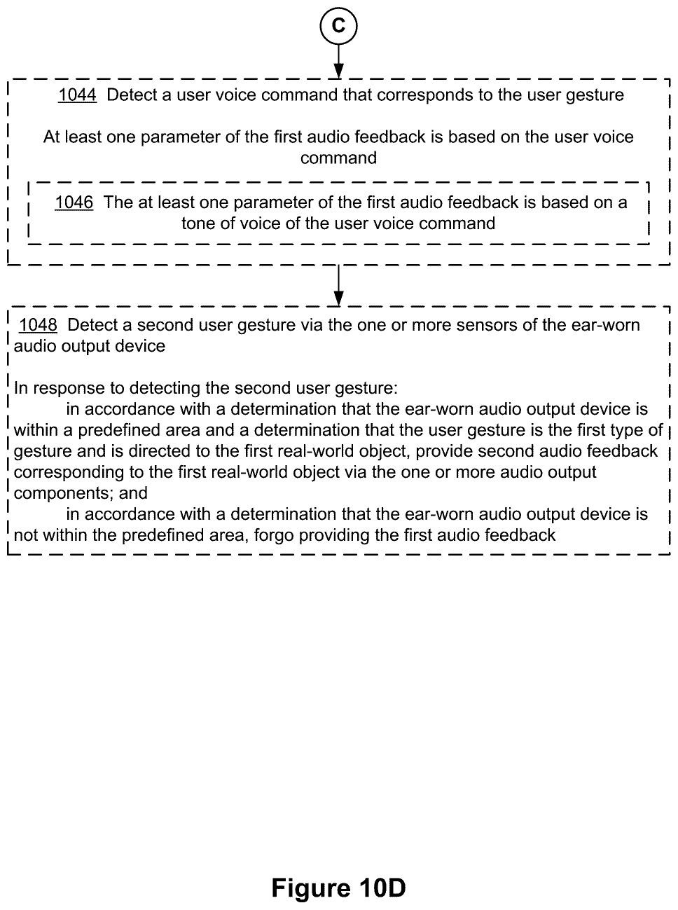

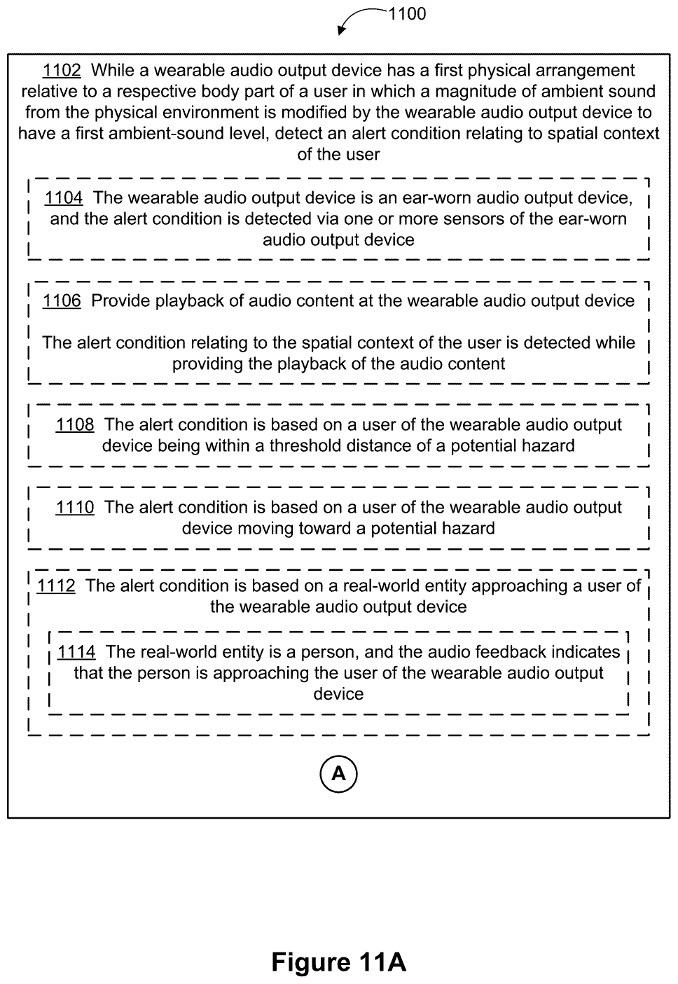

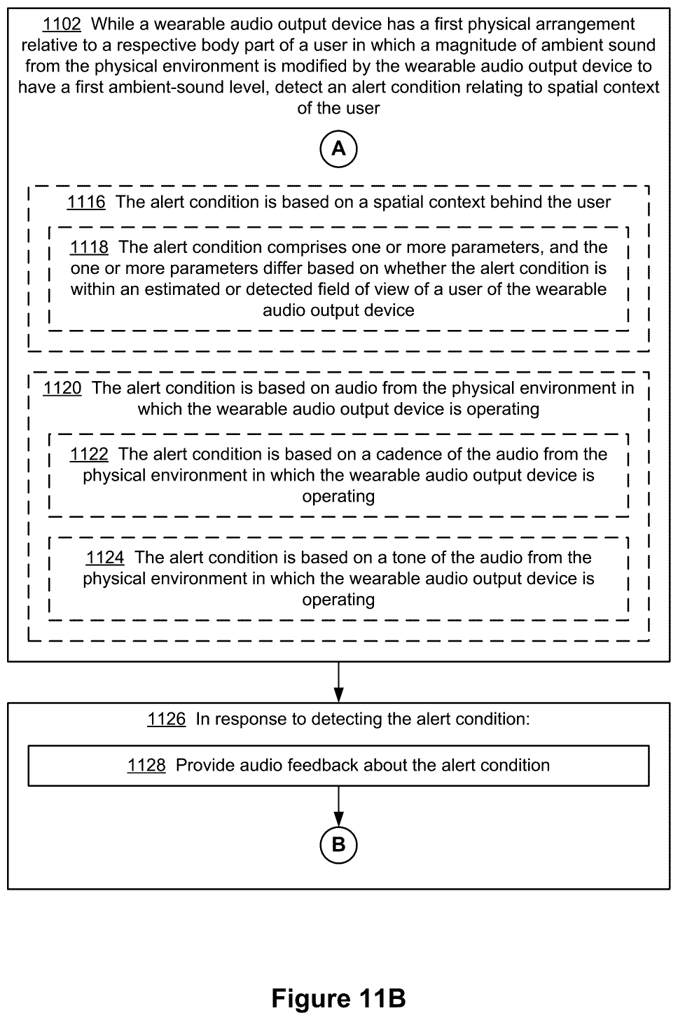

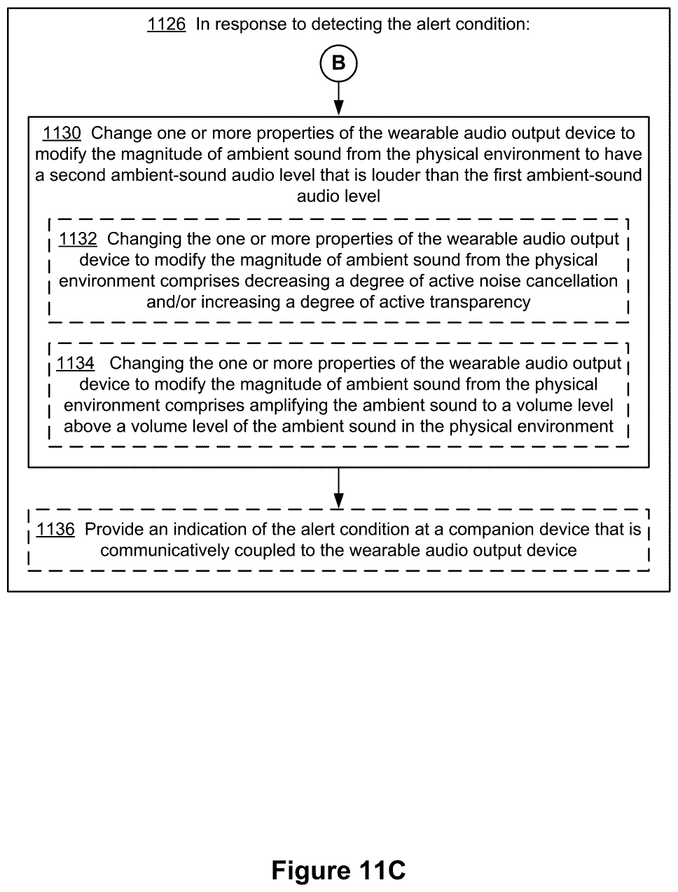

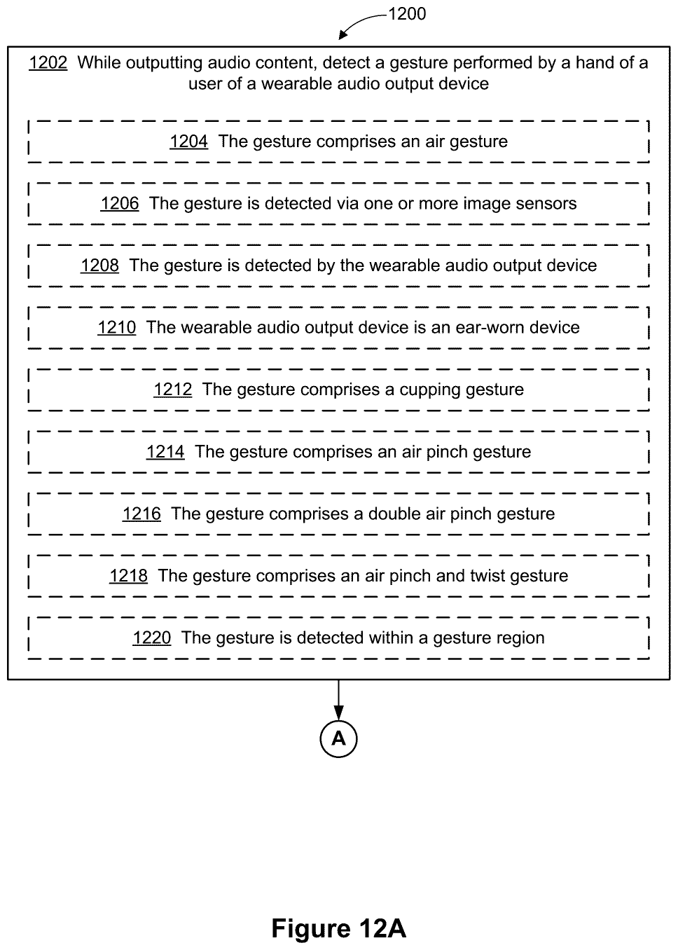

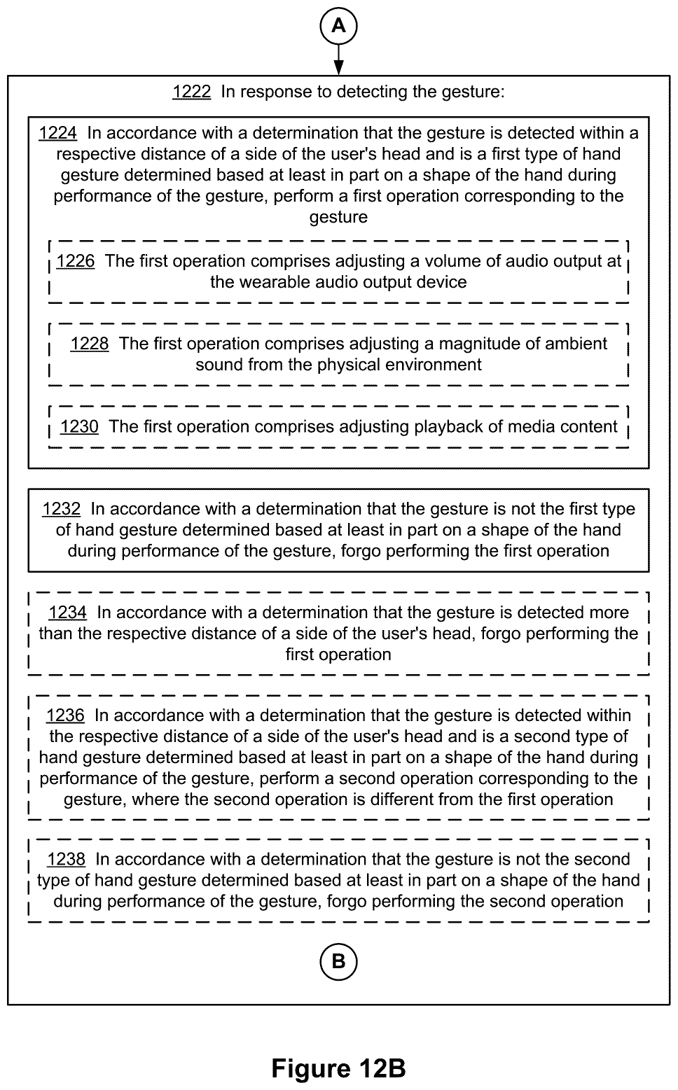

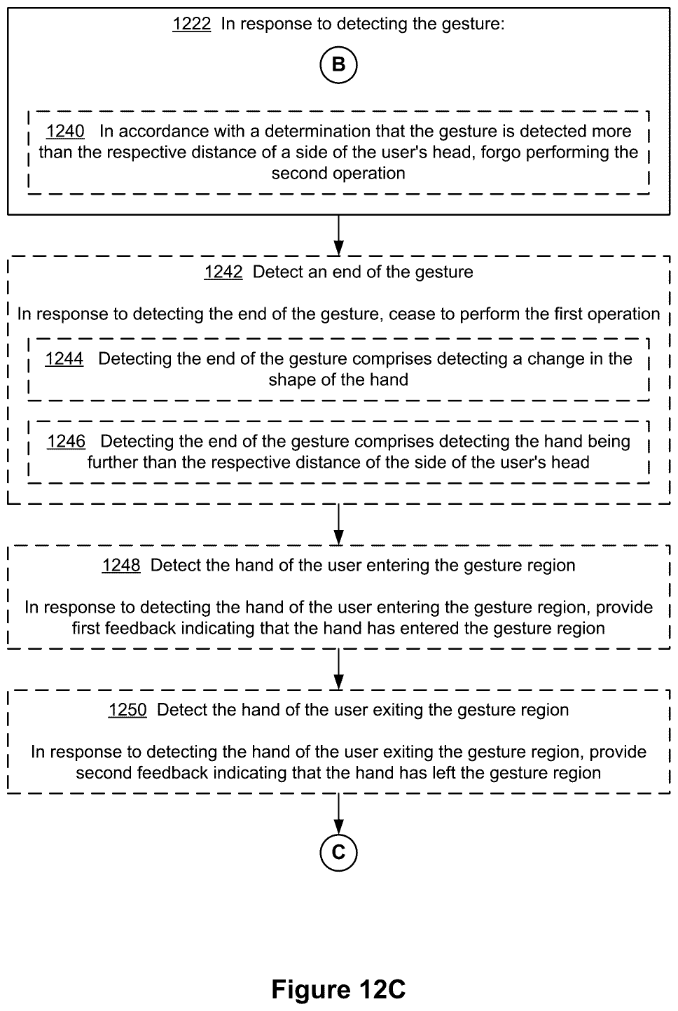

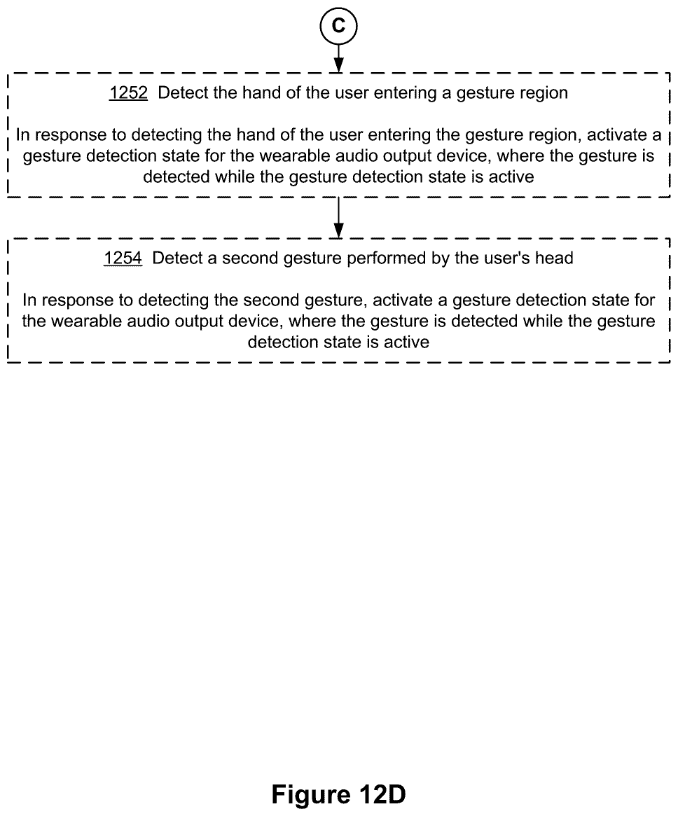

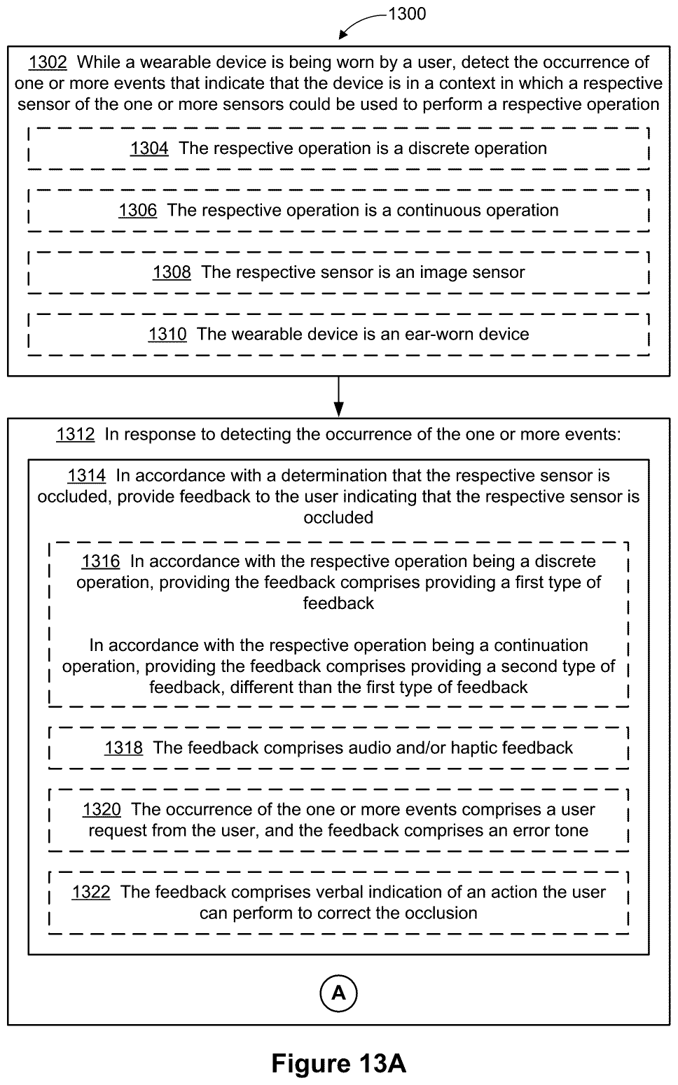

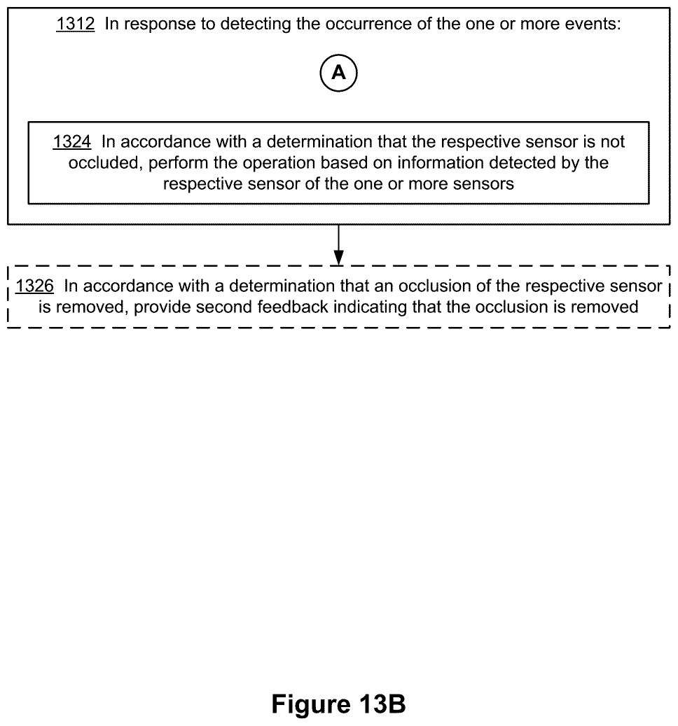

Below, FIGS. 1A-1D, 2, and 3A-3E provide a description of example devices. FIGS. 4A-4B, 5A-5R, 6A-6H, 7A-7K, 8A-8P, and 9A-9K illustrate example user interactions with wearable devices. FIGS. 10A-10D illustrate a flow diagram of a method of providing audio feedback related to real-world objects. FIGS. 11A-11C illustrate a flow diagram of a method of providing audio feedback about alert conditions. FIGS. 12A-12D illustrate a flow diagram of a method of performing operations in response to air gestures. FIGS. 13A-13B illustrate a flow diagram of a method of providing feedback indicating sensor(s) are occluded. The user interfaces in FIGS. 5A-5R, 6A-6H, 7A-7K, 8A-8P, and 9A-9K are used to illustrate the processes in FIGS. 10A-10D, 11A-11C, 12A-12D, and 13A-13B.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random-access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

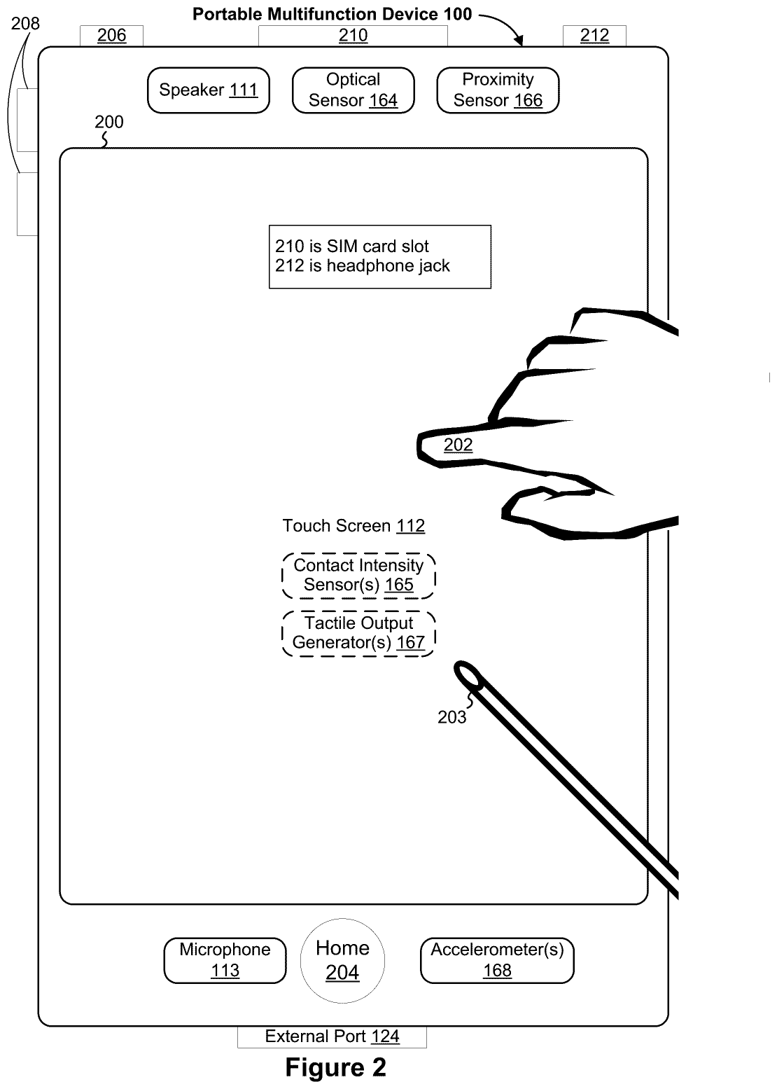

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

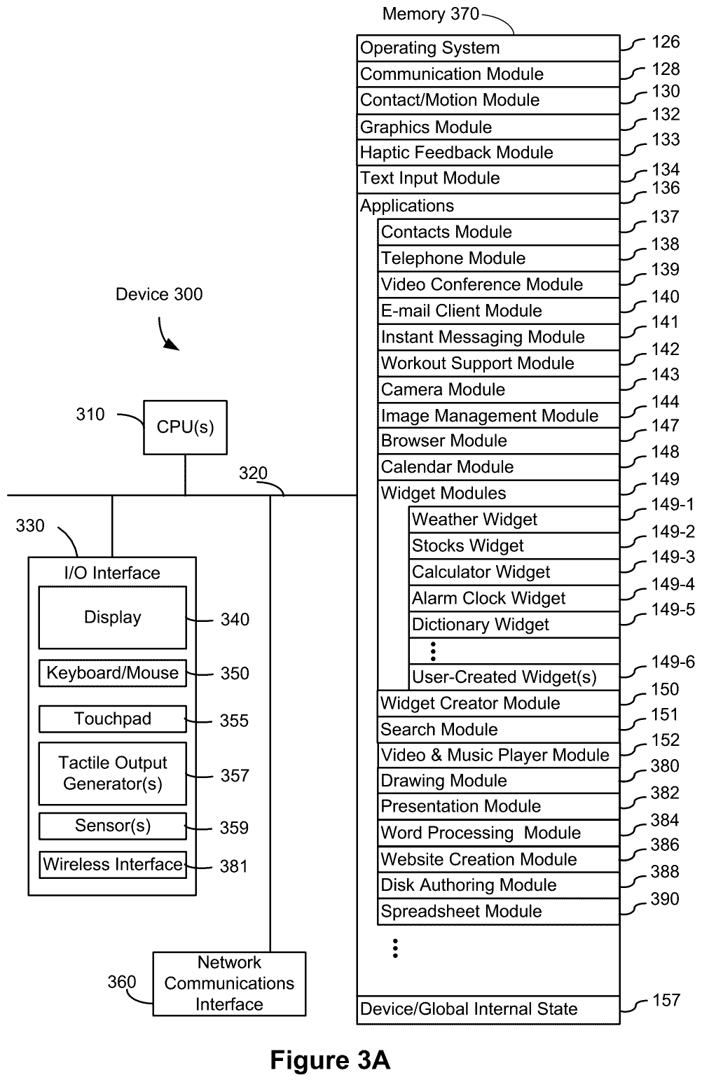

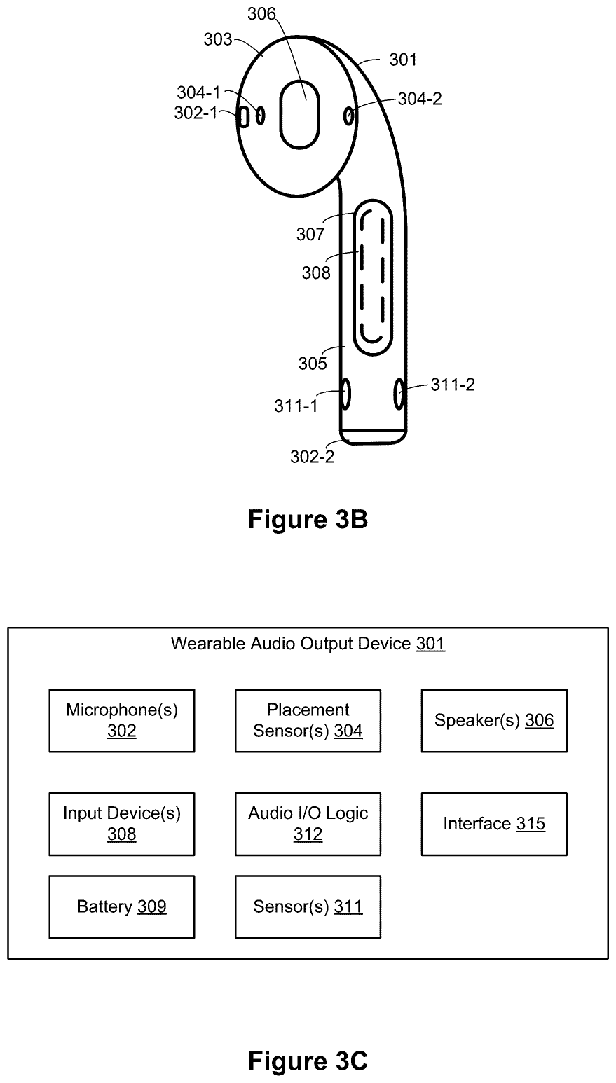

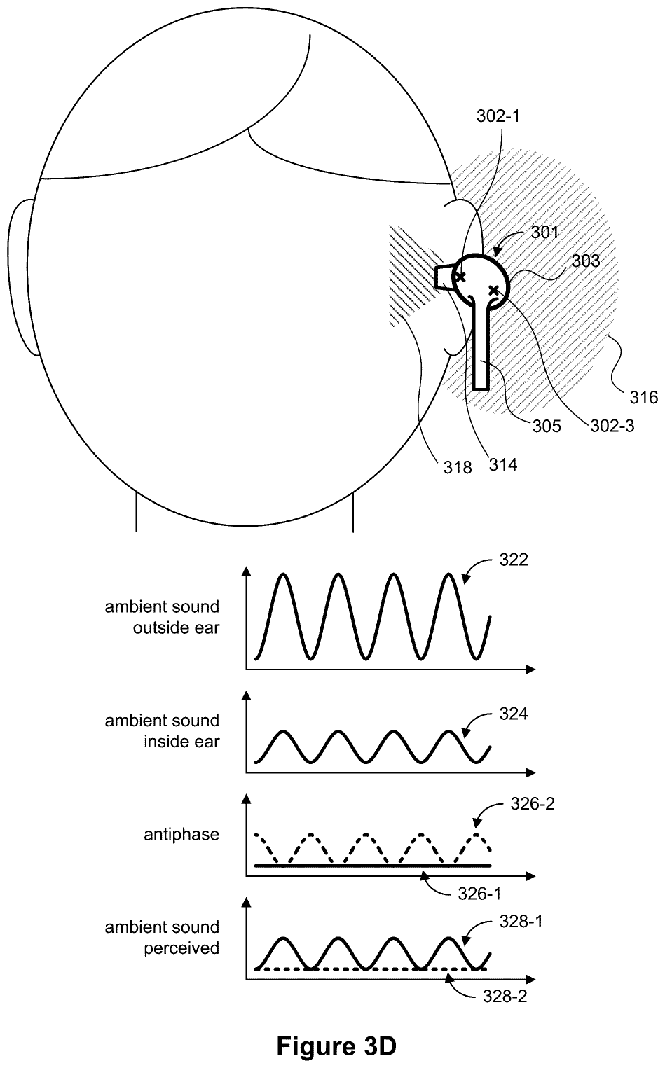

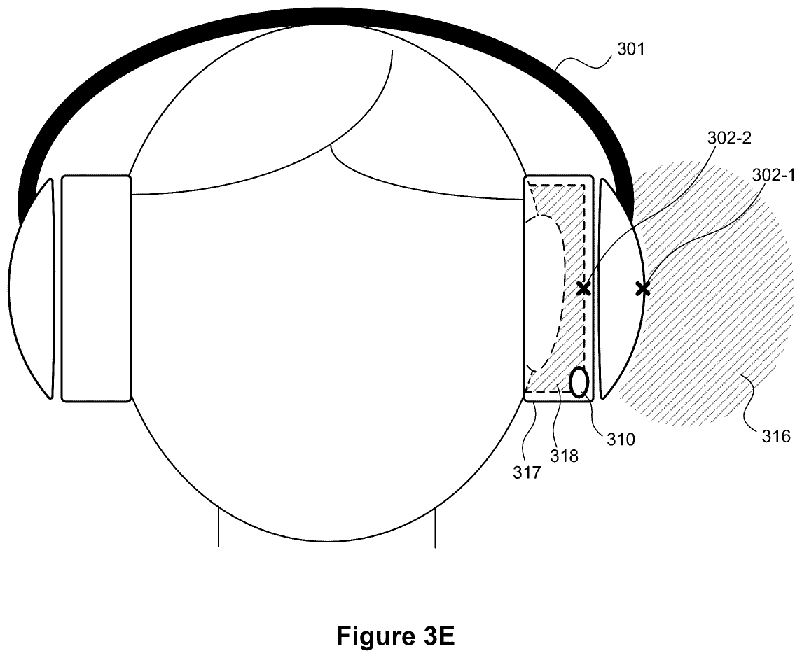

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (e.g., in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture-which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (e.g., in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (e.g., including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (e.g., as shown in FIG. 1A) or 370 (e.g., as shown in FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIGS. 1C-1D illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b) for displaying virtual elements and/or a representation of a physical environment to a user of the computer system, optionally generated based on detected events and/or user inputs detected by the computer system. User interfaces generated by the computer system are optionally corrected by one or more corrective lenses that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD (e.g., HMD 100b) are optionally displayed using two optical modules (e.g., first and second display assemblies 1-120a, 1-120b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors for detecting information about a physical environment of the device which can be used (optionally in conjunction with one or more illuminators) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement that can be used (optionally in conjunction with one or more illuminators) to determine when one or more air gestures have been performed. In some embodiments, the computer system includes one or more input devices for detecting input such as one or more sensors for detecting eye movement which can be used (optionally in conjunction with one or more lights) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128 and/or second button 1-132), knobs (e.g., first button 1-128), digital crowns (e.g., first button 1-128 which is depressible and twistable or rotatable), trackpads, touch screens, keyboards, mice and/or other input devices. One or more buttons (e.g., first button 1-128 and/or second button 1-132) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b).

FIG. 1C illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1C, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1C because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1D illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1C and 1D, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward-facing display screen of the display assembly 1-108 shown in the front perspective view of FIG. 1C. In at least one example, the HMD 1-100 can also include a curtain 1-124 occluding the second opening 1-154 between the housing 1-150 and the rear-facing display assemblies 1-120a-b. In at least one example, the curtain 1-124 can be clastic or at least partially clastic.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical or camera, acceleration, proximity, touch-sensitive, and/or contact intensity sensors similar to contact intensity sensor(s) 165 described above with reference to FIG. 1A). Memory 370 includes high-speed random-access memory, such as DRAM, SRAM, DDR RAM or other random-access solid-state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (e.g., as shown in FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (e.g., as shown in FIG. 1A) optionally does not store these modules.

Wireless interface 381 receives and sends wireless signals. Wireless interface 381 converts electrical signals to/from electromagnetic signals and communicates with communications networks and other communications devices via the electromagnetic signals. Wireless interface 381 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. Wireless interface 381 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

FIG. 3B illustrates physical features of an example wearable audio output device 301 in accordance with some embodiments. In some embodiments, the wearable audio output device 301 is one or more in-ear earphone(s), earbud(s), over-ear headphone(s), or the like. In the example of FIG. 3B, wearable audio output device 301 is an earbud. In some embodiments, wearable audio output device 301 includes a head portion 303 and a stem portion 305. In some embodiments, head portion 303 is configured to be inserted into a user's ear. In some embodiments, stem portion 305 physically extends from head portion 303 (e.g., is an elongated portion extending from head portion 303). For example, head portion 303 physically extends downward, in front of, and/or past a user's earlobe while head portion 303 is inserted into a user's ear.

In some embodiments, wearable audio output device 301 includes one or more audio speakers 306 (e.g., in head portion 303) for providing audio output (e.g., to a user's ear). In some embodiments, wearable audio output device 301 includes one or more placement sensors 304 (e.g., placement sensors 304-1 and 304-2 in head portion 303) to detect positioning or placement of wearable audio output device 301 relative to a user's ear, such as to detect placement of wearable audio output device 301 in a user's ear.

In some embodiments, wearable audio output device 301 includes one or more microphones 302 for receiving audio input. In some embodiments, one or more microphones 302 are included in head portion 303 (e.g., microphone 302-1). In some embodiments, one or more microphones 302 are included in stem portion 305 (e.g., microphone 302-2). In some embodiments, microphone(s) 302 detect speech from a user wearing wearable audio output device 301 and/or ambient noise around wearable audio output device 301. In some embodiments, multiple microphones of microphones 302 are positioned at different locations on wearable audio output device 301 to measure speech and/or ambient noise at different locations around wearable audio output device 301.

In some embodiments, wearable audio output device 301 includes one or more input devices 308 (e.g., in stem portion 305). In some embodiments, input device(s) 308 includes a pressure-sensitive (e.g., intensity-sensitive) input device. In some embodiments, the pressure-sensitive input device detects inputs from a user in response to the user squeezing the input device (e.g., by pinching stem portion 305 of wearable audio output device 301 between two fingers). In some embodiments, input device(s) 308 include a touch-sensitive surface (e.g., a capacitive sensor) for detecting touch inputs, accelerometer(s), and/or attitude sensor(s) (e.g., for determining an attitude of wearable audio output device 301 relative to a physical environment and/or changes in attitude of the device), and/or other input device by which a user can interact with and provide inputs to wearable audio output device 301. In some embodiments, input device(s) 308 include one or more capacitive sensors, one or more force sensors, one or more motion sensors, and/or one or more orientation sensors. FIG. 3B shows input device(s) 308 at a location in stem portion 305, however in some embodiments one or more of input device(s) 308 are located at other positions within wearable audio output device 301 (e.g., other positions within stem portion 305 and/or head portion 303). In some embodiments, wearable audio output device 301 includes a housing with one or more physically distinguished portions 307 at locations that correspond to input device(s) 308 (e.g., to assist a user in locating and/or interacting with input device(s) 308). In some embodiments, physically distinguished portion(s) 307 include indent(s), raised portion(s), and/or portions with different textures. In some embodiments, physically distinguished portion(s) 307 include a single distinguished portion that spans multiple input devices 308. For example, input devices 308 include a set of touch sensors configured to detect swipe gestures and a single distinguished portion (e.g., a depression or groove) spans the set of touch sensors. In some embodiments, physically distinguished portion(s) 307 include a respective distinguished portion for each input device of input device(s) 308.

In some embodiments, wearable audio output device 301 includes one or more sensors 311 (e.g., sensors 311-1 and 311-2 in stem portion 305). In some embodiments, the one or more sensors 311 include one or more image sensors or cameras. In some embodiments, the sensor(s) 311 include a sensor (e.g., the sensor 311-1) that faces forward while the wearable audio output device 301 is being worn by a user. In some embodiments, the sensor(s) 311 include a sensor (e.g., the sensor 311-2) that faces backwards while the wearable audio output device 301 is being worn by a user. In some embodiments, the sensor(s) 311 consist of one sensor (e.g., with a field of view that is substantially the same as the wearer of the wearable audio output device 301). In some embodiments, the sensor(s) 311 include three or more sensors (e.g., each with a different field of view). In some embodiments, one or more of the sensor(s) 311 are arranged at different positions than shown in FIG. 3B. For example, one of the sensor(s) 311 may be arranged on the head portion 303. As another example, one of the sensor(s) 311 may be arranged near the middle or top of the stem portion 305.

FIG. 3C is a block diagram of an example wearable audio output device 301 in accordance with some embodiments. In some embodiments, wearable audio output device 301 is one or more in-ear earphone(s), earbud(s), over-ear headphone(s), or the like. In some examples, wearable audio output device 301 includes a pair of earphones or earbuds (e.g., one for each of a user's ears). In some examples, wearable audio output device 301 includes over-ear headphones (e.g., headphones with two over-ear earcups to be placed over a user's ears and optionally connected by a headband). In some embodiments, wearable audio output device 301 includes one or more audio speakers 306 for providing audio output (e.g., to a user's ear). In some embodiments, wearable audio output device 301 includes one or more placement sensors 304 to detect positioning or placement of wearable audio output device 301 relative to a user's ear, such as to detect placement of wearable audio output device 301 in a user's ear. In some embodiments, wearable audio output device 301 conditionally outputs audio based on whether wearable audio output device 301 is in or near a user's ear (e.g., wearable audio output device 301 forgoes outputting audio when not in a user's ear, to reduce power usage). In some embodiments where wearable audio output device 301 includes multiple (e.g., a pair) of wearable audio output components (e.g., earphones, earbuds, or earcups), each component includes one or more respective placement sensors, and wearable audio output device 301 conditionally outputs audio based on whether one or both components is in or near a user's ear, as described herein. In some embodiments, wearable audio output device 301 furthermore includes an internal rechargeable battery 309 for providing power to the various components of wearable audio output device 301.

In some embodiments, wearable audio output device 301 includes audio I/O logic 312, which determines the positioning or placement of wearable audio output device 301 relative to a user's ear based on information received from placement sensor(s) 304, and, in some embodiments, audio I/O logic 312 controls the resulting conditional outputting of audio. In some embodiments, wearable audio output device 301 includes an interface 315, e.g., a wireless interface, for communication with one or more multifunction devices, such as device 100 (e.g., as shown in FIG. 1A) or device 300 (e.g., as shown in FIG. 3A). In some embodiments, interface 315 includes a wired interface for connection with a multifunction device, such as device 100 (e.g., as shown in FIG. 1A) or device 300 (e.g., as shown in FIG. 3A) (e.g., via a headphone jack or other audio port). In some embodiments, a user can interact with and provide inputs (e.g., remotely) to wearable audio output device 301 via interface 315. In some embodiments, wearable audio output device 301 is in communication with multiple devices (e.g., multiple multifunction devices, and/or an audio output device case), and audio I/O logic 312 determines, which of the multifunction devices from which to accept instructions for outputting audio.

In some embodiments, wearable audio output device 301 includes one or more microphones 302 for receiving audio input. In some embodiments where wearable audio output device 301 includes multiple (e.g., a pair) of wearable audio output components (e.g., earphones or earbuds), each component includes one or more respective microphones. In some embodiments, audio I/O logic 312 detects or recognizes speech or ambient noise based on information received from microphone(s) 302.

In some embodiments, wearable audio output device 301 includes one or more input devices 308. In some embodiments where wearable audio output device 301 includes multiple (e.g., a pair) of wearable audio output components (e.g., earphones, earbuds, or earcups), each component includes one or more respective input devices. In some embodiments, input device(s) 308 include one or more volume control hardware elements (e.g., an up/down button for volume control, or an up button and a separate down button, as described herein with reference to FIG. 1A) for volume control (e.g., locally) of wearable audio output device 301. In some embodiments, inputs provided via input device(s) 308 are processed by audio I/O logic 312. In some embodiments, audio I/O logic 312 is in communication with a separate device (e.g., device 100, FIG. 1A, or device 300, FIG. 3A) that provides instructions or content for audio output, and that optionally receives and processes inputs (or information about inputs) provided via microphone(s) 302, placement sensor(s) 304, and/or input device(s) 308, or via one or more input devices of the separate device. In some embodiments, audio I/O logic 312 is located in device 100 (e.g., as part of peripherals interface 118, FIG. 1A) or device 300 (e.g., as part of I/O interface 330, FIG. 3A), instead of device 301, or alternatively is located in part in device 100 and in part in device 301, or in part in device 300 and in part in device 301.

FIG. 3D illustrates example audio control by a wearable audio output device 301 in accordance with some embodiments. While the following example is explained with respect to implementations that include a wearable audio output device having earbuds to which interchangeable eartips (sometimes called silicon eartips or silicon seals) are attached, the methods, devices and user interfaces described herein are equally applicable to implementations in which the wearable audio output devices do not have eartips, and instead each have a portion of the main body shaped for insertion in the user's cars. In some embodiments, when a wearable audio output device having earbuds to which interchangeable eartips may be attached are worn in a user's ears, the earbuds and eartips together act as physical barriers that block at least some ambient sound from the surrounding physical environment from reaching the user's ear. For example, in FIG. 3D, wearable audio output device 301 is worn by a user such that head portion 303 and eartip 314 are in the user's left ear. Eartip 314 extends at least partially into the user's ear canal. Preferably, when head portion 303 and eartip 314 are inserted into the user's ear, a seal is formed between eartip 314 and the user's ear so as to isolate the user's ear canal from the surrounding physical environment. However, in some circumstances, head portion 303 and eartip 314 together block some, but not necessarily all, of the ambient sound in the surrounding physical environment from reaching the user's ear. Accordingly, in some embodiments, a first microphone (or, in some embodiments, a first set of one or more microphones) 302-1 (and optionally a third microphone 302-3) is located on wearable audio output device 301 so as to detect ambient sound, represented by waveform 322, in region 316 of a physical environment surrounding (e.g., outside of) head portion 303. In some embodiments, a second microphone (or, in some embodiments, a second set of one or more microphones) 302-2 (e.g., of microphones 302, FIG. 3C) is located on wearable audio output device 301 so as to detect any ambient sound, represented by waveform 324, that is not completely blocked by head portion 303 and eartip 314 and that can be heard in region 318 inside the user's ear canal. Accordingly, in some circumstances in which wearable audio output device 301 is not producing a noise-cancelling (also called “antiphase”) audio signal to cancel (e.g., attenuate) ambient sound from the surrounding physical environment, as indicated by waveform 326-1, ambient sound waveform 324 is perceivable by the user, as indicated by waveform 328-1. In some circumstances in which wearable audio output device 301 is producing an antiphase audio signal to cancel ambient sound, as indicated by waveform 326-2, ambient sound waveform 324 is not perceivable by the user, as indicated by waveform 328-2.

In some embodiments, ambient sound waveform 322 is compared to attenuated ambient sound waveform 324 (e.g., by wearable audio output device 301 or a component of wearable audio output device 301, such as audio I/O logic 312, or by an electronic device that is in communication with wearable audio output device 301) to determine the passive attenuation provided by wearable audio output device 301. In some embodiments, the amount of passive attenuation provided by wearable audio output device 301 is taken into account when providing the antiphase audio signal to cancel ambient sound from the surrounding physical environment. For example, antiphase audio signal waveform 326-2 is configured to cancel attenuated ambient sound waveform 324 rather than unattenuated ambient sound waveform 322.

In some embodiments, wearable audio output device 301 is configured to operate in one of a plurality of available audio output modes, such as an active noise control audio output mode, an active pass-through audio output mode, and a bypass audio output mode (also sometimes called a noise control off audio output mode). In the active noise control mode (also called “ANC”), wearable audio output device 301 outputs one or more audio-cancelling audio components (e.g., one or more antiphase audio signals, also called “audio-cancelation audio components”) to at least partially cancel ambient sound from the surrounding physical environment that would otherwise be perceivable to the user. In the active pass-through audio output mode, wearable audio output device 301 outputs one or more pass-through audio components (e.g., plays at least a portion of the ambient sound from outside the user's ear, received by microphone 302-1, for example) so that the user can hear a greater amount of ambient sound from the surrounding physical environment than would otherwise be perceivable to the user (e.g., a greater amount of ambient sound than would be audible with the passive attenuation of wearable audio output device 301 placed in the user's ear). In the bypass mode, active noise management is turned off, such that wearable audio output device 301 outputs neither any audio-cancelling audio components nor any pass-through audio components (e.g., such that any amount of ambient sound that the user perceives is due to physical attenuation by wearable audio output device 301).

FIG. 3E illustrates physical features of an example wearable audio output device 301 in accordance with some embodiments. In the example of FIG. 3E, wearable audio output device 301 includes over-ear earcups worn over a user's ears, the earcups act as physical barriers that block at least some ambient sound from the surrounding physical environment from reaching the user's ear. For example, in FIG. 3E, wearable audio output device 301 is worn by a user such that earcup 317 is over the user's left ear. In some embodiments, a first microphone (or, in some embodiments, a first set of one or more microphones) 302-1 (e.g., of microphones 302, FIG. 3B) is located on wearable audio output device 301 so as to detect ambient sound in region 316 of a physical environment surrounding (e.g., outside of) earcup 317. In some embodiments, earcup 317 blocks some, but not necessarily all, of the ambient sound in the surrounding physical environment from reaching the user's ear. In some embodiments, a second microphone (or, in some embodiments, a second set of one or more microphones) 302-2 (e.g., of microphones 302, FIG. 3B) is located on wearable audio output device 301 so as to detect any ambient sound that is not completely blocked by earcup 317 and that can be heard in region 318 inside earcup 317. Accordingly, in some circumstances in which wearable audio output device 301 is not producing a noise-cancelling (also called “antiphase”) audio signal to cancel (e.g., attenuate) ambient sound from the surrounding physical environment, ambient sound waveform 324 is perceivable by the user. In some circumstances in which wearable audio output device 301 is producing an antiphase audio signal to cancel ambient sound, ambient sound waveform 324 is not perceivable by the user.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, a value produced by low-pass filtering the intensity of the contact over a predefined period or starting at a predefined time, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds may include a first intensity threshold and a second intensity threshold. In this example, a contact with a characteristic intensity that does not exceed the first intensity threshold results in a first operation, a contact with a characteristic intensity that exceeds the first intensity threshold and does not exceed the second intensity threshold results in a second operation, and a contact with a characteristic intensity that exceeds the second intensity threshold results in a third operation. In some embodiments, a comparison between the characteristic intensity and one or more intensity thresholds is used to determine whether or not to perform one or more operations (e.g., whether to perform a respective option or forgo performing the respective operation) rather than being used to determine whether to perform a first operation or a second operation.

In some embodiments, a portion of a gesture is identified for purposes of determining a characteristic intensity. For example, a touch-sensitive surface may receive a continuous swipe contact transitioning from a start location and reaching an end location (e.g., a drag gesture), at which point the intensity of the contact increases. In this example, the characteristic intensity of the contact at the end location may be based on only a portion of the continuous swipe contact, and not the entire swipe contact (e.g., only the portion of the swipe contact at the end location). In some embodiments, a smoothing algorithm may be applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

### User Interfaces and Associated Processes

Attention is now directed towards embodiments of user interfaces (“UI”), user interactions, and associated processes that may be implemented on an electronic device, such as portable multifunction device 100, device 300, and/or wearable audio output devices 301.

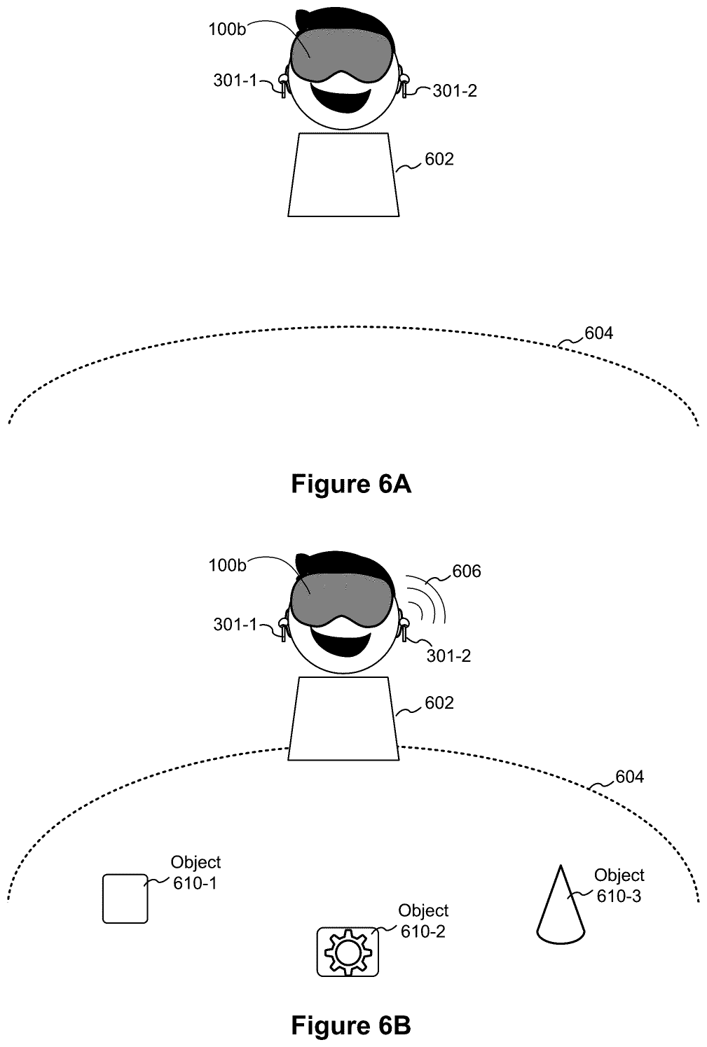

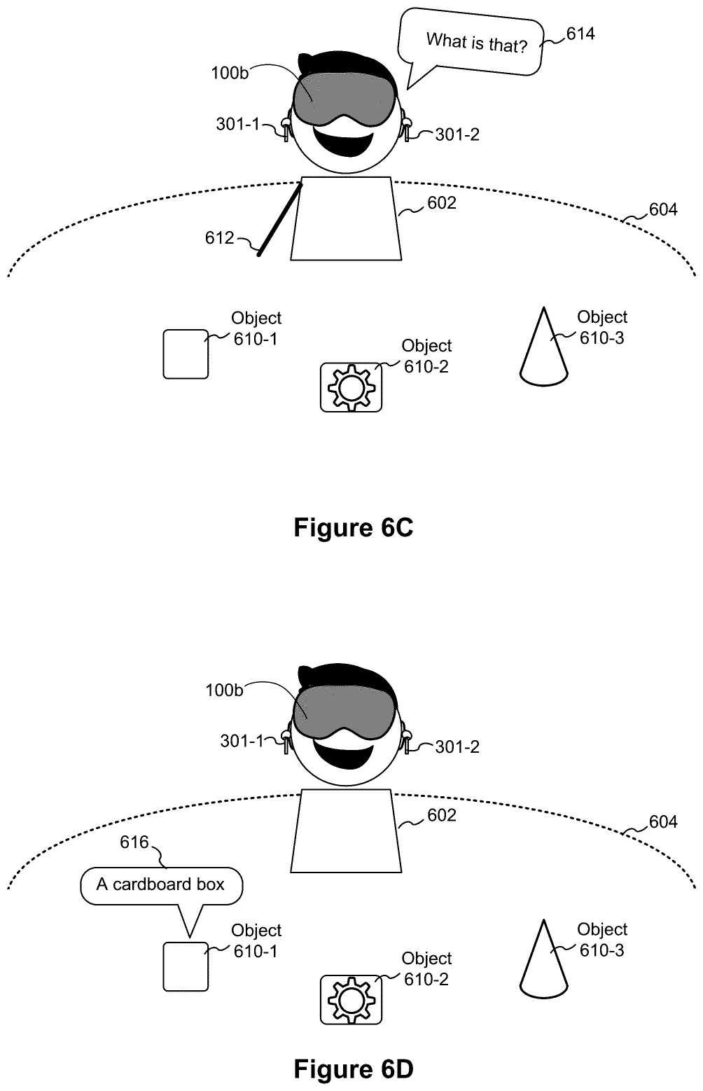

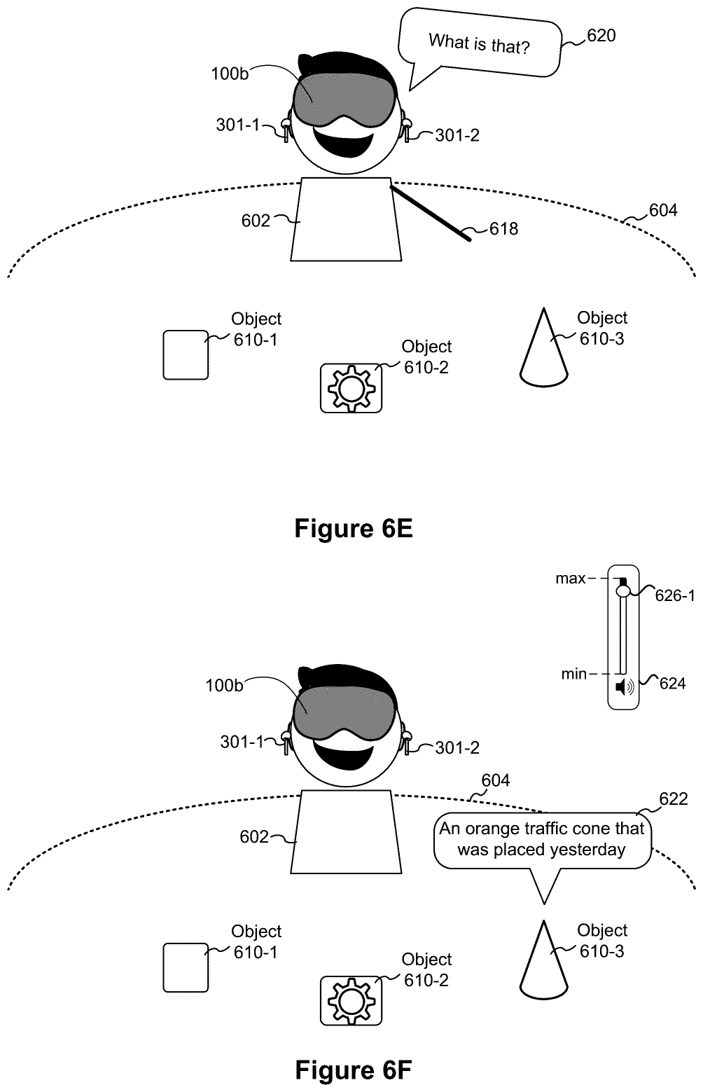

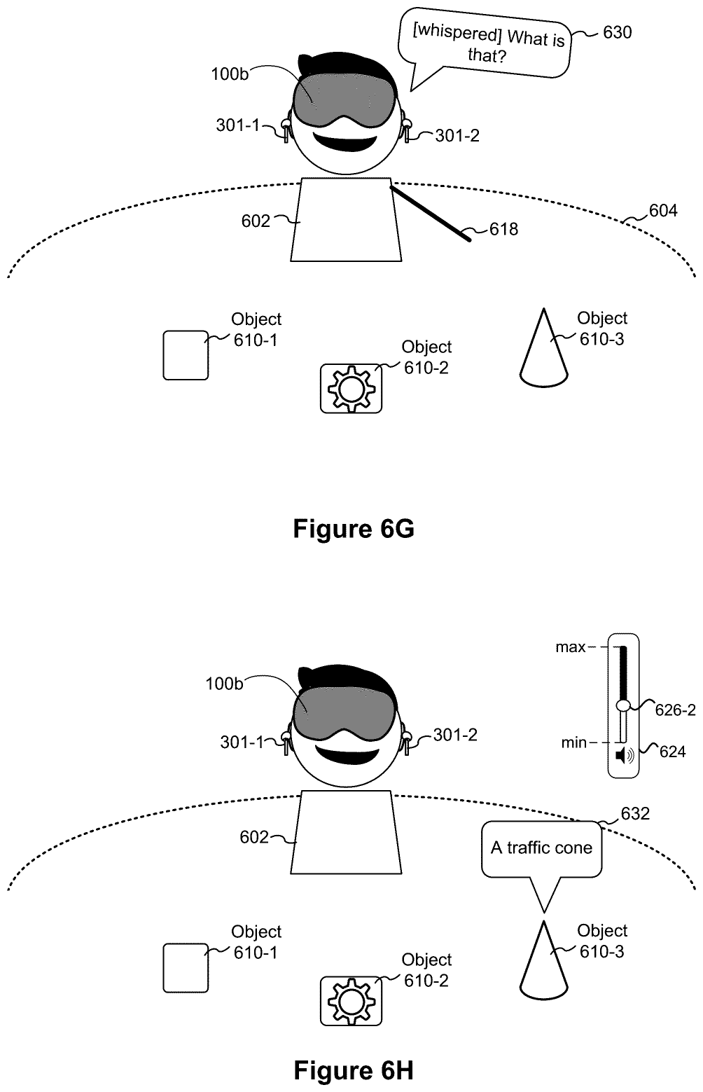

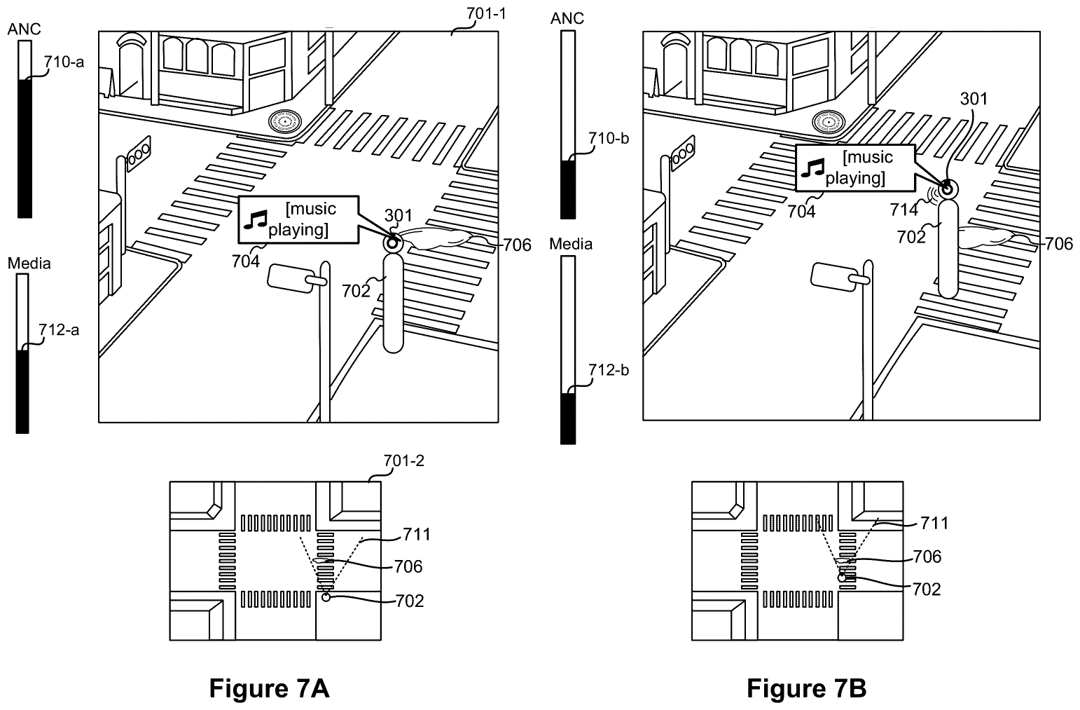

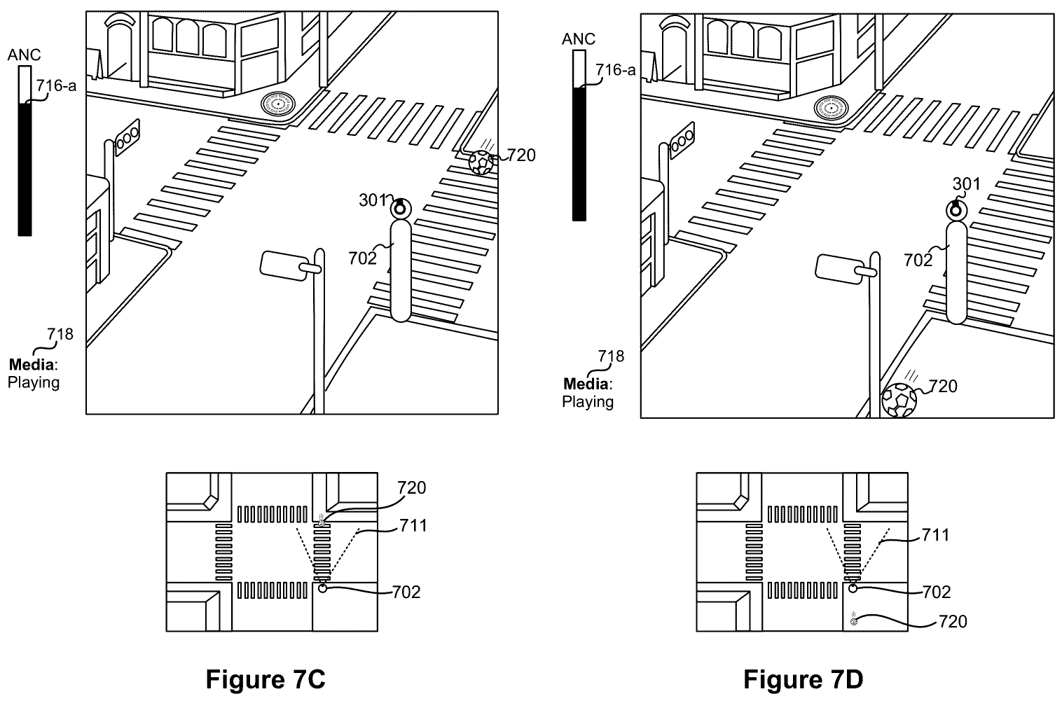

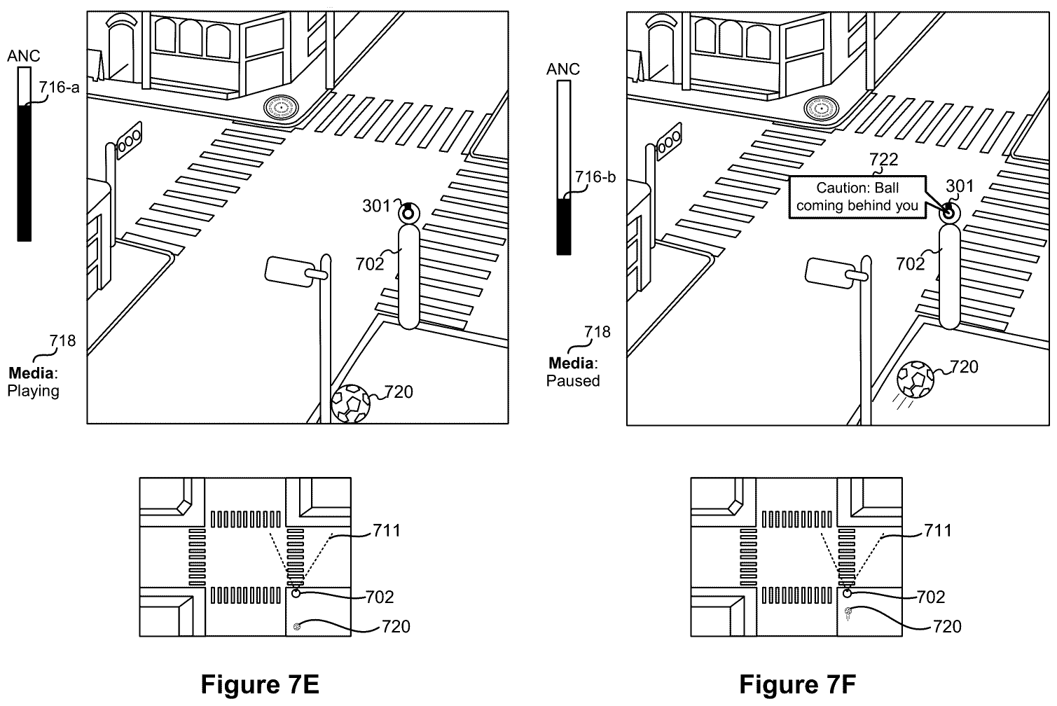

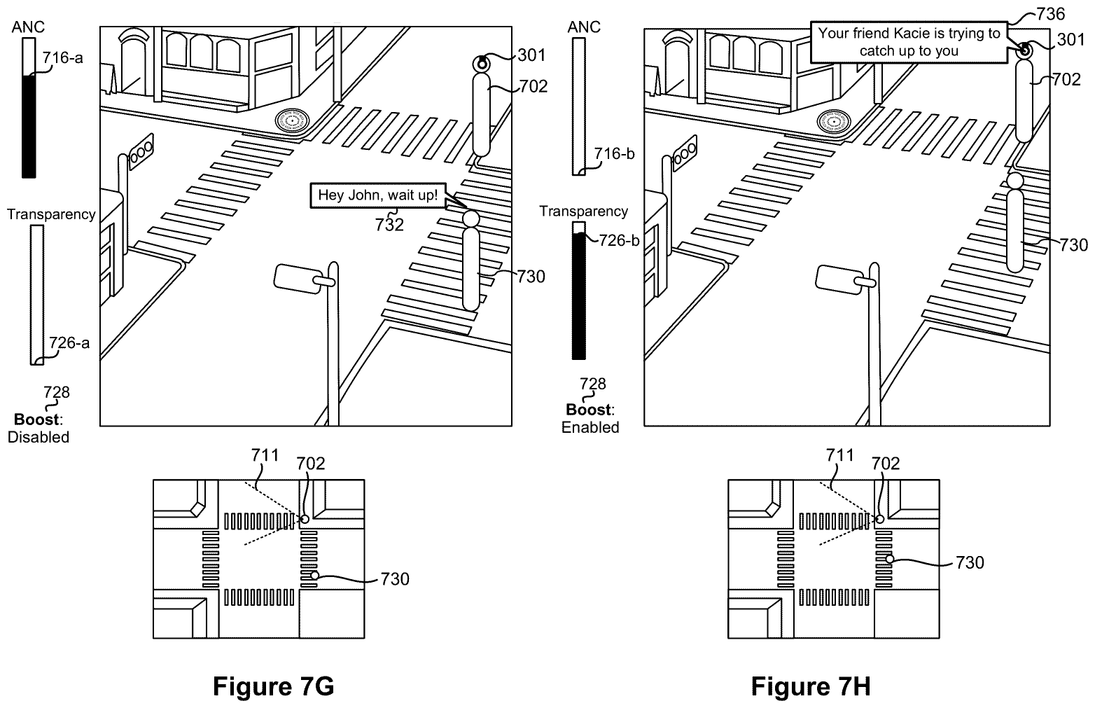

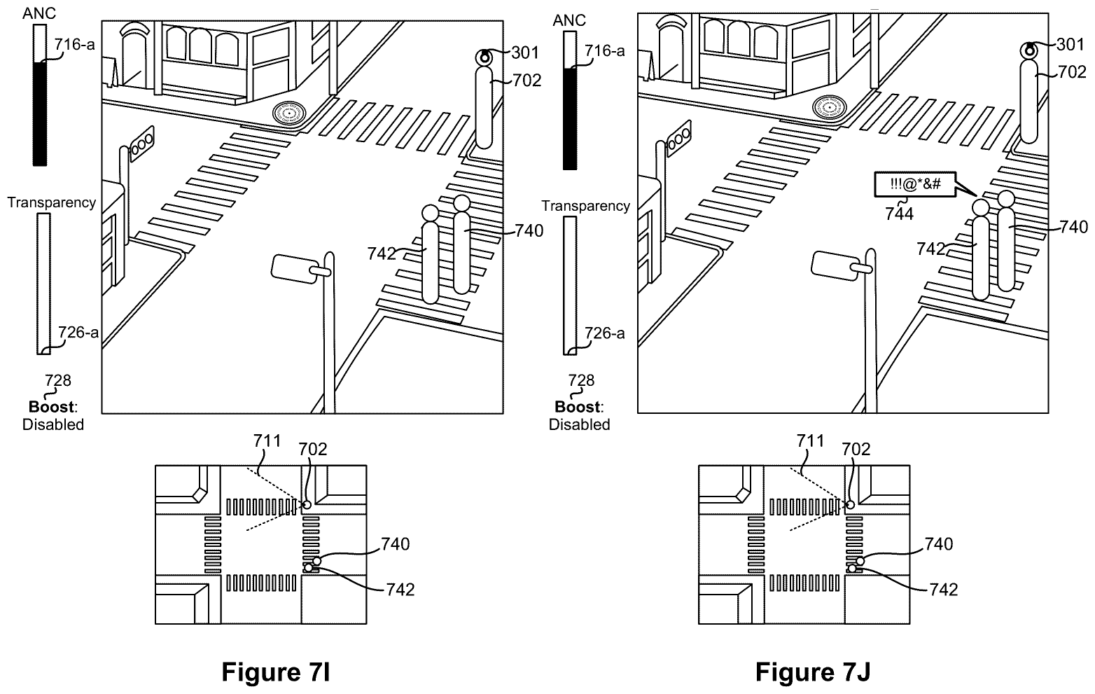

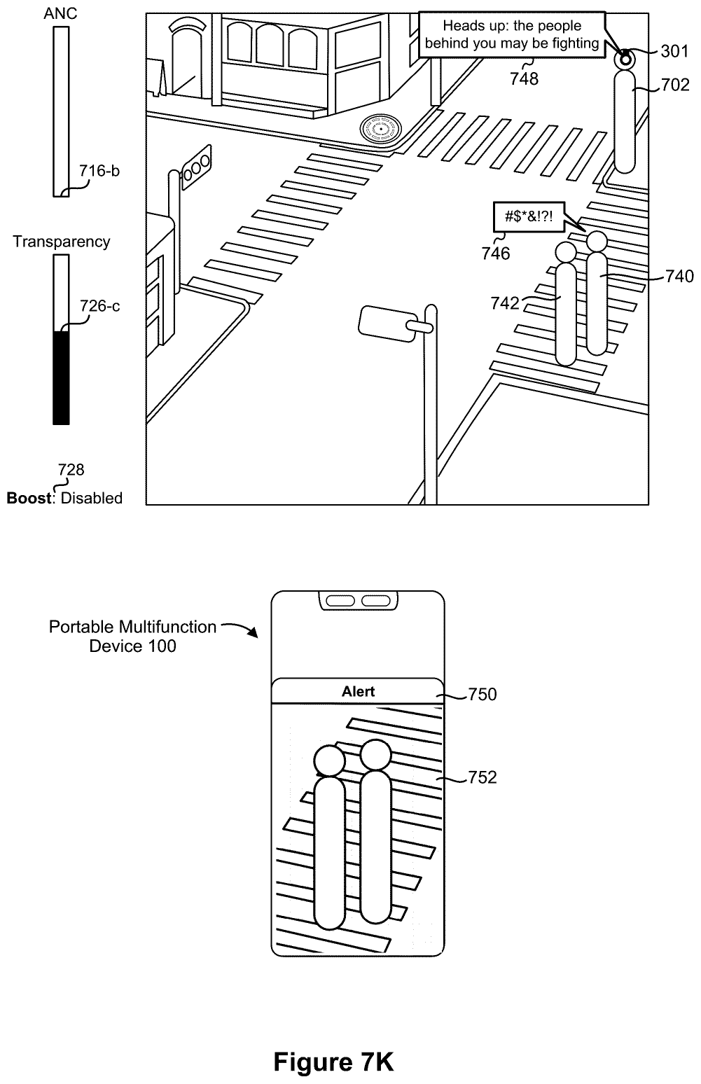

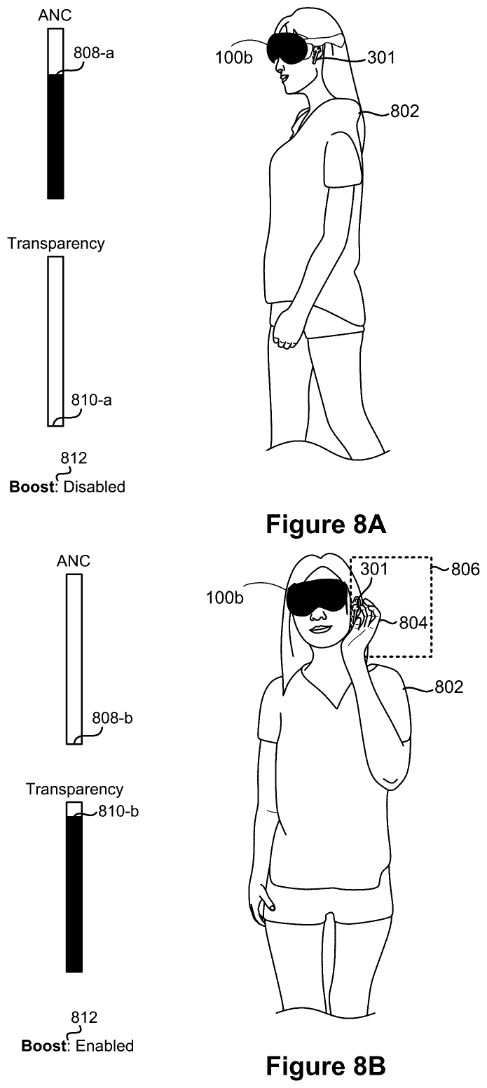

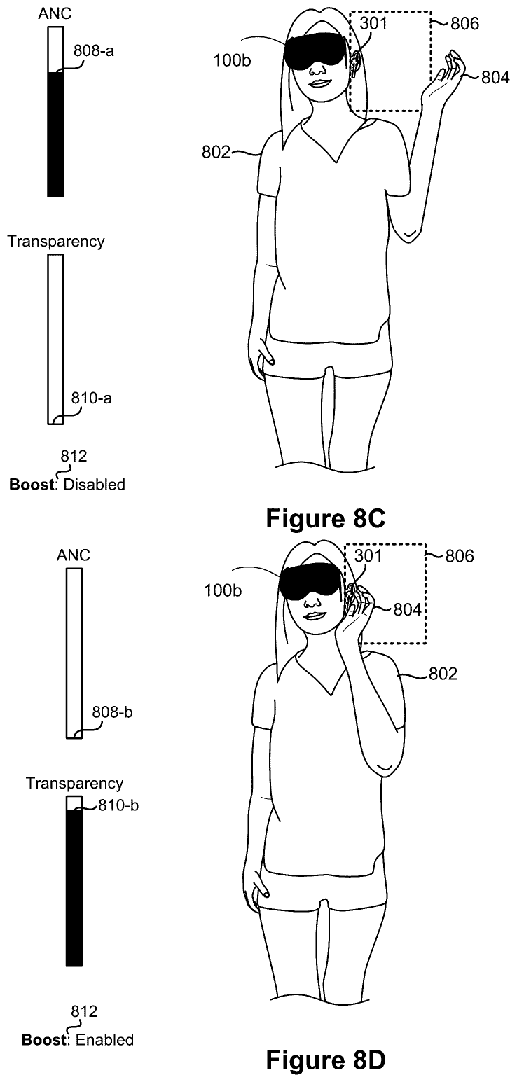

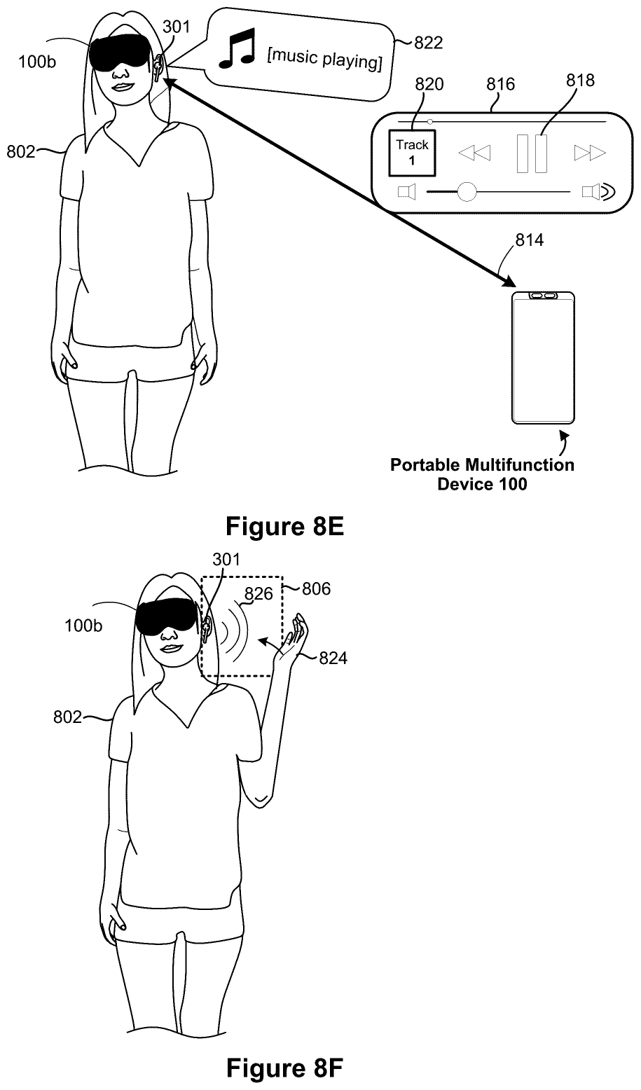

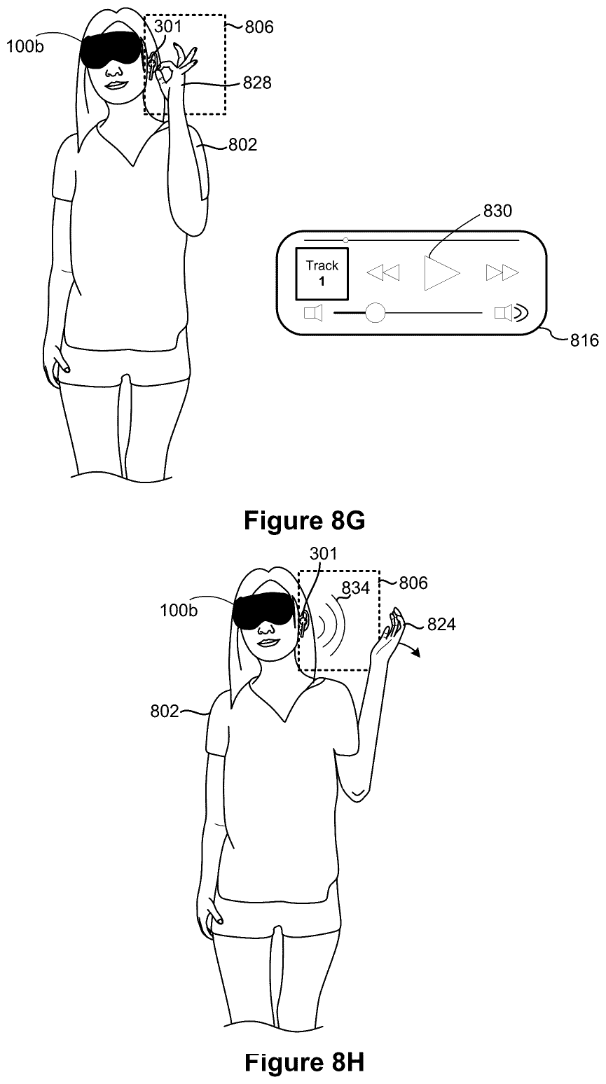

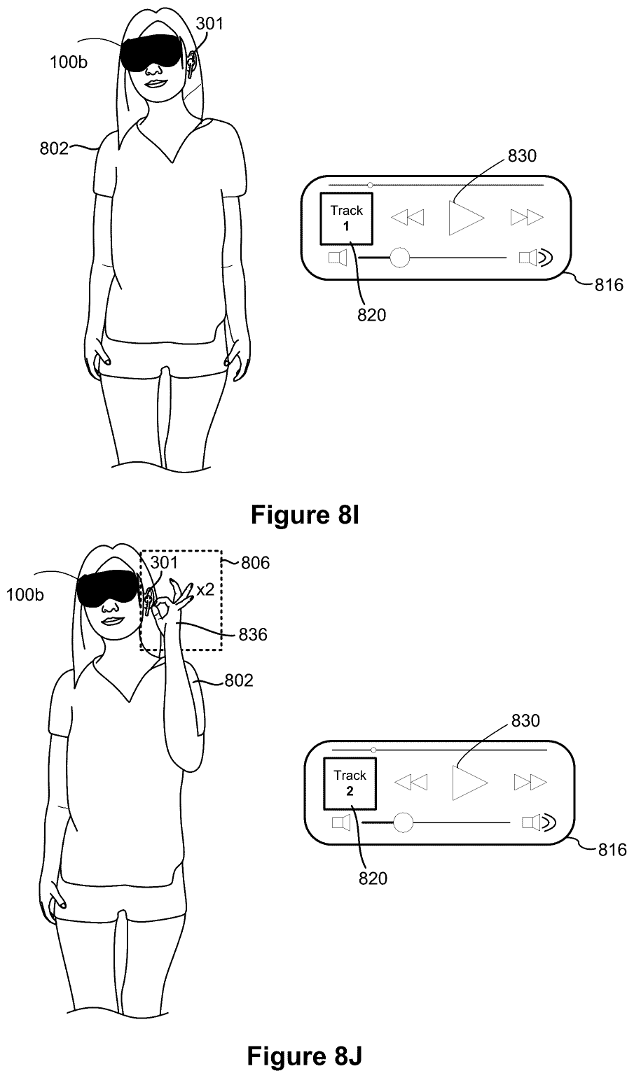

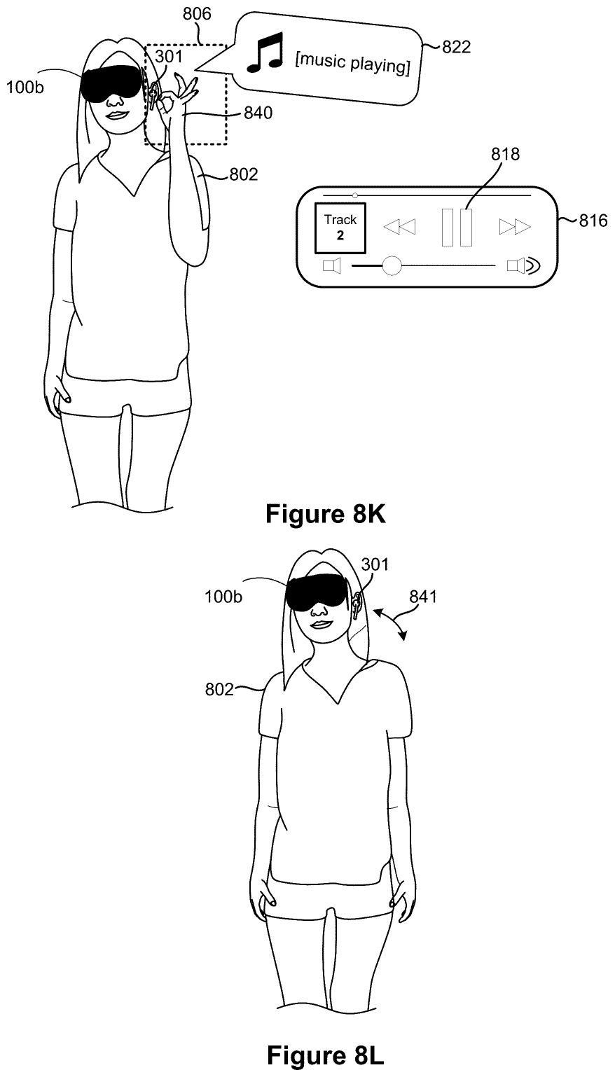

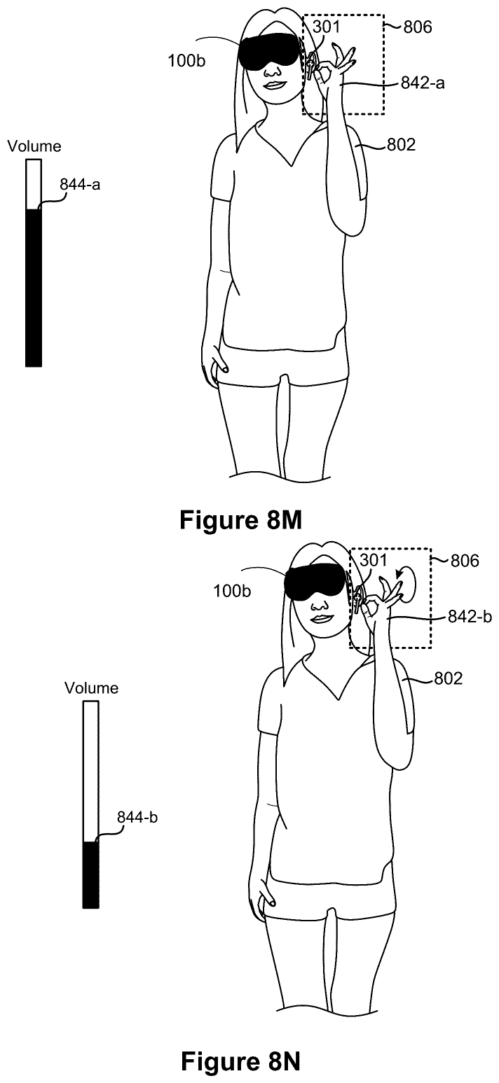

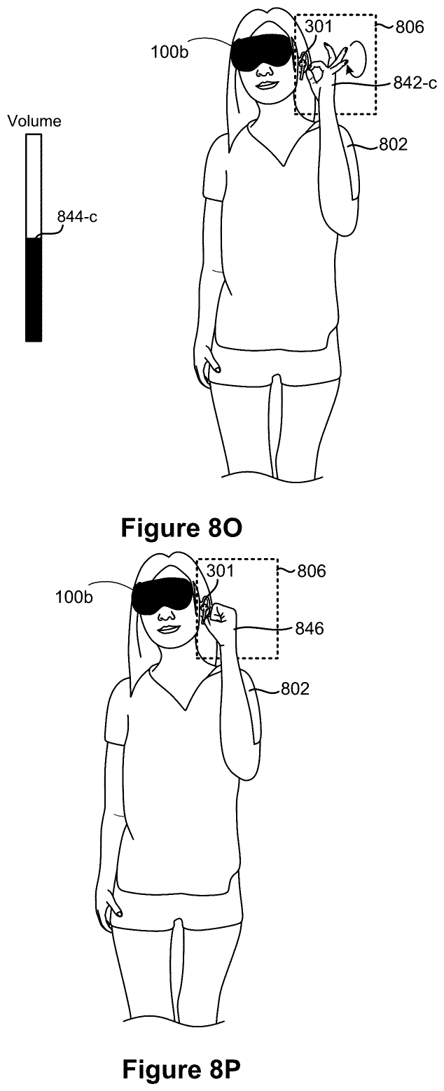

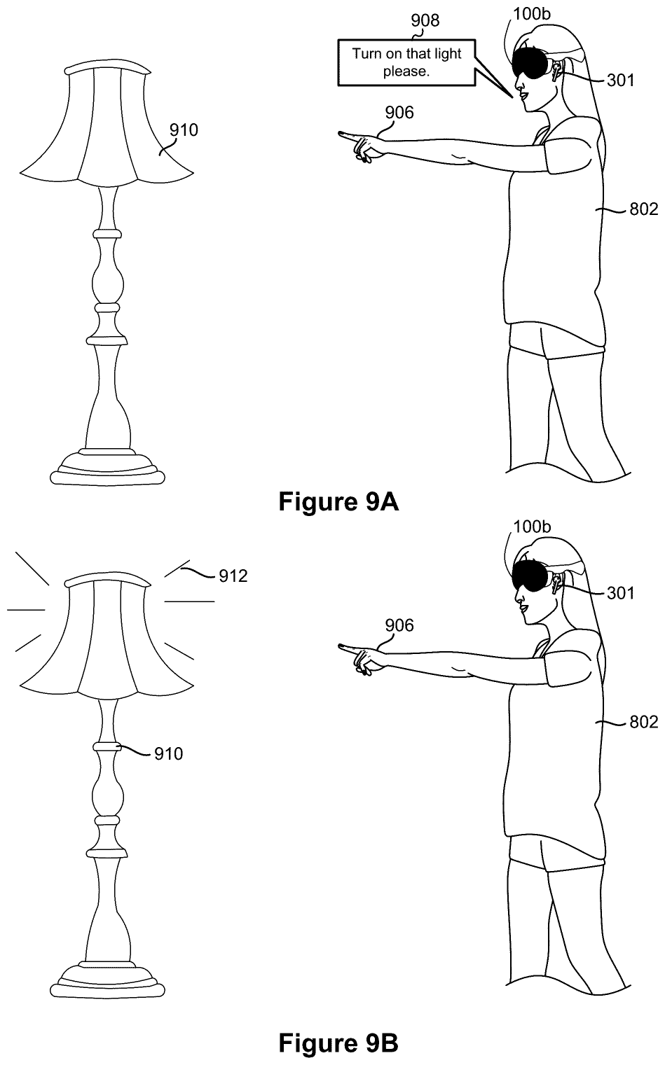

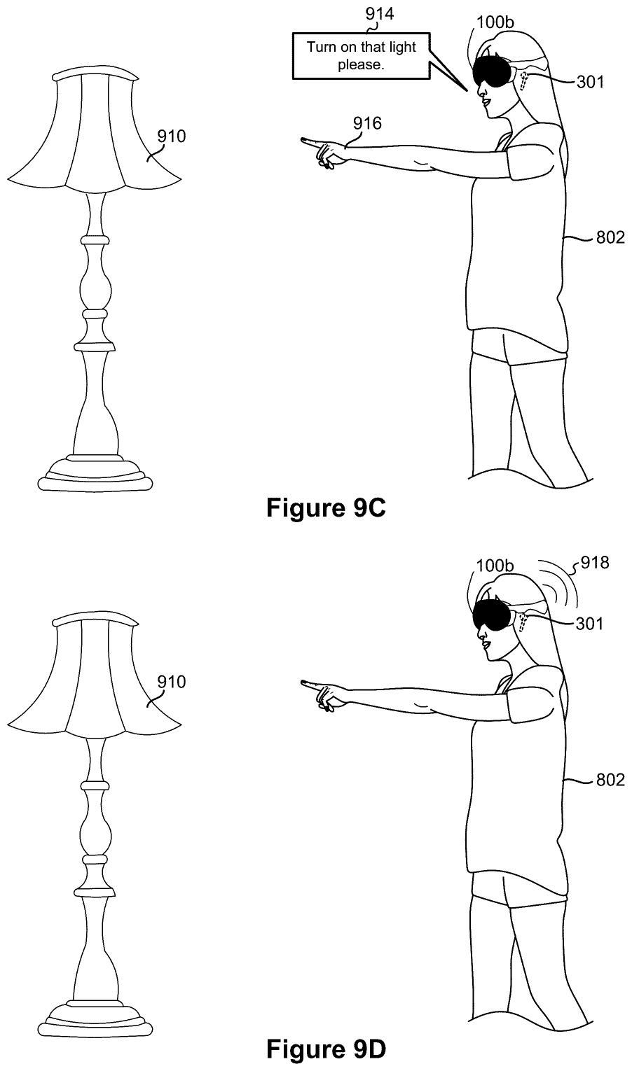

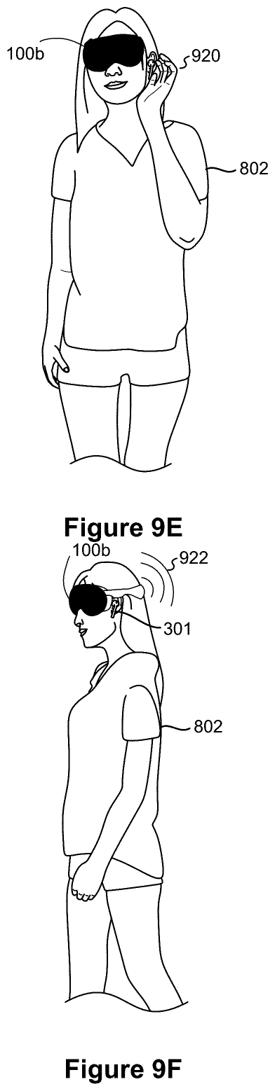

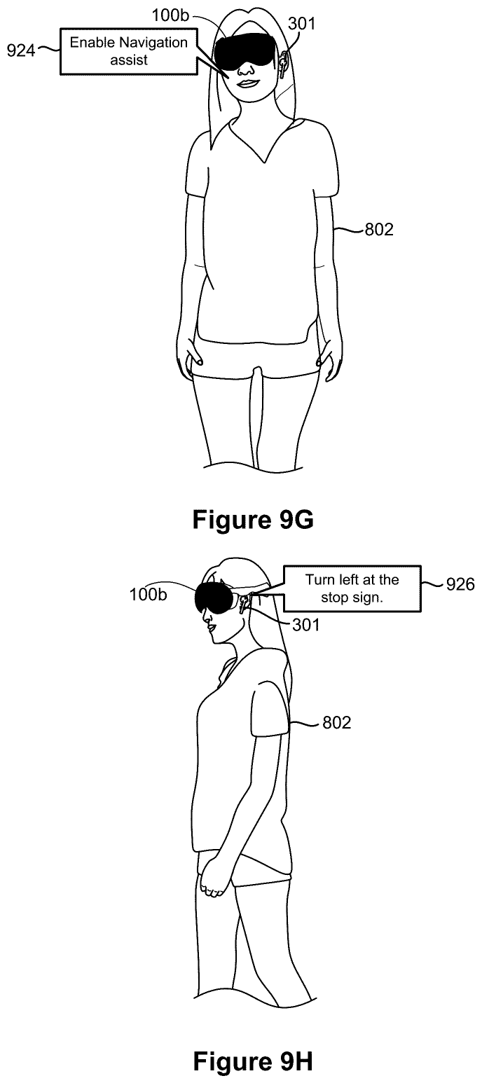

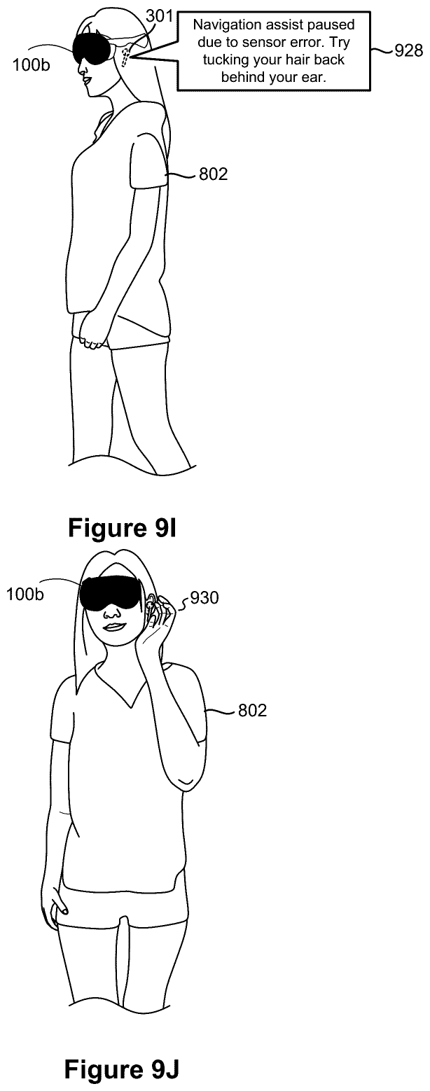

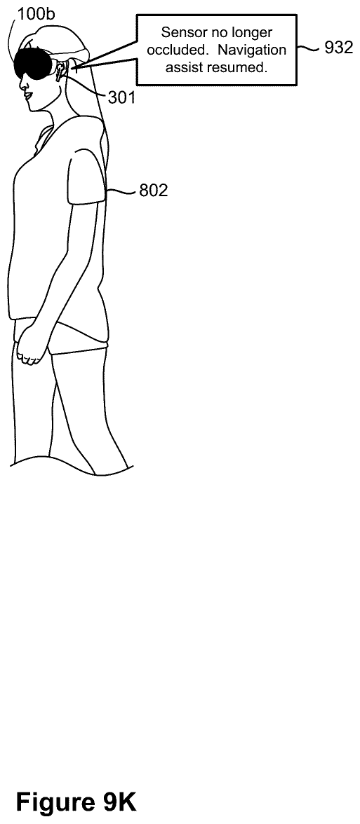

FIGS. 5A-5R illustrate example user interfaces and user interactions involving real-world objects and feedback from wearable devices. FIGS. 6A-6H illustrate example user interactions involving real-world objects and feedback from wearable devices. FIGS. 7A-7K illustrate example user interactions with wearable devices involving various alert conditions. FIGS. 8A-8P and 9A-9K illustrate example user interactions with wearable devices. The user interfaces in these figures are used to illustrate the processes described below, including the processes in FIGS. 10A-10D, 11A-11C, 12A-12D, and 13A-13B.

FIGS. 5A-5D illustrate example user interfaces and user interactions involving real-world objects and feedback from wearable devices in accordance with some embodiments. FIG. 5A shows user 502 wearing wearable audio output device 301 (e.g., earbuds) and head-mounted display (HMD) 100b (e.g., HMD 1-100, FIG. 1C). In some embodiments, user 502 is not wearing HMD 100b (e.g., is only wearable audio output device 301). FIG. 5A also shows real-world objects 508-1 (e.g., a box) and 508-2 (e.g., a clock) near user 502. FIG. 5A further shows user 502 performing a gesture 506 directed to (e.g., pointing at) real-world object 508-1. Real-world object 508-1 includes barcode 509. In some embodiments, a real-world object includes a different type of machine-readable code (e.g., a QR code or App Clip code).

FIG. 5B shows audio feedback 510 from wearable audio output device 301. Audio feedback 510 is responsive to gesture 506 and corresponds to real-world object 508-1. In accordance with some embodiments, wearable audio output device 301 uses context of user 502 to generate audio feedback 510. In accordance with some embodiments, wearable audio output device 301 uses information from one or more sensors (e.g., sensor(s) 311) to detect gesture 506 and/or identify real-world object 508-1. In some embodiments, wearable audio output device 301 uses information from one or more sensors (e.g., sensor(s) 311) of the wearable audio output device 301 to determine that gesture 506 is directed to real-world object 508-1 as opposed to being directed to another object, such as real-world object 508-2. In some embodiments, wearable audio output device 301 scans barcode 509 (e.g., using sensor 311) to obtain data about real-world object 508-1. For example, audio feedback 510 indicates that real-world object 508-1 is a package received from the user's mother on the previous day. In some embodiments, wearable audio output device 301 receives information from one or more other devices (e.g., portable multifunction device 100 and/or HMD 100b) and uses the received information to generate audio feedback 510. In some embodiments, wearable audio output device 301 provides haptic feedback in response to gesture 506 (e.g., alternatively to, or in addition to audio feedback 510). In some embodiments, HMD 100b provides audio, haptic, and/or visual feedback in response to gesture 506.

FIG. 5C shows user 502 wearing wearable audio output device 301 (e.g., earbuds) and HMD 100b. FIG. 5C also shows real-world object 508-2 (e.g., a digital clock) near user 502. FIG. 5C further shows user 502 listening to music 520 output by wearable audio output device 301. Wearable audio output device 301 is communicatively coupled to portable multifunction device 100 as indicated by arrowed line 514. In some embodiments, music 520 corresponds to an application (e.g., a music application) executing on portable multifunction device 100. FIG. 5C shows user interface 516 corresponding to music 520. In some embodiments, user interface 516 is displayed on portable multifunction device 100. User interface 516 includes a playback control 518 (e.g., a pause element). Selection of playback control 518 causes music 520 to cease to be output (e.g., causes music 520 to be paused). In some embodiments, user interface 516 is not displayed (e.g., wearable audio output device 301 and/or portable multifunction device 100 is responsive to user inputs to control playback of music 520 without display of user interface 516). In some embodiments, wearable audio output device 301 is responsive to user input (e.g., via input device(s) 308) to control playback of music 520. FIG. 5C further shows user 502 performing a gesture 512 directed to (e.g., pointing at) real-world object 508-2. In some embodiments, other gestures are used to indicate a real-world object (e.g., a tap gesture, a nod gesture, a circling gesture, and/or other type of gesture). Real-world object 508-2 includes a display of the current time (e.g., real-world object 508-2 is a digital clock).

FIG. 5D shows audio feedback 522 from wearable audio output device 301. Audio feedback 522 is responsive to gesture 512 and corresponds to real-world object 508-2. In accordance with some embodiments, wearable audio output device 301 uses context of user 502 to generate audio feedback 522 (e.g., to determine that real-world object 508-2 is a bedroom clock of the user 502). In accordance with some embodiments, wearable audio output device 301 uses information from one or more sensors (e.g., sensor(s) 311) to detect gesture 512 and/or identify real-world object 508-2. In some embodiments, wearable audio output device 301 uses information from one or more sensors (e.g., sensor(s) 311) to determine that gesture 512 is directed to real-world object 508-2. In some embodiments, wearable audio output device 301 analyzes a display of real-world object 508-2 to obtain data about real-world object 508-2. For example, audio feedback 522 indicates the current time (9:17 AM) obtained from real-world object 508-2. In some embodiments, wearable audio output device 301 receives information from one or more other devices (e.g., portable multifunction device 100 and/or HMD 100b) and uses the received information to generate audio feedback 522. For example, wearable audio output device 301 may use location information from portable multifunction device 100 to determine that real-world object 508-2 is located in a bedroom of user 502. In some embodiments, wearable audio output device 301 provides haptic feedback in response to gesture 512 (e.g., alternatively to, or in addition to audio feedback 510). In some embodiments, HMD 100b provides audio, haptic, and/or visual feedback in response to gesture 512.

FIG. 5E shows user 502 wearing wearable audio output device 301 (e.g., headphones) and HMD 100b. In some embodiments, user 502 is not wearing HMD 100b (e.g., is only wearable audio output device 301). FIG. 5E also shows real-world object 508-3 (e.g., a calendar) near user 502. FIG. 5E further shows user 502 performing gesture 528 directed to real-world object 508-3 (e.g., pointing at a particular day shown on the calendar).

FIG. 5F shows audio feedback 530 from wearable audio output device 301. Audio feedback 530 is responsive to gesture 528 and corresponds to real-world object 508-3. In accordance with some embodiments, wearable audio output device 301 uses context of user 502 to generate audio feedback 530 (e.g., to determine availability of user 502 on a particular date). In accordance with some embodiments, wearable audio output device 301 uses information from one or more sensors (e.g., sensor(s) 311) to detect gesture 528 and/or identify real-world object 508-3. In some embodiments, wearable audio output device 301 uses information from one or more sensors (e.g., sensor(s) 311) to determine that gesture 528 is directed to real-world object 508-3 (e.g., directed to a particular portion of real-world object 508-3). In some embodiments, wearable audio output device 301 analyzes real-world object 508-3 to obtain data about text on real-world object 508-3. For example, audio feedback 530 indicates a date (October 1^{st}) obtained from real-world object 508-3. In some embodiments, wearable audio output device 301 receives information from one or more other devices (e.g., portable multifunction device 100 and/or HMD 100b) and uses the received information to generate audio feedback 530. For example, wearable audio output device 301 may use calendar information from portable multifunction device 100 to determine that user 502 has a meeting with a contact named John on October 1^{st}. In some embodiments, wearable audio output device 301 provides haptic feedback in response to gesture 512 (e.g., alternatively to, or in addition to audio feedback 510). In some embodiments, HMD 100b provides audio, haptic, and/or visual feedback in response to gesture 512. Thus, FIGS. 5A-5F illustrate example user interfaces and user interactions for gesturing at real-world objects (e.g., detected via wearable audio output device 301) and obtaining audio feedback related to the indicated objects (e.g., provided by the wearable audio output device 301) in accordance with some embodiments.

FIG. 5G shows user 502 wearing wearable audio output device 301 (e.g., headphones) and HMD 100b. In some embodiments, user 502 is not wearing HMD 100b (e.g., is only wearable audio output device 301). FIG. 5G also shows notepad 534 (e.g., a real-world object) near user 502 at a first time. FIG. 5G further shows user 502 holding a writing instrument 532 (e.g., a pen or pencil). FIG. 5H shows notepad 534 at a second time, subsequent to the first time. In FIG. 5H notepad 534 includes writing 535 (e.g., notes) on it. For example, user 502 has written writing 535 using writing instrument 532. In some embodiments, writing 535 comprises virtual writing (e.g., corresponding to user 502 writing with their finger and/or a stylus) that is displayed via HMD 100b.

FIG. 5I shows user 502 performing gesture 536 (e.g., circling text on notepad 534). In FIG. 5I, user 502 is performing gesture 536 using a writing instrument. In some embodiments, user 502 performs gesture 536 using their finger (e.g., pointing at, circling, and/or otherwise indicating the text “Call John”). FIG. 5J shows selected portion 538 on notepad 534 (e.g., the result of gesture 536) corresponding to gesture 536. In some embodiments, gesture 536 selects the text within selected portion 538. In some embodiments, selected portion 538 includes a visible line (e.g., drawn in pencil or ink). In some embodiments, selected portion 538 has an invisible boundary (e.g., traced by user 502 using their finger or a stylus). In some embodiments, selected portion 538 has a virtual boundary line (e.g., displayed via HMD 100b). Although FIG. 5I shows selected portion 538 having a circular shape, in some embodiments, selected portion 538 has a non-circular shape (e.g., an oval shape, a rectangular shape, or an irregular shape). In some embodiments, selected portion 538 is defined and/or indicated by underlining of text.

FIG. 5K shows user 502 wearing wearable audio output device 301 (e.g., headphones) and HMD 100b. In some embodiments, user 502 is not wearing HMD 100b (e.g., is only wearable audio output device 301). FIG. 5K further shows user 502 performing gesture 540 directed to selected portion 538 with text (“Call John”). In some embodiments, gesture 540 is a pointing gesture (e.g., in which the user's finger does not touch notepad 534). In some embodiments, gesture 540 is a tap gesture (e.g., in which the user's finger touches selected portion 538 of notepad 534. FIG. 5K also shows portable multifunction device 100 (e.g., a companion device of wearable audio output device 301).

FIG. 5L shows audio feedback 542 being provided to user 502 by wearable audio output device 301 in response to gesture 540. Audio feedback 542 indicates that user 502 should hold gesture 540 for two seconds to perform an operation (e.g., initiate a phone call) corresponding to selected portion 538. FIG. 5L also shows user 502 continuing gesture 540. In some embodiments, haptic and/or visual feedback is provided in response to gesture 540 (e.g., in addition to, or alternatively to, audio feedback 542). In some embodiments, the haptic feedback is provided by wearable audio output device 301 and/or HMD 100b. In some embodiments, the haptic and/or visual feedback is provided by HMD 100b.

FIG. 5M shows feedback 544 being provided to user 502 by wearable audio output device 301 in response to user 502 maintaining gesture 540. For example, FIG. 5M may correspond to a point in time one second after the time shown in FIG. 5L. In some embodiments, feedback 544 comprises audio and/or haptic feedback. In some embodiments, feedback 544 is progressive feedback that changes over time as user 502 continues gesture 540. In some embodiments, feedback 544 indicates how long user 502 has maintained gesture 540 (e.g., indicating that user 502 has maintained the gesture for at least a first threshold amount of time). In some embodiments, audio, visual, and/or haptic feedback is provided to user 502 (e.g., in addition to, or alternatively to, feedback 544) via HMD 100b. FIG. 5M also shows user 502 continuing gesture 540.

FIG. 5N shows audio feedback 546 being provided to user 502 by wearable audio output device 301 in response to user 502 continuing to maintain gesture 540. For example, FIG. 5N may correspond to a point in time one second after the time shown in FIG. 5M. Audio feedback 546 indicates that a call is being initiated (via portable multifunction device 100) to a mobile number for a contact named John. The call is initiated in FIG. 5N in response to user 502 maintaining gesture 540 for at least a second threshold amount of time (e.g., 2 seconds as indicated by audio feedback 542 in FIG. 5L). FIG. 5N further shows user interface 548 on portable multifunction device 100 indicating that portable multifunction device 100 is initiating a call to a mobile phone number for John. In some embodiments, in response to user 502 continuing to maintain gesture 540 for at least the second threshold amount of time, wearable audio output device 301 initiates the call. In some embodiments, in response to user 502 continuing to maintain gesture 540 for at least the second threshold amount of time, wearable audio output device 301 sends a command to portable multifunction device 100 to initiate the call. In some embodiments, portable multifunction device 100 initiates the call without displaying user interface 548. In some embodiments, wearable audio output device 301 initiates the call without providing audio feedback 546 (e.g., the audio of the call, such as a ring tone, is used to notify user 502 that the call has been initiated). Thus, FIGS. 5G-5N illustrate example user interfaces and user interactions for writing text, selecting a portion of the written text, and initiating a call in response to a gesture toward the selected portion (e.g., detected via wearable audio output device 301) in accordance with some embodiments.

FIGS. 5O-5Q show user 502 performing gesture 550 (e.g., a tracing gesture) directed to a portion 554 of notepad 534. In FIG. 5O, user 502 has begun gesture 550 with their finger at position 550-a. In some embodiments, gesture 550 is an air gesture performed without touching notepad 534. In some embodiments, gesture 550 is performed on a surface of notepad 534. In the example of FIGS. 5O-5Q, gesture 550 is performed using the user's finger. In some embodiments, gesture 550 is performed with a writing instrument (e.g., a pen, a pencil, a stylus, or another type of writing instrument). In FIG. 5P, user 502 has continued gesture 550 with their finger moving to position 550-b. In some embodiments, HMD 100b displays an indication (e.g., a line) of the progress of gesture 550. In the example of FIG. 5P, wearable audio output device 301 provides feedback 552 corresponding to gesture 550. In some embodiments, feedback 552 comprises audio and/or haptic feedback. In some embodiments, feedback 552 indicates the progress of gesture 550. In FIG. 5Q, user 502 has completed gesture 550 with their finger at position 550-c (e.g., has drawn an oval around portion 554 on notepad 534). In some embodiments, wearable audio output device 301 and/or HMD 100b provides audio and/or haptic feedback indicating that user 502 has completed gesture 550. In some embodiments, HMD 100b provides visual feedback that user 502 has completed gesture 550.

FIG. 5R shows wearable audio output device 301 providing audio feedback 556 in response to user 502 completing gesture 550. Audio feedback 556 indicates to user 502 that the text in portion 554 has been added to an active notebook 558. In accordance with some embodiments, notebook 558 corresponds to a note taking application executing on portable multifunction device 100. FIG. 5R further shows notebook 558 displayed on portable multifunction device 100 with text 560 copied from portion 554 of notepad 534. In some embodiments, wearable audio output device 301 detects completion of gesture 550 and analyzes the text in portion 554 of notepad 534. In some embodiments, wearable audio output device 301 transmits the text to portable multifunction device 100 to be stored and associated with notebook 558. In some embodiments, notebook 558 and/or text 560 is displayed via HMD 100b (e.g., in addition to, or alternatively to, being displayed on portable multifunction device 100). Thus, FIGS. 5O-5R illustrate example user interfaces and user interactions for adding text to a notebook in response to a gesture (e.g., detected via wearable audio output device 301) in accordance with some embodiments.

FIGS. 6A-6H illustrate example user interactions involving real-world objects and feedback from wearable devices in accordance with some embodiments. FIG. 6A shows user 602 wearing wearable audio output devices 301-1 and 301-2 (e.g., earbuds) and HMD 100b. In some embodiments, user 602 is not wearing HMD 100b (e.g., is only wearable audio output devices 301). User 602 in FIG. 6A is beyond geofence boundary 604. In some embodiments, geofence boundary 604 corresponds to a location previously geofenced by user 602. In some embodiments, geofence boundary 604 corresponds to a home or office of user 602. In some embodiments, geofence boundary 604 has previously been defined by user 602. In some embodiments, geofence boundary 604 is defined by a different user and shared with wearable audio output devices 301 (e.g., shared via a network connection and/or a companion device).

FIG. 6B shows user 602 crossing geofence boundary 604 and, in response, receiving feedback 606 from wearable audio output devices 301. In some embodiments, feedback 606 comprises audio and/or haptic feedback. For example, feedback 606 comprises a beep or tone to indicate to user 602 that they have entered a geofenced location. In some embodiments, wearable audio output devices 301 provide a first type of feedback in response to a user entering a geofenced location and provide a second type of feedback in response to the user exiting the geofenced location. In some embodiments, HMD 100b provides audio, visual, and/or haptic feedback in response to user 602 crossing geofenced boundary 604 (e.g., in addition to, or alternatively to, feedback 606). In some embodiments, wearable audio output devices 301 determine that user 602 has crossed geofence boundary 604 based on sensor data (e.g., from sensor(s) 311) generated at wearable audio output devices 301 and/or received from other devices (e.g., a companion device such as portable multifunction device 100). FIG. 6B further shows real-world objects 610-1, 610-2, and 610-3 within geofenced boundary 604.

FIG. 6C shows user 602 performing gesture 612 (e.g., pointing) toward real-world object 610-1 and asking question 614 (“What is that?”). In some embodiments, wearable audio output devices 301 and/or HMD 100b detect question 614 via one or more microphones (e.g., microphone(s) 302). In some embodiments, wearable audio output devices 301 and/or HMD 100b detect gesture 612 via one or more sensors (e.g., sensor(s) 311). Although FIG. 6C shows user 602 asking question 614, in some embodiments, gesture 612 is performed without a verbal question (e.g., the gesture implies the question).

FIG. 6D shows audio feedback 616 provided in response to gesture 612 and question 614. Audio feedback 616 includes information about real-world object 610-1 (e.g., obtained from an analysis of image(s) of real-world object 610-1). In some embodiments, the audio feedback indicates an object type for the real-world object (e.g., that it is a box). In some embodiments, the audio feedback includes information about an appearance of the real-world object (e.g., a size, a color, a material, a texture, and/or other appearance information). In some embodiments, the audio feedback includes context information (e.g., based on a context of the user). Audio feedback 616 states that real-world object 610-1 is a cardboard box in the example of FIG. 6D. In accordance with some embodiments, audio feedback 616 is provided as spatial feedback that corresponds to (e.g., appears to emanate from) a location of object 610-1. Spatializing audio feedback simulates a more realistic listening experience in which audio seems to come from sources of sound in a particular frame of reference, such as the physical environment surrounding the user. For example, audio feedback 616 is provided as spatial audio from a simulated location corresponding to the location of real-world object 610-1 relative to wearable audio output devices 301. In some embodiments, audio feedback 616 is not provided if user 602 is outside of geofenced boundary 604 when performing gesture 612 and/or asking question 614. As an example, when spatial audio is enabled, the audio that is output from the car-worn audio output device (e.g., earbuds) sounds as though the respective audio for each real-world object is coming from a different, simulated spatial location (which may change over time) in a frame of reference, such as a physical environment (e.g., a surround sound effect). The positioning (simulated spatial locations) of the real-world objects is independent of movement of earbuds relative to the frame of reference.

FIG. 6E shows user 602 performing gesture 618 (e.g., pointing) toward real-world object 610-3 and asking question 620 (“What is that?”). In some embodiments, wearable audio output devices 301 and/or HMD 100b detect question 620 via one or more microphones (e.g., microphone(s) 302). In some embodiments, wearable audio output devices 301 and/or HMD 100b detect gesture 618 via one or more sensors (e.g., sensor(s) 311). In some embodiments, gesture 618 and question 620 are detected concurrently. In some embodiments, gesture 618 is detected before or after question 620 (e.g., gesture 618 and question 620 are correlated in accordance with being detected within a threshold amount of time of one another). In the example of FIG. 6E, question 620 is spoken in a normal tone of voice (e.g., is not shouted or whispered).

FIG. 6F shows audio feedback 622 provided in response to gesture 618 and question 620. Audio feedback 622 includes information about real-world object 610-3 (e.g., obtained from an analysis of image(s) of real-world object 610-3). In some embodiments, the audio feedback indicates an object type for the real-world object (e.g., that it is a traffic cone). In some embodiments, the audio feedback includes information about an appearance of the real-world object (e.g., that real-world object 610-3 is orange). In some embodiments, the audio feedback includes context information (e.g., that real-world object 610-3 appeared at that location a day prior). In accordance with some embodiments, audio feedback 622 is provided as spatial feedback that corresponds to a relative location of object 610-3. FIG. 6F also shows audio feedback 622 being provided at a volume level 626-1 as shown on volume indicator 624. In some embodiments, volume level 626-1 is based on a volume of question 620. In some embodiments, volume level 626-1 is based on a volume setting of wearable audio output devices 301 and/or an ambient sound level of the physical environment in which wearable audio output devices 301 are located.

FIG. 6G shows user 602 performing gesture 618 (e.g., pointing) toward real-world object 610-3 and whispering question 630 (“What is that?”). In some embodiments, wearable audio output devices 301 and/or HMD 100b detect question 630 via one or more microphones (e.g., microphone(s) 302). In the example of FIG. 6G, question 630 is spoken in a different tone of voice than question 620 in FIG. 6E (e.g., is whispered instead of spoken). Questions 620 and 630 include the same words but are spoken differently.

FIG. 6H shows audio feedback 632 provided in response to gesture 618 and question 630. Audio feedback 632 includes information about real-world object 610-3 (e.g., obtained from an analysis of image(s) of real-world object 610-3). FIG. 6H also shows audio feedback 632 being provided at volume level 626-2 (lower than volume level 626-1) as shown on volume indicator 624. In some embodiments, volume level 626-2 is based on a volume of question 630. In some embodiments, volume level 626-2 is based on a volume setting of wearable audio output devices 301 and/or an ambient sound level of the physical environment in which wearable audio output devices 301 are located. In accordance with some embodiments, audio feedback 632 includes different information than audio feedback 622 based on differences in the tone of voice of user 602 in uttering questions 620 and 630 (and/or different volume levels for questions 620 and 630). In accordance with some embodiments, audio feedback 632 is provided as spatial feedback that corresponds to (e.g., appears to emanate from) a location of object 610-3. Thus, FIGS. 6A-6H illustrate example user interactions for gesturing at, and asking about, real-world objects (e.g., detected via wearable audio output device 301) within a geofenced location and obtaining audio feedback related to the indicated objects (e.g., provided by the wearable audio output device 301) in accordance with some embodiments.

FIGS. 7A-7K illustrate example user interactions with wearable devices involving various alert conditions in accordance with some embodiments. FIG. 7A includes a perspective view 701-1 and a corresponding top-down view 701-2 and shows user 702 wearing wearable audio output device 301 (e.g., a headset). Wearable audio output device 301 is outputting music 704 in FIG. 7A. FIG. 7A also indicates that an active noise cancellation (ANC) mode is enabled at level 710-a and music 704 has a corresponding media volume level 712-a. FIG. 7A also shows a puddle 706 representing a potential hazard in the street in front of user 702. In accordance with some embodiments, wearable audio output device 301 does not provide feedback (a notification) for puddle 706 in FIG. 7A in accordance with a determination that puddle 706 is more than a threshold distance from user 702 and/or a determination that user 702 is not moving toward puddle 706. Top-down view 701-2 also shows field of view 711 for user 702.

FIG. 7B includes a perspective view and a corresponding top-down view and shows user 702 crossing the street toward puddle 706, and, in response, wearable audio output device 301 detecting an alert condition. In some embodiments, the alert condition is based on a distance between user 702 and puddle 706. In some embodiments, wearable audio output device 301 detects puddle 706 using data from one or more sensors (e.g., sensor(s) 311). In some embodiments, the alert condition is based on user 702 approaching puddle 706. In some embodiments, the alert condition is determined based on an assessed likelihood of user 702 slipping or tripping due to stepping in puddle 706. In some embodiments, the alert condition is based on one or more user preferences (e.g., to avoid stepping in puddles). In some embodiments, the alert condition is based on a line of sight of user 702 (e.g., an assessment of whether user 702 is likely to notice the puddle). In accordance with detecting the alert condition, the ANC in FIG. 7B is reduced from level 710-a (e.g., as shown in FIG. 7A) to level 710-b and media volume is reduced from volume level 712-a (e.g., as shown in FIG. 7A) to volume level 712-b. In some embodiments, ANC is reduced in accordance with detecting the alert condition, and media volume is unchanged. In some embodiments, media volume is reduced (and/or media playback is paused) in accordance with detecting the alert condition, and ANC is unchanged. In some embodiments, whether media is paused or media volume is lowered is based on a type of media (e.g., volume is lowered for music and playback is paused for audio content from other sources).

FIG. 7C includes a perspective view and a corresponding top-down view and shows user 702 wearing wearable audio output device 301. Wearable audio output device 301 is playing back media in FIG. 7C as indicated by media playback indicator 718. FIG. 7C also indicates that an active noise cancellation (ANC) mode is enabled at level 716-a. FIG. 7C also shows a ball 720 approaching user 702 from the front (e.g., within field of view 711) and representing a potential hazard. In some embodiments, wearable audio output device 301 detects ball 720 using data from one or more sensors (e.g., sensor(s) 311). In accordance with some embodiments, wearable audio output device 301 does not provide feedback (a notification) for ball 720 in FIG. 7C in accordance with a determination that ball 720 is more than a threshold distance from user 702 and/or a determination that ball 720 is within field of view 711. In some embodiments, wearable audio output device 301 does not provide feedback (a notification) for ball 720 in FIG. 7C in accordance with a determination that ball 720 is unlikely to contact user 702. FIG. 7D shows ball 720 behind user 702 (e.g., having passed user 702). In FIG. 7D, wearable audio output device 301 does not provide feedback (e.g., a notification) for ball 720 in accordance with a determination that ball 720 is moving away from user 702. In FIGS. 7C and 7D, the ANC remains at level 716-a and media continues playing, e.g., in accordance with an alert condition not being detected.

FIG. 7E includes a perspective view and a corresponding top-down view and shows user 702 wearing wearable audio output device 301. Wearable audio output device 301 is playing back media in FIG. 7E as indicated by media playback indicator 718 and ANC mode is enabled at level 716-a. FIG. 7E also shows a ball 720 behind user 702 (e.g., outside of field of view 711) and representing a potential hazard. In accordance with some embodiments, wearable audio output device 301 does not provide feedback (e.g., a notification) for ball 720 in FIG. 7E in accordance with a determination that ball 720 is more than a threshold distance from user 702 and/or a determination that ball 720 is not moving closer to user 702. In FIG. 7E, the ANC remains at level 716-a and media continues playing, e.g., in accordance with an alert condition not being detected.

FIG. 7F includes a perspective view and a corresponding top-down view ball 720 approaching user 702 from behind (e.g., outside of field of view 711 of user 702), and, in response, wearable audio output device 301 detecting an alert condition and providing audio feedback 722. In some embodiments, the alert condition is based on a distance between user 702 and ball 720. In some embodiments, the alert condition is based on ball 720 approaching user 702 from a location that is out of field of view 711. In some embodiments, the alert condition is determined based on an assessed likelihood of ball 720 colliding with user 702. In some embodiments, the alert condition is based on one or more user preferences (e.g., a preference for more caution for conditions occurring behind the user). In some embodiments, the alert condition is based on a line of sight of user 702 (e.g., an assessment of whether user 702 is likely to notice the ball). In accordance with detecting the alert condition, the ANC in FIG. 7F is reduced from level 716-a (e.g., as shown in FIG. 7E) to level 716-b and media playback is paused as indicated by media playback indicator 718. In some embodiments, ANC is reduced in accordance with detecting the alert condition, and media playback is unchanged. In some embodiments, media playback is paused in accordance with detecting the alert condition, and ANC is unchanged.

FIG. 7G includes a perspective view and a corresponding top-down view and shows user 702 wearing wearable audio output device 301. User 702 is waiting to cross the road in FIG. 7G. An ANC mode is enabled for wearable audio output device 301 in FIG. 7G with a corresponding ANC level 716-a. In FIG. 7G, an active transparency mode of wearable audio output device 301 is disabled as indicated by level 726-a and a conversation boost mode is also disabled as indicated by boost indicator 728. FIG. 7G also shows a person 730 approaching user 702 from outside of field of view 711 of user 702. Person 730 in FIG. 7G is hailing user 702 as indicated by statement 732 (e.g., “Hey John, wait up!”).

FIG. 7H includes a perspective view and a corresponding top-down view and shows wearable audio output device 301 detecting an alert condition in response to person 730 calling out to user 702 in FIG. 7G. In some embodiments, the alert condition is based on a distance between user 702 and person 730. In some embodiments, wearable audio output device 301 detects person 730 using data from one or more sensors (e.g., sensor(s) 311 and/or microphone(s) 302). In some embodiments, the alert condition is based on person 730 approaching user 702 and/or being outside of field of view 711 of user 702. In some embodiments, the alert condition is determined based on an assessed likelihood of user 702 noticing person 730. In some embodiments, the alert condition is based on one or more user preferences (e.g., to notify the user if being hailed by someone). In some embodiments, the alert condition is based on a line of sight of user 702 (e.g., an assessment of whether user 702 is likely to notice person 730). In accordance with detecting the alert condition, the ANC in FIG. 7H is reduced from level 716-a (e.g., as shown in FIG. 7G) to level 716-b (e.g., ANC is disabled), active transparency is increased from volume level 726-a (e.g., as shown in FIG. 7G) to volume level 726-b (e.g., active transparency is enabled), and conversation boost mode is enabled as indicated by indicator 728. In some embodiments, ANC is disabled in response to the alert condition and active transparency and/or conversation boost is unchanged. In some embodiments, ANC, active transparency, and/or conversation boost are adjusted in response to an alert condition in accordance with a determination that the alert condition includes an audio component (e.g., a user being hailed, a vehicle horn, a crash sound, or other type of audio feature). In some embodiments, level 726-b of active transparency is based on a volume of statement 732 (e.g., a lower volume of statement 732 correspond to a higher level of active transparency). In some embodiments, conversation boost mode is enabled in accordance with a volume of statement 732 being below a threshold volume level. FIG. 7H further shows wearable audio output device 301 providing audio feedback 736 (e.g., “Your friend Kacie is trying to catch up to you”) in response to detecting the alert condition. In accordance with some embodiments, audio feedback 736 includes context information of user 702 (e.g., identifying Kacie as a friend of the user).

FIG. 7I includes a perspective view and a corresponding top-down view and shows user 702 wearing wearable audio output device 301. User 702 is waiting to cross the road in FIG. 7I. An ANC mode is enabled for wearable audio output device 301 in FIG. 7I with a corresponding ANC level 716-a. In FIG. 7I, an active transparency mode of wearable audio output device 301 is disabled as indicated by level 726-a and a conversation boost mode is also disabled as indicated by boost indicator 728. FIG. 7I also shows person 740 and person 742 outside of field of view 711 of user 702. FIG. 7J shows person 740 and person 742 arguing outside of field of view 711 of user 702, as indicated by exclamation 744. In some embodiments, wearable audio output device 301 determines that people are arguing based on audio and/or body movements.

FIG. 7K shows wearable audio output device 301 detecting an alert condition in response to persons 740 and 742 arguing. In some embodiments, the alert condition is based on a distance between user 702 and persons 740 and 742. In some embodiments, wearable audio output device 301 detects persons 740 and 742 arguing using data from one or more sensors (e.g., sensor(s) 311 and/or microphone(s) 302). In some embodiments, the alert condition is based on persons 740 and 742 being outside of field of view 711 of user 702. In some embodiments, the alert condition is determined based on an assessed likelihood of user 702 noticing persons 740 and 742 arguing. In some embodiments, the alert condition is based on one or more user preferences (e.g., to notify the user if people are arguing or fighting nearby). In some embodiments, the alert condition is based on a line of sight of user 702 (e.g., an assessment of whether user 702 is likely to notice the argument). In accordance with detecting the alert condition, the ANC in FIG. 7K is reduced from level 716-a (e.g., as shown in FIG. 7J) to level 716-b (e.g., ANC is disabled), active transparency is increased from volume level 726-a (e.g., as shown in FIG. 7J) to volume level 726-c (e.g., active transparency is enabled), and conversation boost mode is unchanged as indicated by indicator 728. In some embodiments, ANC is disabled in response to the alert condition and active transparency and/or conversation boost is unchanged. In some embodiments, ANC, active transparency, and/or conversation boost are adjusted in response to an alert condition in accordance with a determination that the alert condition includes an audio component (e.g., an argument or other type of audio feature). In some embodiments, level 726-c of active transparency is based on a volume of exclamation 746. In some embodiments, conversation boost mode is enabled in accordance with a relative volume of exclamation 746 compared to other noises in the physical environment. FIG. 7K further shows wearable audio output device 301 providing audio feedback 748 (e.g., “Heads up: the people behind you may be fighting”) in response to detecting the alert condition. In accordance with some embodiments, audio feedback 748 includes information about the relative location of the alert condition (e.g., behind the user). FIG. 7K further shows alert 750 displayed on portable multifunction device 100 in response to detecting the alert condition. Alert 750 includes image 752 of persons 740 and 742 arguing (e.g., an image captured by wearable audio output device 301). In some embodiments, alert 750 is generated in accordance with a user preference (e.g., a user preference to get audio and visual information for alert conditions). In some embodiments, alert 750 is generated in accordance with a determination that wearable audio output device 301 is coupled to a display generation component (e.g., a display generation component of portable multifunction device 100). In some embodiments, a visual alert is generated in accordance with the alert condition being a first type of alert condition (e.g., nearby fighting), and a visual alert is not generated in accordance with the alert condition being a second type of alert condition (e.g., a puddle in the user's path). Thus, FIGS. 7A-7K illustrate example user interfaces and user interactions for generating audio feedback in response to alert conditions (e.g., detected via wearable audio output device 301) in accordance with some embodiments.

FIGS. 8A-8P illustrate example user interactions with wearable devices in accordance with some embodiments. FIG. 8A shows user 802 wearing wearable audio output device 301 (e.g., earbuds) and HMD 100b. In some embodiments, user 802 is not wearing HMD 100b (e.g., is only wearable audio output device 301). FIG. 8A also indicates that an active noise cancellation (ANC) mode is enabled for wearable audio output device 301 at level 808-a, active transparency mode is at level 810-a (e.g., disabled), and conversation boost mode is disabled as indicated by boost indicator 812.

FIG. 8B shows user 802 performing air gesture 804 in a detection region 806. In some embodiments, detection region 806 is defined relative to wearable audio output device 301. In some embodiments, detection region 806 corresponds to a sensor detection range of a sensor of wearable audio output device 301 (e.g., sensor(s) 311). In some embodiments, detection region 806 is a three-dimensional region (e.g., with predetermined dimensions). For example, detection region 806 may have dimensions of 1 foot by 1 foot by 1 foot, 6 inches by 6 inches by 8 inches, 5 inches by 8 inches by 4 inches, a radius (e.g., hemisphere radius) of 1 foot, or other dimensions. In some embodiments, wearable audio output device 301 only detects gestures performed within detection region 806. In some embodiments, wearable audio output device 301 ignores and/or disregards gestures performed outside of detection region 806. In some embodiments, air gesture 804 comprises a cupping gesture in which the user's hand forms a c-shape near the user's ear. In response to detecting air gesture 804, wearable audio output device 301 performs an operation that includes adjusting the ANC in FIG. 8B from level 808-a (e.g., as shown in FIG. 8A) to level 808-b (e.g., ANC is disabled), increasing active transparency from volume level 810-a (e.g., as shown in FIG. 8A) to volume level 810-b (e.g., active transparency is enabled), and enabling conversation boost mode as indicated by indicator 812. In some embodiments, only a subset of ANC, active transparency, and conversation boost are adjusted in response to air gesture 804. For example, ANC may be disabled, and active transparency may not be enabled in response to air gesture 804.

FIG. 8C shows user 802 performing air gesture 804 outside of detection region 806. In response to the user's hand moving outside of detection region 806, wearable audio output device 301 adjusts the ANC in FIG. 8C from level 808-b (e.g., as shown in FIG. 8B) to level 808-A (e.g., ANC is re-enabled), active transparency is decreased from volume level 810-b (e.g., as shown in FIG. 8B) to volume level 810-a (e.g., active transparency is disabled), and conversation boost mode is disabled as indicated by indicator 812 (e.g., wearable audio output device 301 ceases to perform the operation of FIG. 8B).

FIG. 8D shows user 802 performing air gesture 804 in detection region 806 (e.g., the user's hand re-enters detection 806 while performing air gesture 804 after leaving as shown in FIG. 8C). In response to detecting air gesture 804 in detection region 806, wearable audio output device 301 performs an operation (e.g., resumes the operation performed in FIG. 8B) that includes adjusting the ANC in FIG. 8D from level 808-a (e.g., as shown in FIG. 8C) to level 808-b (e.g., ANC is disabled), increasing active transparency from volume level 810-a (e.g., as shown in FIG. 8C) to volume level 810-b (e.g., active transparency is enabled), and enabling conversation boost mode as indicated by indicator 812.

FIG. 8E shows user 802 wearing wearable audio output device 301 (e.g., earbuds) and HMD 100b. In some embodiments, user 802 is not wearing HMD 100b (e.g., is only wearable audio output device 301). FIG. 8A also shows wearable audio output device 301 outputting music 822. Wearable audio output device 301 in FIG. 8E is communicatively coupled to portable multifunction device 100 as indicated by arrowed line 814. In some embodiments, music 822 corresponds to an application (e.g., a music application) executing on portable multifunction device 100. FIG. 8E shows user interface 816 corresponding to music 822. In some embodiments, user interface 816 is displayed on portable multifunction device 100. User interface 816 includes a playback control 818 (e.g., a pause element) and media item indicator 820 (e.g., indicating that “Track 1” is currently playing). Selection of playback control 818 causes music 822 to cease to be output (e.g., causes music 822 to be paused). In some embodiments, user interface 816 is not displayed (e.g., wearable audio output device 301 and/or portable multifunction device 100 is responsive to user inputs to control playback of music 822 without display of user interface 816). In some embodiments, wearable audio output device 301 is responsive to user input (e.g., via input device(s) 308) to control playback of music 822.

FIG. 8F shows hand 824 of user 802 entering detection region 806. FIG. 8F also shows feedback 826 being provided by wearable audio output device 301 in response to detecting hand 824 entering detection region 806. In some embodiments, wearable audio output device 301 detects hand 824 using one or more sensors (e.g., sensor(s) 311). In some embodiments, feedback 826 comprises audio and/or haptic feedback. In some embodiments, HMD 110b provides audio, visual, and/or haptic feedback in response to hand 824 entering detection region 806 (e.g., in addition to, or alternatively to, feedback 826).

FIG. 8G shows user 802 performing air gesture 828 (e.g., a pinch gesture) within detection region 806. FIG. 8G also shows that playback of music 822 (from FIG. 8E) has ceased (e.g., music 822 is paused), as indicated by user interface 816, which includes playback control 830 (e.g., a play element) in place of playback control 818 shown in FIG. 8E. In some embodiments, playback of music 822 is paused for a preset amount of time (e.g., 5 seconds, 10 seconds, 20 seconds, or 30 seconds). In some embodiments playback of music 822 is paused until user 802 issues a command, input, and/or gesture to resume the playback. For example, playback of music 822 resumes in response to user 802 selecting playback control 830.

FIG. 8H shows hand 824 of user 802 exiting detection region 806. FIG. 8H also shows feedback 834 being provided by wearable audio output device 301 in response to detecting hand 824 exiting detection region 806. In some embodiments, wearable audio output device 301 provides feedback 834 in response to ceasing to detect hand 824 (e.g., due to hand 824 leaving detection region 806). In some embodiments, wearable audio output device 301 detects hand 824 using one or more sensors (e.g., sensor(s) 311). In some embodiments, feedback 834 comprises audio and/or haptic feedback. In some embodiments, HMD 110b provides audio, visual, and/or haptic feedback in response to hand 824 exiting detection region 806 (e.g., in addition to, or alternatively to, feedback 834). In some embodiments, feedback 834 in FIG. 8H has one or more properties that are different than feedback 826 in FIG. 8F. For example, feedback 834 includes a single beep and feedback 826 includes two or more beeps.

FIG. 8I shows user 802 with their hands at their sides. In some embodiments, one or more sensors of wearable audio output device 301 are disabled (e.g., detection region 806 is deactivated) or placed in a low power mode (e.g., using a reduced sampling or scan rate for detecting hand gestures or other events, as compared with a normal power mode in which a normal sampling or scan rate is used) while no hands are present in the region. FIG. 8I also shows media playback is paused as indicated by playback control 830 of user interface 816. FIG. 8J shows user 802 performing air gesture 836 (e.g., a double pinch gesture) within detection region 806. In some embodiments, air gesture 836 is detected by wearable audio output device 301 (e.g., via sensor(s) 311). FIG. 8J also shows the currently playing media item changing from “Track 1” in FIG. 8I to “Track 2” in FIG. 8J to in response to air gesture 836, as indicated by media item indicator 820.

FIG. 8K shows user 802 performing air gesture 840 (e.g., a pinch gesture) within detection region 806. FIG. 8K also shows that playback of music 822 (from FIG. 8E) has resumed (e.g., music 822 is no longer paused), as indicated by user interface 816, which includes playback control 818 (e.g., a pause element) in place of playback control 830 shown in FIG. 8J. As shown in FIG. 8K, music 822 resumes at “Track 2” due to detection of air gesture 836 in FIG. 8J.

FIG. 8L shows user 802 wearing wearable audio output device 301 (e.g., earbuds) and HMD 100b and performing a head gesture 841 (e.g., a head shake, nod, or other gesture). In some embodiments, head gesture 841 is detected by wearable audio output device 301 (e.g., via sensor(s) 311). For example, head gesture 841 is detected by an accelerometer in wearable audio output device 301.

FIG. 8M shows detection region 806 activated in response to head gesture 841. FIG. 8M further shows a portion 842-a (e.g., an initial portion) of air gesture 842 (e.g., a pinch portion of a gesture) being detected within detection region 806. In accordance with some embodiments, air gesture 842 corresponds to a volume adjustment operation for audio output by wearable audio output device 301. In FIG. 8M, wearable audio output device 301 has an audio output volume level at level 844-a.

FIG. 8N shows user 802 performing a portion 842-b (e.g., a subsequent or second portion) of air gesture 842 (e.g., a pinch and twist gesture). In the example of FIG. 8N, user 802 is twisting in a counterclockwise direction, which corresponds to a decrease in output volume from level 844-a (e.g., as shown in FIG. 8M) to level 844-b. In some embodiments, a magnitude of the volume adjustment is based on a speed and/or amount of movement in air gesture 842. In some embodiments, wearable audio output device 301 performs the volume adjustment operation (e.g., is responsive to the twisting action) while the pinch portion of the gesture is maintained.

FIG. 8O shows user 802 performing a portion 842-c (e.g., another portion) of air gesture 842 (e.g., a pinch and twist gesture). In the example of FIG. 8O, user 802 is twisting in a clockwise direction, which corresponds to an increase in output volume from level 844-b (e.g., as shown in FIG. 8N) to level 844-c. In some embodiments, a magnitude of the volume adjustment is based on a speed and/or amount of movement in air gesture 842. In some embodiments, wearable audio output device 301 performs the volume adjustment operation (e.g., is responsive to the twisting action) while the pinch portion of the gesture is maintained.

FIG. 8P shows user 802 no longer performing air gesture 842 (e.g., performing a first gesture 846 in detection region 806). In response to user 802 ceasing to perform air gesture 842, wearable audio output device 301 ceases to perform the volume adjustment operation. In some embodiments, a gesture ceases to be performed when the hand shape changes (e.g., the pinch gesture is no longer performed) and/or when the hand leaves the detection region 806. In some embodiments, air gesture 846 corresponds to a different operation (e.g., a power off operation) than the operation (e.g., volume adjustment) corresponding to air gesture 842. Thus, FIGS. 8A-8P illustrate example user air gestures (e.g., detected via wearable audio output device 301) and corresponding operations (e.g., performed by wearable audio output device 301 and/or HMD 100b) in accordance with some embodiments.

FIGS. 9A-9K illustrate example user interactions with wearable devices in accordance with some embodiments. In the examples of FIGS. 9A-9K, user 802 is wearing a wearable audio output device 301 and HMD 100b, however, in some embodiments, user 802 is wearing a different type of wearable device (e.g., a different head-worn device, ear-worn device, or other type of wearable device). In some embodiments, user 802 is not wearing HMD 100b (e.g., is only wearable audio output device 301).

FIG. 9A shows user 802 wearing wearable audio output device 301 and performing gesture 906 (e.g., a pointing gesture). FIG. 9A further shows user 802 issuing a command 908 (e.g., a verbal command) to turn on light 910. In some embodiments, turning on light 910 comprises a discrete operation (e.g., with a single output being a command for light 910 to activate). In some embodiments, wearable audio output device 301 detects command 908 via one or more microphones (e.g., microphone(s) 302). In some embodiments, wearable audio output device 301 detects gesture 906 via one or more sensors (e.g., sensor(s) 311). In the example of FIG. 9A, user 802 has their hair tucked behind their ear such that a field of view of wearable audio output device 301 is not obscured by the user's hair. FIG. 9B shows light 910 turning on in response to gesture 906 and command 908 in FIG. 9A, as indicated by illumination lines 912. In some embodiments, wearable audio output device 301 determines that gesture 906 is directed to light 910 (e.g., using data from sensor(s) 311) and transmits a command to light 910 (and/or a controller of light 910) to turn on.

FIG. 9C shows user 802 wearing wearable audio output device 301 and performing gesture 916 (e.g., a pointing gesture). FIG. 9C further shows user 802 issuing a command 914 to turn on light 910. In the example of FIG. 9C, hair of user 802 is covering wearable audio output device 301 and occluding one or more of its sensors (e.g., sensor(s) 311). In some embodiments, the occluded sensors are used to perform the operation requested by command 914 (e.g., to turn on light 910). For example, the occluded sensors include an image sensor used to determine to what object gesture 916 is directed.

FIG. 9D shows wearable audio output device 301 providing feedback 918 in response to command 914 in FIG. 9C. In some embodiments, feedback 918 is provided in accordance with a determination that a sensor of wearable audio output device 301 is occluded (e.g., sensor(s) 311). In some embodiments, feedback 918 comprises audio and/or haptic feedback. In some embodiments, feedback 918 includes an indication of the cause of the failure to perform the operation requested by command 914. FIG. 9E shows user 802 tucking their hair behind their ear with gesture 920 to resolve the occlusion of the sensors of wearable audio output device 301 (e.g., to clear the field of view of wearable audio output device 301).

FIG. 9F shows wearable audio output device 301 no longer covered by hair of user 802. FIG. 9F also shows wearable audio output device 301 providing feedback 922 in response to user 802 moving their hair in FIG. 9E. In some embodiments, feedback 922 is provided in accordance with a determination that the sensor of wearable audio output device 301 is no longer occluded. In some embodiments, feedback 922 comprises audio and/or haptic feedback. In some embodiments, feedback 922 includes one or more properties that different from feedback 918. For example, feedback 922 includes a single beep and feedback 918 includes two or more beeps.

FIG. 9G shows user 802 wearing wearable audio output device 301 and issuing a command 924 to activate a navigation assistance mode. In some embodiments, wearable audio output device 301 detects command 924 via one or more microphones (e.g., microphone(s) 302). In some embodiments, wearable audio output device 301 performs the navigation assistance mode using data from one or more sensors (e.g., sensor(s) 311). In the example of FIG. 9G, user 802 has their hair tucked behind their ear such that a field of view of wearable audio output device 301 is not obscured by the user's hair. In some embodiments, the navigation assistance mode comprises a continuous operation (e.g., scanning the physical environment of the user and providing navigation assistance).

FIG. 9H shows wearable audio output device 301 providing audio feedback 926 in accordance with navigation assistance mode being active. In some embodiments, feedback 926 includes directions for user 802 to follow. In some embodiments, feedback 926 includes haptic feedback (e.g., providing haptic vibrations when user 802 should turn). In some embodiments, the navigation assistance mode uses data from one or more sensors of wearable audio output device 301 (e.g., location data from geolocation sensors and/or image data from one or more image sensors). In some embodiments, the navigation assistance mode uses data obtained from one or more other devices (e.g., portable multifunction device 100).

FIG. 9I shows hair of user 802 covering wearable audio output device 301 and wearable audio output device 301 providing audio feedback 928. In some embodiments, wearable audio output device 301 provides audio feedback 928 in accordance with a determination that a sensor used for the navigation assistance mode is occluded (e.g., an image sensor). In some embodiments, wearable audio output device 301 provides haptic feedback in addition to, or alternatively to, providing feedback 928. In accordance with some embodiments, feedback 928 includes a suggestion of an action user 802 can perform to attempt to resolve the error (e.g., remove the occlusion). In the example of FIG. 9I, feedback 928 includes a suggestion for user 802 to tuck their hair behind their ear. FIG. 9J shows user 892 tucking their hair behind their ear with gesture 930 to resolve the occlusion of the sensors of wearable audio output device 301 (e.g., to clear the field of view of wearable audio output device 301).

FIG. 9K shows wearable audio output device 301 no longer covered by hair of user 802. FIG. 9K also shows wearable audio output device 301 providing feedback 932 in response to user 802 moving their hair in FIG. 9J. In some embodiments, feedback 932 is provided in accordance with a determination that the sensor of wearable audio output device 301 is no longer occluded. In some embodiments, feedback 932 comprises audio and/or haptic feedback. In some embodiments, feedback 932 includes an indication that the sensor is no longer occluded and/or an indication that the navigation assistance mode is re-enabled.

FIGS. 10A-10D are flow diagrams illustrating method 1000 for providing audio feedback related to real-world objects in accordance with some embodiments. Method 1000 is performed at an ear-worn audio output device (e.g., wearable audio output device 301 such as earbuds or headphones) that includes one or more sensors (e.g., sensor(s) 311 such as image sensors, motion sensors, and/or other types of sensors) and one or more audio output components (e.g., speaker(s) 306). In some embodiments, the ear-worn audio output device does not cover the user's eyes. In some embodiments, the ear-worn audio output device does not extend across the user's face. In some embodiments, the ear-worn audio output device does not affect the user's vision. In some embodiments, the ear-worn audio output device is an in-ear device (e.g., earbuds). In some embodiments, the ear-worn audio output device is an over-the-ear device (e.g., headphones). In some embodiments, the ear-worn audio output device is mounted to an ear of the user (e.g., mounted to the ear canal such as with earbuds, mounted to an earlobe such as with earrings, and/or mounted to the helix of the ear such as with hearing aids). Some operations in method 1000 are, optionally, combined and/or the order of some operations is, optionally, changed.

As described below, method 1000 provides an improved interface for controlling a wearable audio output device by providing audio feedback related to real-world objects in response to user gestures. Detecting and responding to user gestures reduces the number of inputs needed to provide audio feedback and makes the user-device interface more efficient (e.g., by helping the user to achieve an intended outcome and reducing user mistakes when operating/interacting with the audio output device), which reduces power usage and improves battery life (e.g., by alleviating the need to power a graphical user interface). Additionally, detecting and responding to user gestures allows for a user to not have to handle the wearable audio output device directly, which enhances the operability of the wearable audio output device and makes the user-device interface more efficient.

The ear-worn audio output device detects (1002) a user gesture via one or more sensors (e.g., sensor(s) 311, FIG. 3B) of the ear-worn audio output device. For example, FIGS. 5A-5B illustrate user 502 performing gesture 506, which is detected by wearable audio output device 301. Example user gestures include a pointing gesture, a tap gesture, and a tracing gesture. In some embodiments, the user gesture is an air gesture, in other embodiments, the user gesture is performed on a surface of a real-world object.

In some embodiments, the ear-worn audio output device comprises (1004) an audio playback device. For example, the ear-worn audio output device comprises one or more speakers (e.g., speaker(s) 306). In some embodiments, the ear-worn audio output device communicatively couples to a companion device (e.g., portable multifunction device 100, device 300, and/or HMD 100b) to playback audio provided by the companion device.

In some embodiments, the user gesture is detected (1006) while providing playback of audio content via the one or more audio output components. For example, the audio content includes music, audio from an audio book or podcast, and/or other types of audio content. As an example, FIGS. 5C-5D illustrate wearable audio output device 301 detecting gesture 512 performed by user 502 while music 520 is being played back. Detecting user gestures while providing playback of audio content reduces the number of inputs needed (e.g., the user does not need to manually stop the playback) and allows the device to automatically perform the gesture detection.

In some embodiments, the audio content is received (1008) from a companion device communicatively coupled to the ear-worn audio output device. For example, the companion device is a phone, smartwatch, music player, or other type of device. As an example, music 520 in FIG. 5C is received from portable multifunction device 100 as indicated by arrowed line 514. Receiving audio content from the companion device may reduce the operations performed by the ear-worn audio output device and/or the memory needed for operation of the ear-worn audio output device, which enhances the operability of the ear-worn audio output device and reduces power usage and improves battery life of the ear-worn audio output device.

In some embodiments, the companion device includes (1010) playback controls for controlling playback of the audio content at the ear-worn audio output device. For example, FIGS. 5C-5D illustrate user interface 516 that includes playback controls 518 and 524. In some embodiments, the companion device displays a user interface with audio playback controls. For example, the user interface includes a plurality of controls (e.g., play, pause, stop, skip ahead, rewind, change audio source, change media item, change volume, and/or other controls) for the companion device and/or the ear-worn audio output device. In some embodiments, the ear-worn audio output device detects a user input directed to (e.g., at or that occurs while attention is directed to) a first control (e.g., a pause or stop control) of the plurality controls, and, in response to detecting the user input directed to the first control, ceases the playback of the audio content at the ear-worn audio output device. In some embodiments, the ear-worn audio output device detects a user input directed to, or otherwise corresponding to, a second control (e.g., a skip ahead, rewind, or change media item control) of the plurality controls, and, in response to detecting the user input directed to the second control, changes which portion of the audio content is being played back at the ear-worn audio output device. In some embodiments, the ear-worn audio output device detects a user input directed to a volume control of the plurality controls, and, in response to detecting the user input directed to the volume control, adjusts an output volume of the audio content being played back at the ear-worn audio output device. Presenting playback controls at the companion device enhances operability of the companion device and the earn-worn audio output device (e.g., provides flexibility) and makes the user-device interface more efficient.

In some embodiments, the user gesture comprises (1012) a boundary gesture outlining a portion of the first real-world object, and the first audio feedback comprises audio feedback about real-world content on the portion of the first real-world object. As an example, FIGS. 51-5N illustrate user 502 performing gesture 536 that outlines text in portion 538 of notepad 534, and wearable audio output device 301 providing feedback 542 about text within portion 538. For example, the boundary gesture is a finger circling gesture. In some embodiments, the boundary gesture describes a boundary around the portion of the first real-world object. In some embodiments, the ear-worn audio output device detects a second user gesture via the one or more sensors of the ear-worn audio output device; and, in response to detecting the second user gesture: in accordance with a determination that the second user gesture is a boundary-type gesture directed to a portion of the first real-world object, the ear-worn audio output device provides third audio feedback corresponding to real-world content on the portion of the first real-world object. In some embodiments, the real-world content on the portion of the first real-world object comprises a musical note, or sequence of musical notes, and the audio feedback comprises playback of the musical note, or sequence of musical notes. Detecting and being responsive in different ways to different types of gestures enhances operability of the device (e.g., provides flexibility without cluttering the user interface with additional displayed controls, as well as reducing the number of inputs needed to access this flexibility) and makes the user-device interface more efficient.

In some embodiments, the real-world content on the portion of the first real-world object comprises (1014) text, and the ear-worn audio output device provides an indication (e.g., a visual or audio indication) that text from the first real-world object has been selected (e.g., by displaying a copy of the text on a display of a companion device and/or outputting audio corresponding to the text at the ear-worn device). As an example, FIGS. 5O-5R illustrate text in portion 554 being added to an active notebook in response to gesture 550, and wearable audio output device 301 providing feedback 556 indicating that the text has been selected. For example, a copy of the text is stored at the ear-worn audio output device and/or a companion device in communication with the ear-worn audio output device. In some embodiments, the audio feedback about the real-world content on the portion of the first real-world object comprises an indication that the text is copied to the ear-worn audio output device and/or the companion device (e.g., is copied to a virtual clipboard of a device). Providing the indication that the text from the real-world object has been selected provides improved feedback about a state of the ear-worn audio output device.

In some embodiments, the ear-worn audio output device adds (1016) the text to a document associated with the ear-worn audio output device and/or a companion device. As an example, FIGS. 5Q-5R illustrate text from portion 554 being added to notebook 558. For example, the text is added to an active notes document. In some embodiments, the user gesture indicates which document to which to add the text. For example, the user gesture includes a voice command, and the voice command indicates which document to which to add the text. Adding the text to the document in response to the gesture enables the text operation to be performed without displaying additional controls and reducing the number of inputs needed to perform the text operation.

In some embodiments, in response to detecting at least a portion of the user gesture, the ear-worn audio output device provides (1020) feedback corresponding to the user gesture. For example, FIGS. 5O-5P illustrate wearable audio output device 301 detecting portion 550-a of gesture 550 and, in response, providing feedback 552 about gesture 550. In some embodiments, the feedback corresponding to the user gesture includes audio and/or haptic feedback. As an example, the feedback corresponding to the user gesture includes an indication of a start of the user gesture, a dwell of the user gesture, and/or an end of the user gesture. For example, the user gesture comprises a touch-and-hold gesture and the feedback corresponding to the user gesture includes a sound at a start of the touch-and-hold gesture and/or a sound at the end of the touch-and-hold gesture. In some embodiments, the feedback corresponding to the user gesture includes an indication of an action corresponding to the user gesture. For example, the user gesture is directed to a musical object (e.g., a music album or sheet music), and the feedback corresponding to the user gesture includes an indication that music corresponding to the musical object (e.g., a musical preview) will be played in response to completion of the gesture. As another example, the user gesture is directed to an object with text in a language that is different from a language assigned to the user, and the feedback corresponding to the user gesture indicates that a translation of the text will be played in response to completion of the gesture. Providing feedback corresponding to the user gesture provides improved feedback about a state of the ear-worn audio output device.

In some embodiments, the feedback corresponding to the user gesture comprises (1022) feedback indicating a dwell of the user gesture. As an example, FIG. 5M shows wearable audio output device 301 providing feedback 544 about gesture 540, which may indicate the dwell of gesture 540. For example, the gesture is a touch-and-hold gesture, and the feedback indicating a dwell of the user gesture is feedback indicating that the touch-and-hold gesture has been held for a threshold amount of time. In some embodiments, in accordance with a duration of the user gesture meeting a threshold amount of time, a dwell feedback is provided to the user; and, in accordance with the duration of the user gesture not meeting the threshold amount of time, the dwell feedback is not provided to the user. For example, if a user gesture ends before the threshold amount of time, the dwell feedback is not provided. As another example, the gesture is a touch-and-drag gesture, and the feedback indicating a dwell of the user gesture is feedback indicating that the drag portion of the gesture is being performed. Indicating a dwell of the user gesture provides improved feedback about a state of the ear-worn audio output device.

In some embodiments, the feedback corresponding to the user gesture comprises (1024) feedback indicating a progress of the user gesture. As an example, FIG. 5M shows wearable audio output device 301 providing feedback 544 about gesture 540, which may indicate the progress of gesture 540. For example, the feedback corresponding to the user gesture comprises progressive feedback indicating a progress of interaction toward an input threshold (e.g., an input threshold of 0.5 seconds, 1 second, 1.5 seconds, or 2 seconds). In some embodiments, one or more properties of the progressive feedback changes over time (e.g., to indicate progress toward the input threshold). Example properties of the progressive feedback include tone, amplitude, cadence, frequency, and/or other audio (and/or haptic) properties. Providing feedback indicating a progress of the user gesture provides improved feedback about a state of the ear-worn audio output device.

In response to detecting the user gesture (1018) and in accordance with a determination that the user gesture is a first type of gesture (e.g., an index finger pointing gesture) and is directed to a first real-world object, the ear-worn audio output device provides (1026) first audio feedback corresponding to the first real-world object via the one or more audio output components. For example, in FIGS. 5A-5B, user 502 performs gesture 506 directed to real-world object 508-1 and, in response, wearable audio output device 301 provides feedback 510 about real-world object 508-1.

In some embodiments, the ear-worn audio output device provides (1028) the first audio feedback without providing visual feedback. In some embodiments, the ear-worn audio output device does not include a display and does not provide visual feedback (e.g., only provides audio, and optionally, haptic feedback). For example, feedback 510 in FIG. 5B may be provided without any corresponding visual feedback (e.g., in embodiments in which user 502 is not wearing HMD 100b). Forgoing providing visual feedback reduces the number of components needed in the ear-worn audio output device (e.g., a display generation component is not needed), which reduces power usage and improves battery life of the ear-worn audio output device.

In some embodiments, the first audio feedback corresponding to the first real-world object comprises (1030) a description of the first real-world object. For example, feedback 510 in FIG. 5B includes a description of real-world object 508-1. In some embodiments, the first audio feedback corresponding to the second real-world object comprises a description of the second real-world object (e.g., size, shape, color, purpose, and/or other descriptive information). In some embodiments, the first audio feedback includes (e.g., words describing, or information corresponding to) a relative location of the first real-world object. Providing descriptions of real-world objects in response to user gestures enhances the operability of the ear-worn audio output device (e.g., provides flexibility without cluttering the user interface with additional displayed controls, as well as reducing the number of inputs needed to access this flexibility) and makes the user-device interface more efficient.

In some embodiments, the first audio feedback corresponding to the first real-world object comprises (1032) an indication of actionable data associated with the first real-world object. For example, real-world object 508-1 in FIG. 5A includes barcode 509, real-world object 508-2 in FIG. 5D includes a current time, and real-world object 508-3 in FIG. 5F includes dates. For example, the actionable data includes a time, a date, a phone number, an email, and/or a machine-readable code (e.g., a QR code or App Clip code). In some embodiments, the actionable data is on a surface of the first real-world object and/or is displayed by the first real-world object. In some embodiments, the ear-worn audio output device initiates an interaction based on an input indicating (e.g., pointing at or touching) a machine-readable code. Providing indication of actionable data associated with the first real-world object in response to user gestures enhances the operability of the ear-worn audio output device (e.g., provides flexibility without cluttering the user interface with additional displayed controls, as well as reducing the number of inputs needed to access this flexibility) and makes the user-device interface more efficient.

In some embodiments, the first audio feedback corresponding to the first real-world object includes (1034) context information about a user of the ear-worn audio output device. For example, feedback 510 in FIG. 5B includes context information about real-world object 508-1 being from the user's mother, feedback 522 in FIG. 5D includes context information about real-world object 508-2 being a bedroom clock of user 502, and feedback 530 in FIG. 5F includes context information about appointments of user 502 on a given date. Example context information includes information about the user's schedule (e.g., availability at a given time), the user's past experience with the first real-world object, the user's experience with similar real-world objects, the user's preferences, and/or other types of context information.

In some embodiments, the first audio feedback corresponding to the first real-world object includes an indication of a future time period associated with the first real-world object, and the context information includes information regarding an availability of the user during the future time period (e.g., as indicated by feedback 530 in FIG. 5F). For example, the first audio feedback includes indication of a specific date and an indication of whether the user is free on the specific date. Providing indication of future time periods associated with real-world objects in response to user gestures enhances the operability of the ear-worn audio output device (e.g., provides flexibility without cluttering the user interface with additional displayed controls, as well as reducing the number of inputs needed to access this flexibility) and makes the user-device interface more efficient.

In some embodiments, in accordance with the first real-world object being at a first location, the first audio feedback is (1038) spatialized to the first location, and, in accordance with the first real-world object being at a second location, the first audio feedback is spatialized to the second location. For example, FIGS. 6C-6F illustrate audio feedback 616 being provided at a location that corresponds to real-world object 610-1 and audio feedback 622 being provided at a location that corresponds to real-world object 610-3. For example, spatializing the first audio feedback to the first location includes indicating a direction and distance between the ear-worn audio output device and the first location via the first audio feedback, and spatializing the first audio feedback to the second location includes indicating a direction and distance between the ear-worn audio output device and the second location via the first audio feedback. Spatializing audio feedback simulates a more realistic listening experience in which audio seems to come from sources of sound in a particular frame of reference, such as the physical environment surrounding the user. For example, the first audio feedback is provided as spatial audio from a simulated location corresponding to the relative location of the first real-world object from the ear-worn audio output device. Providing spatial feedback enhances the operability of the device and makes the user-device interface more efficient (e.g., by helping the user to achieve an intended result and reducing user mistakes when operating/interacting with the device), which, additionally, reduces power usage and improves battery life of the device by enabling the user to use the device more quickly and efficiently.

As an example, when spatial audio is enabled, the audio that is output from the ear-worn audio output device (e.g., earbuds) sounds as though the respective audio for each real-world object is coming from a different, simulated spatial location (which may change over time) in a frame of reference, such as a physical environment (e.g., a surround sound effect). The positioning (e.g., simulated spatial locations) of the real-world objects is independent of movement of earbuds relative to the frame of reference.

As an example, the simulated spatial locations of the one or more real-world objects, when fixed, are fixed relative to the frame of reference, and, when moving, move relative to the frame of reference. For example, where the frame of reference is a physical environment, the one or more real-world objects have respective simulated spatial locations in the physical environment. As the ear-worn audio output device moves about the physical environment, due to movement of the user, the audio output from the ear-worn audio output device is automatically adjusted so that the audio continues to sound as though it is coming from the one or more real-world objects at their respective spatial locations in the physical environment. As the one or more real-world objects move through a sequence of spatial locations about the physical environment, the audio output from the ear-worn audio output device is adjusted so that the audio continues to sound as though it is coming from the one or more real-world objects at the sequence of spatial locations in the physical environment. Such adjustment for moving sound sources also takes into account any movement of the ear-worn audio output device relative to the physical environment. For example, if the ear-worn audio output device moves relative to the physical environment along an analogous path as a moving real-world object so as to maintain a constant spatial relationship with the real-world object, the audio would be output so that the sound does not appear to move relative to the ear-worn audio output device.

In some embodiments, the first real-world object comprises (1040) a hand-drawn picture, and the first audio feedback includes information indicated by the hand-drawn picture. For example, FIGS. 51-5L illustrate notepad 534 including handwritten text and feedback 542 indicating portion 538 of the handwritten text. For example, the hand-drawn picture includes one or more terms and the first audio feedback includes the one or more terms or a description of the one or more terms. In some embodiments, the hand-drawn picture indicates an operation to be performed by the ear-worn audio output device and/or a companion device in communication with the ear-worn audio output device. In some embodiments, the first audio feedback includes an indication of the operation. In some embodiments, the ear-worn audio output device causes the operation to be performed in response to detecting the user gesture. For example, the hand-drawn picture is a labeled button (e.g., a call button, a pause button, a mute button, or other type of button) and the operation corresponds to the button (e.g., initiating a phone call, pausing audio content, or muting a microphone of the ear-worn audio output device). In some embodiments, the hand-drawn picture includes one or more instructions for the ear-worn audio output device and/or the companion device and the ear-worn audio output device performs one or more operations based on the one or more instructions. For example, the one or more instructions comprise “Call Sally” and the one or more operations comprise initiating a phone call to a contact labeled “Sally” in the user's contact list. In some embodiments, the user gesture comprises pointing at or tapping on the hand-drawn picture. In some embodiments, the first real-world object includes a plurality of hand-drawn pictures, the user gesture indicates a first hand-drawn picture of the plurality of hand-drawn pictures, and the first audio feedback comprises information associated with the first hand-drawn picture. In some embodiments, the first real-world object includes the plurality of hand-drawn pictures, the user gesture indicates a second hand-drawn picture of the plurality of hand-drawn pictures, and the first audio feedback comprises information associated with the second hand-drawn picture. In some embodiments, providing the first audio feedback comprises providing information about a first portion of a hand-drawn picture in accordance with a determination that the user gesture indicates the first portion, and providing the first audio feedback comprises providing information about a second portion of the hand-drawn picture in accordance with a determination that the user gesture indicates the second portion. Providing information indicated by hand drawn pictures in response to user gestures enhances the operability of the ear-worn audio output device and makes the user-device interface more efficient.

In response to detecting the user gesture (1018) and in accordance with a determination that the user gesture is the first type of gesture and is directed to a second real-world object, the ear-worn audio output device provides (1042) second audio feedback corresponding to the second real-world object via the one or more audio output components. For example, FIGS. 5A-5B illustrate user 502 gesturing toward real-world object 508-1 (e.g., a first real-world object) and FIGS. 5C-5D illustrate user 502 gesturing toward real-world object 508-2 (e.g., a second real-world object). FIG. 5D further shows wearable audio output device 301 providing feedback 522 about real-world object 508-2. In some embodiments, the ear-worn audio output device is a set of earbuds and the first and second audio feedback is provided at a subset of the set of earbuds (e.g., only the right earbud outputs the audio feedback). In some embodiments, the audio feedback is provided at a particular earbud in accordance with a preference setting. In some embodiments, the ear-worn audio output device provides the second audio feedback without providing visual feedback.

In some embodiments, the ear-worn audio output device detects (1044) a user voice command that corresponds to the user gesture, where at least one parameter of the first audio feedback is based on the user voice command. For example, the user points to the first real-world object and asks a question or gives a spoken command. In some embodiments, the user voice command is detected concurrently with the user gesture. In some embodiments, the user voice command is detected within a predefined threshold amount of time before or after detecting the user gesture. In some embodiments, the user voice command is determined to correspond to the user gesture if the user voice command is detected within a threshold amount of time of the user gesture. In some embodiments, the first type of gesture includes (or optionally includes) a voice command component. In some embodiments, a second type of gesture does not include a voice command component. In some embodiments, in accordance with the user voice command being a first type of voice command, the first audio feedback includes first information, and, in accordance with the user voice command being a second type of voice command, the first audio feedback includes second information different than the first information. For example, a user voice command of “what is that?” causes the first audio feedback to include a description of the first real-world object and a user voice command of “what does that say?” causes the first audio feedback to include a recitation of text on the first real-world object. In some embodiments, in response to a third type of voice command, the ear-worn audio output device performs an operation different than providing the first audio feedback or providing the second audio feedback. Detecting voice commands and providing feedback based on the detected voice commands enhances the operability of the ear-worn audio output device and makes the user-device interface more efficient.

In some embodiments, the at least one parameter of the first audio feedback is (1046) based on a tone of voice of the user voice command. For example, FIGS. 6E-6H illustrate user 602 speaking question 620 in FIG. 6E and whispering question 630 in FIG. 6G. FIGS. 6E-6H also illustrate a volume level 626 and level of detail in the feedback changing in response to the whispered versus spoken questions. In some embodiments, a volume of the first audio feedback is based on the tone of voice. For example, a whispered voice command results in a lower volume for the first audio feedback as compared to a louder voice command. In some embodiments, a level of detail in the first audio feedback is based on the tone of voice. For example, a whispered voice command results in a terser first audio feedback as compared to a louder voice command. In some embodiments, a type of information in the first audio feedback is based on the tone of voice. As an example, a whispered user voice command causes different audio feedback than a spoken or shouted user voice command. In some embodiments, in accordance with the user voice command having a first tone, a parameter (e.g., a volume, speed, and/or other type of parameter) of the first audio feedback is set to a first value, and, in accordance with the user voice command having a second tone, different from the first tone, the parameter of the first audio feedback is set to a second value, different than the first value. In some embodiments, in accordance with the user voice command having a first tone, the first audio feedback is provided, and, in accordance with the user voice command having a third tone, performing an operation different than providing the first audio feedback or providing the second audio feedback. Providing feedback with parameter(s) based on tone of voice enhances the operability of the ear-worn audio output device and makes the user-device interface more efficient.

In some embodiments, the ear-worn audio output device detects (1048) a second user gesture via the one or more sensors of the ear-worn audio output device; and in response to detecting the second user gesture: in accordance with a determination that the ear-worn audio output device is within a predefined area and a determination that the user gesture is the first type of gesture and is directed to the first real-world object, the ear-worn audio output device provides second audio feedback corresponding to the first real-world object via the one or more audio output components; and, in accordance with a determination that the ear-worn audio output device is not within the predefined area, the ear-worn audio output device forgoes providing the first audio feedback (e.g., without regard to whether or not the user gesture is the first type of gesture and is directed to the first real-world object). For example, FIGS. 6A-6H illustrate user 602 entering a geofence boundary, and gesturing toward objects 610, and obtaining feedback about objects 610. In some embodiments, the first audio feedback is provided while the ear-worn audio output device is within a predefined area; and, in accordance with a determination that the ear-worn audio output device is not within the predefined area and a determination that the user gesture is the first type of gesture and is directed to the first real-world object, the ear-worn audio output device forgoes providing the first audio feedback. In some embodiments, the ear-worn audio output device provides an indication to the user (e.g., audio and/or haptic feedback) when the user enters and/or exits a geofenced area. In some embodiments, the ear-worn audio output device provides audio feedback corresponding to real-world objects only while the ear-worn audio output device and/or the real-world objects are within geofenced locations. Providing feedback while within predefined areas enhances the operability of the ear-worn audio output device and makes the user-device interface more efficient, and reduces power usage and improves battery life of the ear-worn audio output device by being able to disable components (e.g., sensors) while outside of the predefined areas.

It should be understood that the particular order in which the operations in FIGS. 10A-10D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1100, 1200, and 1300) are also applicable in an analogous manner to method 1000 described above with respect to FIGS. 10A-10D. For example, the inputs, gestures, functions, and feedback described above with reference to method 1000 optionally have one or more of the characteristics of the inputs, gestures, functions, and feedback described herein with reference to other methods described herein (e.g., methods 1100, 1200, and 1300). For brevity, these details are not repeated here.

FIGS. 11A-11C are flow diagrams illustrating method 1100 for providing audio feedback about alert conditions in accordance with some embodiments. Method 1100 is performed at a wearable audio output device (e.g., wearable audio output device 301 such as earbuds or headphones) that includes one or more audio output components (e.g., speaker(s) 306) and optionally includes one or more sensors (e.g., sensor(s) 311 such as image sensors, motion sensors, and/or other types of sensors). Some operations in method 1100 are, optionally, combined and/or the order of some operations is, optionally, changed.

As described below, method 1100 provides audio outputs in an intuitive and efficient manner by providing audio feedback and adjusting a modification of ambient sound. For example, the ambient sound modification is automatically adjusted to allow the user to hear more ambient sound when an alert condition is detected in the surrounding physical environment. In this way, the wearable audio output device is better suited to a current state of the surrounding physical environment, without requiring additional input from the user. Providing an adaptive and more intuitive user experience while reducing the number of inputs needed to achieve such an experience enhances the operability of the device and makes the user-device interface more efficient (e.g., by helping the user to achieve an intended outcome and reducing user mistakes when operating/interacting with the device), which, additionally, reduces power usage and improves battery life of the device by enabling the user to use the device more quickly and efficiently.

While a wearable audio output device has a first physical arrangement relative to a respective body part of a user in which a magnitude of ambient sound from the physical environment is modified by the wearable audio output device (e.g., via active noise cancellation, passive noise cancellation, and/or active audio transparency) to have a first ambient-sound level, the wearable audio output device detects (1102) an alert condition relating to spatial context of the user. For example, FIGS. 7A-7B illustrate user 702 approaching puddle 706 (e.g., representing an alert condition) while an ANC mode is active with level 710-a. In some embodiments, the alert condition is detected via one or more sensors of the wearable audio output device (e.g., one or more image sensors, one or more audio sensors, and/or one or more other types of sensors). In some embodiments, the wearable audio output device includes an in-ear and/or over-the-ear component configured to provide audio feedback (e.g., speakers). For example, the wearable audio output device is a head-worn device such as a headset (e.g., an augmented reality headset), headphones, earbuds, glasses, or earrings. In some embodiments, the wearable audio output device includes one or more audio output components (e.g., speakers).

In some embodiments, the wearable audio output device is (1104) an ear-worn audio output device (e.g., a wearable audio output device 301 such as earbuds or headphones), and the alert condition is detected via one or more sensors of the ear-worn audio output device. In some embodiments, the ear-worn audio output device does not cover the user's eyes. In some embodiments, the ear-worn audio output device does not extend across the user's face. In some embodiments, the ear-worn audio output device does not affect the user's vision. In some embodiments, the ear-worn audio output device is an in-ear device (e.g., earbuds). In some embodiments, the ear-worn audio output device is an over-the-ear device (e.g., headphones). In some embodiments, the ear-worn audio output device is mounted to an ear of the user. Detecting alert conditions via sensors of an ear-worn audio output device enhances the operability of the wearable audio output device and makes the user-device interface more efficient.

In some embodiments, the wearable audio output device provides (1106) playback of audio content at the wearable audio output device, and the alert condition relating to the spatial context of the user is detected while providing the playback of the audio content. For example, FIGS. 7A-7B illustrate wearable audio output device 301 detecting the alert condition corresponding to puddle 706 while providing music 704. For example, the audio content comprises music, spoken word audio (e.g., a podcast or audio book), and/or other types of audio content. In some embodiments, the audio content is received from a companion device in communication with the wearable audio output device. Detecting alert conditions while providing playback of audio content reduces the number of inputs needed (e.g., the user does not need to manually stop the playback) and allows the device to automatically perform the alert condition detection.

In some embodiments, in response to detecting the alert condition, the wearable audio output device pauses (and/or reduces a volume of) the playback of the audio content. For example, FIGS. 7E-7F illustrate wearable audio output device 301 detecting ball 720 approaching from behind user 702 (e.g., representing an alert condition) and pausing media playback as indicated by media playback indicator 718. In some embodiments, the playback of the audio content is paused while the audio feedback is provided. In some embodiments, the playback of the audio content is paused until the alert condition is over. In some embodiments, the playback of the audio content is paused for a threshold amount of time. In some embodiments, the playback of the audio content is paused until an input is received from the user to resume the playback. In some embodiments, the playback of the audio content resumes automatically (e.g., without further user input), for example, after the audio feedback is provided or after a threshold amount of time after the audio feedback is provided. Automatically pausing the playback of audio content reduces the number of inputs needed (e.g., the user does not need to manually pause) and allows the device to automatically perform the alert condition detection.

In some embodiments, the alert condition is (1108) based on a user of the wearable audio output device being within a threshold distance of a potential hazard. For example, in the example of FIGS. 7A-7B user 702 is alerted to puddle 706 after approaching the puddle (e.g., in accordance with being within a threshold distance of the puddle). In some embodiments, the wearable audio output device determines that the user is within the threshold distance of the potential hazard (e.g., using a camera and/or other type of sensor). In some embodiments, the audio feedback changes based on the user proximity to the potential hazard. For example, a more urgent warning is given if the user is closer to the potential hazard. In some embodiments, one or more properties of the audio feedback (e.g., tone, frequency, and/or other audio properties) are based on the user proximity to the potential hazard. In some embodiments, the audio feedback indicates the proximity of the potential hazard (e.g., using verbal feedback). In some embodiments, in accordance with a determination that the wearable audio output device is not within the threshold distance of the potential hazard, the wearable audio output device forgoes providing the audio feedback about the potential hazard. For example, the alert condition is not met while the wearable audio output device is further than the threshold distance from the potential hazard. In some embodiments, the wearable audio output device identifies the alert condition from a predefined list of alert conditions. In some embodiments, the wearable audio output device (and/or a device in communication with the wearable audio output device) dynamically determines (e.g., in real time) whether an alert condition exists based on one or more hazard detection criteria (e.g., comparing the spatial context of the user with the one or more hazard detection criteria). For example, potential hazards include pits, holes, sharp or otherwise dangerous objects, high speed objects, and heavy machinery. Detecting alert conditions based on threshold distances enhances the operability of the wearable audio output device and makes the user-device interface more efficient.

In some embodiments, the alert condition is (1110) based on a user of the wearable audio output device moving toward a potential hazard. For example, in the example of FIGS. 7A-7B user 702 is alerted to puddle 706 in FIG. 7B after approaching the puddle from further away (e.g., in FIG. 7A). In some embodiments, the wearable audio output device determines that the user is moving toward the potential hazard (e.g., using a camera and/or other type of sensor). In some embodiments, the alert condition is based on a user's heading (e.g., determined using a gyroscope). In some embodiments, the alert condition is based on a speed at which the user is approaching the potential hazard. In some embodiments, the alert condition is based on an estimated amount of time before the user is at the potential hazard. In some embodiments, the alert condition is not met while the user of the wearable audio output device is not moving toward the potential hazard (e.g., is maintaining a distance or moving away from the potential hazard). Detecting alert conditions based on user movement enhances the operability of the wearable audio output device and makes the user-device interface more efficient.

In some embodiments, the alert condition is (1112) based on a real-world entity approaching a user of the wearable audio output device. For example, in the example of FIGS. 7E-7F user 702 is alerted to ball 720 after ball begins to approach user 702 from behind (e.g., in accordance with ball 720 approaching user 702). For example, the real-world entity is a car, bike, or other vehicle. In some embodiments, the wearable audio output device determines that the real-world entity is approaching the user (e.g., using a camera and/or other type of sensor). In some embodiments, the alert condition is based on a speed at which the real-world entity is approaching the user. In some embodiments, the alert condition is based on the type of real-world entity. In some embodiments, the audio feedback indicates the type of real-world entity, the speed of the real-world entity, and/or the relative location of the real-world entity to the user. In some embodiments, the alert condition is not met while the real-world entity is not approaching the user (e.g., is maintaining a distance or moving away from the user). Detecting alert conditions based on entity movement enhances the operability of the wearable audio output device and makes the user-device interface more efficient.

In some embodiments, the real-world entity is (1114) a person, and the audio feedback indicates that the person is approaching the user of the wearable audio output device. For example, FIGS. 7G-7H illustrate person 730 approaching user 702 and wearable audio output device 301 providing feedback 736 indicating that person 730 is approaching. In some embodiments, the wearable audio output device determines that the real-world entity is a person. In some embodiments, the wearable audio output device determines that the person is attempting to get the attention of the user (e.g., the person waves and/or calls out to the user) and the audio feedback indicates the same. In some embodiments, the wearable audio output device determines that the person is on a collision course with the user, and the audio feedback indicates the same. In some embodiments, the person is a known contact of the user, and the audio feedback indicates the identity of the person. In some embodiments, in accordance with the person moving away from the user of the wearable audio output device, the alert condition is not met (e.g., the audio feedback is not provided). Providing indication that a person is approaching enhances the operability of the wearable audio output device (e.g., provides flexibility without cluttering the user interface with additional displayed controls, as well as reducing the number of inputs needed to access this flexibility) and makes the user-device interface more efficient.

In some embodiments, the alert condition is (1116) based on a spatial context behind the user. For example, FIGS. 7C-7F illustrate an alert condition based on ball 720 approaching from behind user 702. In some embodiments, the alert condition is based on a spatial context out of the user's field of view. In some embodiments, audio feedback indicates the spatial context. In some embodiments, the alert condition is detected in accordance with the spatial context behind the user meeting one or more criteria (e.g., the one or more hazard detection criteria described above), and, in accordance with the spatial context behind the user not meeting the one or more criteria, the alert condition is not met (e.g., the audio feedback is not provided). Detecting alert conditions based on spatial context behind the user enhances the operability of the wearable audio output device and makes the user-device interface more efficient.

In some embodiments, the alert condition comprises (1118) one or more parameters, and the one or more parameters differ based on whether the alert condition is within an estimated or detected field of view of a user of the wearable audio output device. For example, FIGS. 7C-7F illustrate an alert condition being triggered when ball 720 approaches from behind user 702, but not being triggered when ball 720 approaches from in front of user 702. For example, different criteria are used for the alert condition when the event is occurring behind the user as opposed to in front of the user. For example, a car approaching from in front of a user while the user is walking along the shoulder of a road may not trigger the alert condition, but a car approaching from behind the user may trigger the alert condition (e.g., to warn the user not to stray into the lane). In some embodiments, the alert condition is met in accordance with the one or more parameters having a first set of values, and the alert condition is not met in accordance with the one or more parameters having a second set of values. Detecting alert conditions differently based on an estimated or detected field of view of a user enhances the operability of the wearable audio output device and makes the user-device interface more efficient.

In some embodiments, the alert condition is (1120) based on audio from the physical environment in which the wearable audio output device is operating. For example, FIGS. 7I-7K illustrate an alert condition being triggered in response to persons 740 and 742 arguing with one another. In some embodiments, the audio is detected by the wearable audio output device. In some embodiments, the audio is received via one or more microphones in communication with (e.g., external to or within) the wearable audio output device. For example, the audio includes a siren, an alarm, a shout, and/or other types of audio. Detecting alert conditions based on audio from the physical environment enhances the operability of the wearable audio output device and makes the user-device interface more efficient.

In some embodiments, the alert condition is (1122) based on a cadence of the audio from the physical environment in which the wearable audio output device is operating. For example, the cadence of the audio may indicate that an object is approaching the user. As another example, the cadence of the audio may indicate urgency of a situation. In some embodiments, the alert condition is based on a change in cadence of the audio. In some embodiments, the alert condition is based on a frequency of the audio. Detecting alert conditions based on a cadence of audio from the physical environment enhances the operability of the wearable audio output device and makes the user-device interface more efficient.

In some embodiments, the alert condition is (1124) based on a tone of the audio from the physical environment in which the wearable audio output device is operating. FIGS. 7I-7K illustrate an alert condition being triggered in response to persons 740 and 742 arguing with one another. For example, a tone of a conversation detected in the physical environment in which the wearable audio output device is operating indicates an argument. Detecting alert conditions based on a tone of audio from the physical environment enhances the operability of the wearable audio output device and makes the user-device interface more efficient.

In response to detecting the alert condition (1126), the wearable audio output device provides (1128) audio feedback about the alert condition. For example, in FIG. 7B, wearable audio output device provides feedback 714 about the alert condition involving puddle 706. In some embodiments, the audio feedback includes a description of the alert condition. In some embodiments, the audio feedback indicates a potential hazard associated with the alert condition. In some embodiments, the audio feedback is provided as spatial audio that indicates a relative position of a source of the alert condition. In some embodiments, the audio feedback indicates the relative position of the alert condition. In some embodiments, the audio feedback includes a suggestion to avert a potential hazard.

In response to detecting the alert condition (1126), the wearable audio output device changes (1130) (e.g., automatically changing without further input from the user) one or more properties of the wearable audio output device to modify the magnitude of ambient sound (e.g., by decreasing a degree of active noise cancellation and/or increasing a degree of active transparency) from the physical environment to have a second ambient-sound audio level that is louder than the first ambient-sound audio level. For example, FIGS. 7A-7B illustrate wearable audio output device 301 decreasing a level of ANC from level 710-a in FIG. 7A to level 710-b in FIG. 7B in response to detecting an alert condition involving puddle 706.

In some embodiments, changing the one or more properties of the wearable audio output device to modify the magnitude of ambient sound from the physical environment comprises (1132) decreasing a degree of active noise cancellation and/or increasing a degree of active transparency. For example, FIGS. 7G-7H illustrate wearable audio output device 301 decreasing a level of ANC from level 716-a in FIG. 7G to level 716-b in FIG. 7H in response to detecting an alert condition involving person 730. FIGS. 7G-7JH further illustrate wearable audio output device 301 increasing a level of active transparency from level 726-a in FIG. 7G to level 726-b in FIG. 7H in response to detecting an alert condition involving person 730. In some embodiments, changing the one or more properties of the wearable audio output device to modify the magnitude of ambient sound from the physical environment comprises switching from the noise cancellation mode to the active transparency mode. In some embodiments, changing the degree of active noise cancellation (ANC) comprises disabling the ANC mode. In some embodiments, changing the degree of ANC comprises reducing the ANC from above a threshold percentage (e.g., 90%, 80%, 75%, or 50%) to below the threshold percentage. For example, prior to detecting the alert condition, the ANC reduces the ambient sound to an ambient-sound audio level of 20%, 10%, or 5% and, in response to detecting the alert condition, the ANC reduces the ambient sound to an ambient-sound audio level of 80%, 75%, 70%, or 50%. In some embodiments, changing the degree of active transparency comprises enabling an active transparency mode. In some embodiments, changing the degree of active transparency comprises increasing the active transparency from below a threshold percentage (e.g., 15%, 20%, 30%, or 50%) to above the threshold percentage. For example, prior to detecting the alert condition, the active transparency increases the ambient sound at an ambient-sound audio level of 10%, 20%, or 35% and, in response to detecting the alert condition, the active transparency increases the ambient sound to an ambient-sound audio level of 80%, 75%, 70%, or 50%. In some embodiments, the wearable audio output device changes the one or more properties of the wearable audio output device to modify the magnitude of ambient sound from the physical environment in accordance with a determination that the wearable audio output device is operating in a first state (e.g., with ANC enabled). In some embodiments, the wearable audio output device forgoes changing the one or more properties of the wearable audio output device in accordance with a determination that the wearable audio output device is operating in a second state (e.g., with ANC disabled). Decreasing a degree of active noise cancellation and/or increasing a degree of active transparency based on alert conditions enhances the operability of the wearable audio output device and makes the user-device interface more efficient.

In some embodiments, changing the one or more properties of the wearable audio output device to modify the magnitude of ambient sound from the physical environment comprises (1134) amplifying the ambient sound to a volume level above a volume level of the ambient sound in the physical environment. For example, FIGS. 7G-7H illustrate wearable audio output device 301 enabling a conversation boost mode, as indicated by boost indicator 728, in response to detecting an alert condition involving person 730. For example, the ambient sound is amplified to assist users that are hard of hearing, or to emphasize a relatively quiet alert condition. As an example, a warning shouted from a distance in a noisy environment may be amplified so that the user of the wearable audio output device is able to hear and understand the warning over the sounds of the noisy environment. Amplifying ambient sound based on alert conditions enhances the operability of the wearable audio output device and makes the user-device interface more efficient.

In some embodiments, the wearable audio output device causes (1136) an indication of the alert condition to be provided at a companion device that is communicatively coupled to the wearable audio output device. For example, FIG. 7K illustrates alert 750 being provided at portable multifunction device 100 in response to detecting an alert condition involving persons 740 and 742. For example, a notification is shown on a display of the companion device. In some embodiments, the indication of the alert condition includes visual, audio, and/or haptic feedback. In some embodiments, the indication of the alert condition includes an image of a potential hazard associated with the alert condition. Providing indication of the alert condition at a companion device enhances the operability of the wearable audio output device and provides improved feedback about the alert condition.

It should be understood that the particular order in which the operations in FIGS. 11A-11C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1000, 1200, and 1300) are also applicable in an analogous manner to method 1100 described above with respect to FIGS. 11A-11C. For example, the inputs, gestures, functions, and feedback described above with reference to method 1100 optionally have one or more of the characteristics of the inputs, gestures, functions, and feedback described herein with reference to other methods described herein (e.g., methods 1000, 1200, and 1300). For brevity, these details are not repeated here.

FIGS. 12A-12D are flow diagrams illustrating method 1200 for performing operations in response to air gestures in accordance with some embodiments. Method 1200 is performed at a wearable audio output device (e.g., wearable audio output device 301 such as earbuds or headphones) that includes one or more audio output components (e.g., speaker(s) 306) and optionally includes one or more sensors (e.g., sensor(s) 311 such as image sensors, motion sensors, and/or other types of sensors). Some operations in method 1200 are, optionally, combined and/or the order of some operations is, optionally, changed.

As described below, method 1200 provides an improved interface for controlling a wearable audio output device by performing operations in response to user hand gestures. Detecting and responding to user hand gestures reduces the number of inputs needed to provide audio feedback and makes the user-device interface more efficient (e.g., by helping the user to achieve an intended outcome and reducing user mistakes when operating/interacting with the audio output device), which reduces power usage and improves battery life (e.g., by alleviating the need to power a graphical user interface). Additionally, detecting and responding to user gestures allows for a user to not have to handle the wearable audio output device directly, which enhances the operability of the wearable audio output device and makes the user-device interface more efficient.

While outputting audio content, the wearable audio output device detects (1202) a gesture performed by a hand of a user of a wearable audio output device. For example, FIG. 8B shows wearable audio output device 301 detecting gesture 804. In some embodiments, the wearable audio output device includes an in-ear and/or over-the-ear component configured to provide audio feedback (e.g., speakers). For example, the wearable audio output device is a head-worn device such as a headset (e.g., an augmented reality headset), headphones, earbuds, glasses, or earrings. In some embodiments, the wearable audio output device includes one or more audio output components (e.g., speakers). In some embodiments, the first operation changes an operating state of the wearable audio output device (e.g., from an ANC mode active to an active transparency mode active).

In some embodiments, the gesture comprises (1204) an air gesture. For example, gesture 828 in FIG. 8G is an air gesture. example, the air gesture does not involve contact with any surface or part of the user's body. As an example, the air gesture is a cupping gesture performed near the user's ear. An air gesture is a gesture that is detected without the user touching (or independently of) an input element that is part of a device and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). Detecting air gestures enhances the operability of the wearable audio output device and makes the user-device interface more efficient.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0.01-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input. Detecting and being responsive in different ways to different types of gestures enhances operability of the device (e.g., provides flexibility without cluttering the user interface with additional displayed controls, as well as reducing the number of inputs needed to access this flexibility) and makes the user-device interface more efficient.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their hand, spreading apart the two or more fingers that formed the pinch gesture) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, the gesture is (1206) detected via one or more image sensors (e.g., sensor(s) 311). For example, the gesture is detected by one or more cameras configured for capturing images in a visual, infrared, and/or near infrared spectrums. Detecting gestures via one or more image sensors enhances operability of the device and makes the user-device interface more efficient.

In some embodiments, the gesture is (1208) detected by the wearable audio output device (e.g., via sensor(s) 311). For example, the gesture is detected via one or more sensors of the wearable audio output device. In some embodiments, the gesture is detected from data captured from the wearable audio output device and another device in communication with the wearable audio output device.

In some embodiments, the wearable audio output device is (1210) an ear-worn device. In some embodiments, the ear-worn audio output device does not cover the user's eyes. In some embodiments, the ear-worn audio output device does not extend across the user's face. In some embodiments, the ear-worn audio output device does not affect the user's vision. In some embodiments, the ear-worn audio output device is an in-ear device. In some embodiments, the ear-worn audio output device is an over-the-ear device. In some embodiments, the ear-worn audio output device is mounted to an ear of the user. Being able to detect gestures via ear-worn devices simplifies the user-device interface.

In some embodiments, the gesture comprises (1212) a cupping gesture (e.g., gesture 804, FIG. 8B). For example, the cupping gesture involves the user's hand curving to the shape of a ‘C’ or backwards ‘C’. In some embodiments, the cupping gesture is performed near the user's ear. Detecting and being responsive in different ways to different types of gestures enhances operability of the device (e.g., provides flexibility without cluttering the user interface with additional displayed controls, as well as reducing the number of inputs needed to access this flexibility) and makes the user-device interface more efficient.

In some embodiments, the gesture comprises (1214) an air pinch gesture (e.g., gesture 828, FIG. 8G). For example, the gesture includes the user performing a pinch gesture using their thumb and index finger or their thumb and middle finger. In some embodiments, the pinch gesture is a pinch-and-hold gesture. Detecting and being responsive in different ways to different types of gestures enhances operability of the device (e.g., provides flexibility without cluttering the user interface with additional displayed controls, as well as reducing the number of inputs needed to access this flexibility) and makes the user-device interface more efficient.

In some embodiments, the gesture comprises (1216) a double air pinch gesture (e.g., gesture 836, FIG. 8J). For example, the double pinch gesture involves the user performing two pinches in succession (e.g., within a threshold amount of time of one another). In some embodiments, the double pinch gesture includes the user pinching their thumb and index finger (or middle finger) together twice. In some embodiments, the double pinch gesture includes a first pinch using a first finger and a second pinch using a second finger (e.g., not used during the first pinch). Detecting and being responsive in different ways to different types of gestures enhances operability of the device (e.g., provides flexibility without cluttering the user interface with additional displayed controls, as well as reducing the number of inputs needed to access this flexibility) and makes the user-device interface more efficient.

In some embodiments, the gesture comprises (1218) an air pinch and twist gesture (e.g., gesture 842, FIGS. 8M-80). For example, the pinch and twist gesture involves the user pinching their thumb and index finger together and then rotating their wrist (e.g., mimicking turning a dial) more than a threshold amount of rotation (e.g., more than 5 degrees, 10 degrees or 20 degrees). In some embodiments, one or more parameters of the first operation are varied in accordance with a magnitude, speed, and/or direction of the rotation. For example, if the first operation is an adjustment to an output parameter (e.g., a volume, a contrast, a brightness, or other type of parameter), the degree of the adjustment may be based on the magnitude, speed, and/or direction of the rotation. Detecting and being responsive in different ways to different types of gestures enhances operability of the device (e.g., provides flexibility without cluttering the user interface with additional displayed controls, as well as reducing the number of inputs needed to access this flexibility) and makes the user-device interface more efficient.

In some embodiments, the gesture is (1220) detected within a gesture region (e.g., gesture region 806). For example, the gesture region is relative to the wearable audio output device. In some embodiments, the gesture region is based on a field of view of the wearable audio output device. In some embodiments, the gesture region is based on a distance from a side of the user's head. In some embodiments, the gesture region is a three-dimensional region (e.g., defined relative to the user's head.) For example, the gesture region is a 6 inch by 6 inch by 6 inch cubic region, a 10 inch by 10 inch by 10 inch cubic region, a 10 inch by 8 inch by 6 inch region, or other sized three-dimensional region. Detecting gestures within a detection region improves operation of the device by reducing false positive gestures performed outside of the gesture region and reduces power usage and improves battery life of the wearable audio output device.

In response to detecting the gesture (1222), in accordance with a determination that the gesture is detected within a respective distance of a side of the user's head and is a first type of hand gesture determined based at least in part on a shape of the hand during performance of the gesture, the wearable audio output device performs (1224) a first operation corresponding to the gesture. For example, FIGS. 8I-8J illustrate wearable audio output device 301 adjusting a media content playback position in response to gesture 836.

In some embodiments, the first operation comprises (1226) adjusting a volume of audio output at the wearable audio output device. For example, FIGS. 8M-80 illustrate wearable audio output device 301 adjusting a volume level 844 in response to gesture 842. For example, the audio output corresponds to playback of media content. As another example, the audio output corresponds to ambient sound in the physical environment (e.g., audio boost). As another example, the audio output corresponds to audio received from another device (e.g., a phone call). In some embodiments, in accordance with the gesture including movement in a first direction, the volume is decreased, and in accordance with the gesture including movement in a second direction (e.g., opposite to or different from the first direction), the volume is increased. In some embodiments, a magnitude of the volume adjustment is based on a magnitude and/or speed of the gesture. Adjusting volume of audio output in response to gestures performed in a gesture region enhances operability of the device (e.g., provides flexibility without cluttering the user interface with additional displayed controls, as well as reducing the number of inputs needed to access this flexibility) and makes the user-device interface more efficient.

In some embodiments, the first operation comprises (1228) adjusting a magnitude of ambient sound from the physical environment. For example, FIGS. 8A-8B illustrate wearable audio output device 301 adjusting levels of ANC, active transparency, and conversation boost in response to detecting gesture 804. For example, adjusting the magnitude of ambient sound comprises adjusting a degree of ANC and/or a degree of active transparency. In some embodiments, adjusting the magnitude of ambient sound comprises enabling or disabling an ANC and/or active transparency mode. In some embodiments, in accordance with the gesture including movement in a first direction, the magnitude of ambient sound is decreased, and in accordance with the gesture including movement in a second direction (e.g., opposite to or different from the first direction), the magnitude of ambient sound is increased. In some embodiments, an amount of the adjustment is based on a magnitude and/or speed of the gesture. Adjusting magnitude of ambient sound in response to gestures performed in a gesture region enhances operability of the device (e.g., provides flexibility without cluttering the user interface with additional displayed controls, as well as reducing the number of inputs needed to access this flexibility) and makes the user-device interface more efficient.

In some embodiments, the first operation comprises (1230) adjusting playback of media content. For example, FIGS. 8E-8G illustrate wearable audio output device 301 pausing playback of media content in response to detecting gesture 828. For example, the first operation comprises pausing or resuming media content. As another example, the first operation comprises fast-forwarding or rewinding the media content. As another example, the first operation comprises switching media content (e.g., switching tracks, switching songs, switching stations, or switching media sources). In some embodiments, in accordance with the gesture including movement in a first direction, the adjustment to the playback of the media content comprises a rewind operation, and in accordance with the gesture including movement in a second direction (e.g., opposite to or different from the first direction), the adjustment to the playback of the media content comprises a skip ahead operation. In some embodiments, an amount of the adjustment is based on a magnitude and/or speed of the gesture. Adjusting media playback in response to gestures performed in a gesture region enhances operability of the device (e.g., provides flexibility without cluttering the user interface with additional displayed controls, as well as reducing the number of inputs needed to access this flexibility) and makes the user-device interface more efficient.

In response to detecting the gesture (1222), in accordance with a determination that the gesture is not the first type of hand gesture determined based at least in part on a shape of the hand during performance of the gesture, the wearable audio output device forgoes (1232) performing the first operation. For example, FIGS. 80-8P illustrate wearable audio output device 301 ceasing to perform the volume adjustment device in response to a change in hand shape. For example, the first operation is not performed without regard to whether or not the hand gesture is within the respective distance of the side of the user's head. For example, the respective distance is 2 inches, 5 inches, 10 inches, or 1 foot. Forgoing performing operations based on hand shape reduces false-positive gesture detection and enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, in response to detecting the gesture (1222), in accordance with a determination that the gesture is detected more than the respective distance of a side of the user's head, the wearable audio output device forgoes (1234) performing the first operation (e.g., without regard to whether or not the hand gesture is the first type of gesture). For example, FIGS. 8B-8D illustrate wearable audio output device 301 ceasing to perform the ANC, transparency, and boost modifications in response to the user's hand being more than the respective distance of a side of the user's head (e.g., outside of a gesture region) in FIG. 8C. Forgoing performing operations based on gestures performed more than the respective distance of a side of the user's head enhances the operability of the devices and makes the user-device interface more efficient (e.g., by helping the user to achieve an intended outcome and reducing user mistakes when operating/interacting with the devices), which, additionally, reduces power usage and improves battery life of the devices by enabling the user to use the devices more quickly and efficiently.

In some embodiments, in response to detecting the gesture (1222), in accordance with a determination that the gesture is detected within the respective distance of a side of the user's head and is a second type of hand gesture determined based at least in part on a shape of the hand during performance of the gesture, the wearable audio output device performs (1236) a second operation corresponding to the gesture, where the second operation is different from the first operation. For example, FIG. 8B illustrates an adjustment to ANC, transparency, and boost in response to detecting gesture 804 (e.g., a cupping gesture) and FIG. 8G illustrates a media playback adjustment in response to detecting gesture 828 (e.g., a pinch gesture). Detecting and being responsive in different ways to different types of gestures enhances operability of the device (e.g., provides flexibility without cluttering the user interface with additional displayed controls, as well as reducing the number of inputs needed to access this flexibility) and makes the user-device interface more efficient.

In some embodiments, in response to detecting the gesture (1222), in accordance with a determination that the gesture is not the second type of hand gesture determined based at least in part on a shape of the hand during performance of the gesture, the wearable audio output device forgoes (1238) performing the second operation (e.g., without regard to whether or not the hand gesture is within the respective distance of the side of the user's head). For example, FIGS. 80-8P illustrate wearable audio output device 301 ceasing to perform the volume adjustment device in response to a change in hand shape. Forgoing performing operations based on gesture type enhances the operability of the devices and makes the user-device interface more efficient, which, additionally, reduces power usage and improves battery life of the devices by enabling the user to use the devices more quickly and efficiently.

In some embodiments, in response to detecting the gesture (1222), in accordance with a determination that the gesture is detected more than the respective distance of a side of the user's head, the wearable audio output device forgoes (1240) performing the second operation (e.g., without regard to whether or not the hand gesture is the second type of gesture). For example, FIGS. 8B-8D illustrate wearable audio output device 301 ceasing to perform the ANC, transparency, and boost modifications in response to the user's hand being outside the gesture region in FIG. 8C. Forgoing performing operations based on gestures performed more than the respective distance of a side of the user's head enhances the operability of the devices and makes the user-device interface more efficient, which, additionally, reduces power usage and improves battery life of the devices by enabling the user to use the devices more quickly and efficiently.

In some embodiments, the wearable audio output device detects (1242) an end of the gesture, and, in response to detecting the end of the gesture, ceases to perform the first operation. For example, FIGS. 80-8P illustrate wearable audio output device 301 ceasing to perform the volume adjustment device in response to a change in hand shape. For example, the gesture is a pinch-and-hold gesture and the first operation is performed while the gesture is held. In some embodiments, the first operation adjusts a modification of ambient sound. For example, ANC is disabled (or, alternatively, a degree of ANC is reduced) while the gesture is being detected. In some embodiments, the first operation changes an operating state of the wearable audio output device from a first state to a second state, and the wearable audio output device operates in the second state while the gesture is being performed (e.g., when the gesture is no longer detected the wearable audio output device transitions back to the first state). In some embodiments, the wearable audio output device operates in the second state for a respective amount of time after the gesture is detected. In some embodiments, the wearable audio output device operates in the second state until a command is received to change the operating state from the second state. Ceasing to perform an operation in response to detecting an end of a user gesture enhances the operability of the devices and makes the user-device interface more efficient, which, additionally, reduces power usage and improves battery life of the devices by enabling the user to use the devices more quickly and efficiently.

In some embodiments, detecting the end of the gesture comprises (1244) detecting a change in the shape of the hand. For example, FIGS. 80-8P illustrate wearable audio output device 301 ceasing to perform the volume adjustment device in response to a change in hand shape from a pinch shape to a first shape. For example, the user stops cupping their hand. Detecting the end of gestures based on changes in hand shape enhances operability of the device and makes the user-device interface more efficient.

In some embodiments, detecting the end of the gesture comprises (1246) detecting the hand being further than the respective distance of the side of the user's head. For example, the wearable audio output device detects the user's hand moving away from the side of the user's head. For example, FIGS. 8B-8D illustrate wearable audio output device 301 ceasing to perform the ANC, transparency, and boost modifications in response to the user's hand being outside the gesture region in FIG. 8C. Detecting the end of gestures based on the user's hand being further than the respective distance enhances operability of the device and makes the user-device interface more efficient.

In some embodiments, the wearable audio output device detects (1248) the hand of the user entering the gesture region, and, in response to detecting the hand of the user entering the gesture region, provides first feedback indicating that the hand has entered the gesture region. For example, FIG. 8F shows hand 824 of user 802 entering gesture region 806 and wearable audio output device 301 providing feedback 826 in response. In some embodiments, the first feedback comprises audio and/or haptic feedback. Providing feedback indicating that the user's hand has entered the gesture region provides improved feedback about a state of the wearable audio output device.

In some embodiments, the wearable audio output device detects (1250) the hand of the user exiting the gesture region, and, in response to detecting the hand of the user exiting the gesture region, provides second feedback indicating that the hand has left the gesture region. For example, FIG. 8H shows hand 824 of user 802 leaving gesture region 806 and wearable audio output device 301 providing feedback 834 in response. In some embodiments, the second feedback comprises audio and/or haptic feedback. In some embodiments, the second feedback is a different type of feedback than the first feedback. In some embodiments, the first and second feedback are the same type of feedback. In some embodiments, one or more properties of the first feedback is different than one or more properties of the second feedback (e.g., different tones, frequencies, and/or other properties). Providing feedback indicating that the user's hand has exited the gesture region provides improved feedback about a state of the wearable audio output device.

In some embodiments, the wearable audio output device detects (1252) the hand of the user entering a gesture region, and, in response to detecting the hand of the user entering the gesture region, activates a gesture detection state for the wearable audio output device, where the gesture is detected while the gesture detection state is active. For example, a gesture detection state is activated in FIG. 8F in response to detecting hand 824 entering gesture region 806. In some embodiments, the wearable audio output device detects the hand of the user exiting the gesture region, and, in response, disables the gesture detection state for the wearable audio output device. In some embodiments, the gesture detection state is activated for a threshold amount of time. In some embodiments, activating the gesture detection state includes enabling one or more sensors (e.g., image sensors, audio sensors, and/or other types of sensors) of the wearable audio output device. In some embodiments, the hand is detected entering the gesture region via a first type of sensor (e.g., a capacitive sensor, such as a capacitive sensor of the wearable audio output device) and the gesture is detected via a second type of sensor (e.g., an image sensor, such as an image sensor of the wearable audio output device). In some embodiments, the first type of sensor consumes less power than the second type of sensor. Activating gesture detection states in response to detecting a hand entering a gesture region enhances the operability of the wearable audio output device and makes the user-device interface more efficient, and reduces power usage and improves battery life of the wearable audio output device by being able to disable components (e.g., sensors) while outside of the predefined areas.

In some embodiments, the wearable audio output device detects (1254) a second gesture performed by the user's head, and, in response to detecting the second gesture, activates a gesture detection state for the wearable audio output device, where the gesture is detected while the gesture detection state is active. For examples, FIG. 8L-8M illustrate head gesture 841 being performed in FIG. 8L and a gesture detection state being active in FIG. 8M. In some embodiments, the wearable audio output device detects another gesture performed by the user's head, and, in response, disables the gesture detection state for the wearable audio output device. In some embodiments, the gesture detection state is activated for a threshold amount of time. In some embodiments, the second gesture comprises a head tilt and/or head shake. In some embodiments, the second gesture is detected by a first type of sensor (e.g., an accelerometer, such as an accelerometer of the wearable audio output device) and the gesture is detected by a second type of sensor (e.g., an image sensor, such as an image sensor of the wearable audio output device). In some embodiments, the first type of sensor consumes less power than the second type of sensor. Activating gesture detection states in response to head gestures enhances the operability of the wearable audio output device and makes the user-device interface more efficient, and reduces power usage and improves battery life of the wearable audio output device by being able to disable components (e.g., sensors) while outside of the predefined areas.

It should be understood that the particular order in which the operations in FIGS. 12A-12D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1000, 1100, and 1300) are also applicable in an analogous manner to method 1200 described above with respect to FIGS. 12A-12D. For example, the inputs, gestures, functions, and feedback described above with reference to method 1200 optionally have one or more of the characteristics of the inputs, gestures, functions, and feedback described herein with reference to other methods described herein (e.g., methods 1000, 1100, and 1300). For brevity, these details are not repeated here.

FIGS. 13A-13B are flow diagrams illustrating method 1300 for providing feedback indicating sensor(s) are occluded in accordance with some embodiments. Method 1300 is performed at a wearable device (e.g., wearable audio output device 301 such as earbuds, headphones, a headset, a necklace, or glasses) that includes one or more sensors (e.g., sensor(s) 311 such as image sensors, motion sensors, and/or other types of sensors) and optionally includes one or more audio output components (e.g., speaker(s) 306). In some embodiments, the wearable device is a headset, earbuds, necklace, headphones, glasses, or other type of wearable device. Some operations in method 1300 are, optionally, combined and/or the order of some operations is, optionally, changed.

As described below, method 1300 provides improved feedback about a state of a wearable device. Determining that sensor(s) are occluded and reporting the occlusion to the user allows the user to achieve an intended outcome and reduces errors when operating/interacting with the wearable device. Reducing errors reduces power usage and improves battery life and makes the user-device interface more efficient.

While a wearable device is being worn by a user, the wearable device detects (1302) the occurrence of one or more events that indicate that the device is in a context in which a respective sensor of the one or more sensors could be used to perform a respective operation. For example, FIG. 9A shows user 802 performing gesture 906 and speaking command 908 corresponding to occurrence of an event in which a sensor of wearable audio output device 301 could be used (e.g., to turn on light 910). In some embodiments, the occurrence of the one or more events is detected by the respective sensor. In some embodiments, the occurrence of the one or more events is detected at least in part by one or more sensors other than the respective sensor. In some embodiments, the occurrence of the one or more events includes an input that corresponds to a request (e.g., an explicit or implicit request) from the user to perform the respective operation. In some embodiments, the occurrence of the one or more events includes detecting that a context of the device corresponds to a situation in which performing the respective operation (e.g., based on information detected by the respective sensor) is likely to be helpful. In some embodiments, the context in which a respective sensor of the one or more sensors could be used to perform a respective operation comprises a scanning state of the wearable device in which the wearable device scans the physical environment in which the wearable audio output device is operating using the one or more sensors (e.g., to provide information about the physical environment in which the wearable audio output device is operating and/or suggestions based on the context).

In some embodiments, the respective operation is (1304) a discrete operation (e.g., an operation to turn on a light as illustrated in FIGS. 9A-9B). In some embodiments, a discrete operation involves a single output (e.g., an audio and/or haptic notification) in response to a user command (e.g., a query and a response). For example, the discrete operation is one-time (single) scan of the physical environment in which the wearable audio output device is operating. As another example, the discrete operation is a ‘one off’ or bounded operation. As another example, the discrete operation is to provide information about a real-world object (e.g., an object at which the user is pointing). Determining that sensor(s) are occluded and reporting the occlusion to the user in accordance with events in which discrete operations could be performed allows the user to achieve an intended outcome and reduces errors when operating/interacting with the wearable device. Reducing errors reduces power usage and improves battery life and makes the user-device interface more efficient.

In some embodiments, the respective operation is (1306) a continuous operation (e.g., the navigation assistance operation illustrated in FIGS. 9G-9K). In some embodiments, the continuous operation involves two or more outputs (e.g., a sequence of notifications and/or instructions) in response to a user command. In some embodiments, the continuous operation involves activating one or more sensors and providing feedback in accordance data from with the one or more of the activated sensors meeting one or more criteria. In some embodiments, performing a continuous operation comprises enabling a particular state, where the state is enabled for a predefined amount of time, and/or the state is enabled until disabled (e.g., disabled by a user via a second command). For example, the continuous operation is a scanning mode in which the wearable device identifies real-world objects and provides information. As another example, the continuous operation is a navigation assistance mode in which the wearable device provides navigation directions to a user as the user is traveling. Determining that sensor(s) are occluded and reporting the occlusion to the user during continuous operations allows the user to achieve an intended outcome and reduces errors when operating/interacting with the wearable device. Reducing errors reduces power usage and improves battery life and makes the user-device interface more efficient.

In some embodiments, the respective sensor is (1308) an image sensor (e.g., sensor(s) 311). For example, the respective sensor is a camera of the wearable device or other type of visual sensor. As an example, the image sensor may be located in the stem of an earbud or in the frame of a pair of glasses. As another example, the image sensor may be mounted to a casing of a pair of headphones. In some embodiments, the respective sensor is a low-resolution sensor and/or a low-fidelity sensor. In some embodiments, the wearable device does not retain or transmit images from the image sensor (e.g., analyzes and then discards the images). In some embodiments, the image sensor and/or the wearable device is configured to extract information about the physical environment in which the wearable audio output device is operating (e.g., to determine the context in which the respective sensor could be used to perform the respective operation) without storing the images. Determining that image sensor(s) are occluded and reporting the occlusion to the user allows the user to achieve an intended outcome and reduces errors when operating/interacting with the wearable device. Reducing errors reduces power usage and improves battery life and makes the user-device interface more efficient.

In some embodiments, the wearable device is (1310) an ear-worn device (e.g., wearable audio output device 301). For example, the wearable device is an ear-worn audio output device, such as an earbud or headphones. Being able to detect gestures via ear-worn devices simplifies the user-device interface.

In response to detecting the occurrence of the one or more events (1312), in accordance with a determination that the respective sensor is occluded, the wearable device provides (1314) feedback to the user indicating that the respective sensor is occluded (e.g., partially occluded or fully occluded). For example, FIGS. 9C-9D illustrate wearable audio output device 301 providing feedback 918 in accordance with wearable audio output device 301 being covered by hair of user 802. For example, the respective sensor may be at least partially occluded by clothing and/or hair of the user. In some embodiments, the wearable device determines that the respective sensor is occluded based on data from the respective sensor and/or data from another sensor of the one or more sensors.

In some embodiments, in accordance with the respective operation being a discrete operation, providing the feedback comprises (1316) providing a first type of feedback (e.g., feedback 918, FIG. 9D); and, in accordance with the respective operation being a continuation operation, providing the feedback comprises providing a second type of feedback (e.g., feedback 928, FIG. 9I), different than the first type of feedback. For example, different types of feedback are provided for continuous operations versus discrete operations. In some embodiments, one or more parameters of the first type of feedback are different than one or more parameters of the second type of feedback. Providing different types of feedback based on operation type provides improved feedback about a state of the wearable device.

In some embodiments, the feedback comprises (1318) audio and/or haptic feedback. For example, the wearable device provides a tone and/or vibration as the feedback. Providing audio/haptic feedback reduces the number of components needed in the wearable device (e.g., a display generation component is not needed), which reduces power usage and improves battery life of the wearable device.

In some embodiments, the occurrence of the one or more events comprises (1320) a user request from the user (e.g., command 914 to turn on light 910 in FIG. 9C), and the feedback comprises an error tone. For example, the user request is a request to provide information about a real-world object and the error tone is provided in accordance with a determination that the real-world object is occluded from the respective sensor. Determining that sensor(s) are occluded and reporting the occlusion to the user in response to user requests allows the user to achieve an intended outcome and reduces errors when operating/interacting with the wearable device. Reducing errors reduces power usage and improves battery life and makes the user-device interface more efficient.

In some embodiments, the feedback comprises (1322) verbal indication of an action the user can perform to correct the occlusion. For example, feedback 928 in FIG. 9I includes a suggestion that user 802 tuck their hair behind their ear. For example, the feedback indicates that the sensor is occluded by the user's hair and suggests that the user move their hair. In some embodiments, in accordance with a determination that the respective sensor has an error other than occlusion, the feedback comprises a suggestion the user can perform to correct the error. For example, the error may be a low lighting condition and the feedback may include a suggestion to increase the lighting. As another example, the wearable device may have insufficient charge to power the respective sensor and the feedback may include a suggestion to charge the wearable device. As another example, the respective sensor may be facing the wrong direction to perform the respective operation and the feedback may include a suggestion to adjust the orientation of the respective sensor. In some embodiments, the verbal indication includes information regarding which sensor is occluded (e.g., an indication of where the sensor is positioned). Providing a verbal indication of an action the user can perform to correct the occlusion enhances the operability of the wearable device and makes the user-device interface more efficient.

In response to detecting the occurrence of the one or more events (1312), in accordance with a determination that the respective sensor is not occluded, the wearable device performs (1324) the operation based on information detected by the respective sensor of the one or more sensors. For example, FIGS. 9A-9B illustrate wearable audio output device 301 turning on light 910 in accordance with sensor(s) of wearable audio output device 301 not being occluded.

In some embodiments, in accordance with a determination that an occlusion of the respective sensor is removed, the wearable device provides (1326) second feedback indicating that the occlusion is removed. For example, FIGS. 9E-9F illustrate wearable audio output device 301 providing feedback 922 in response to user 802 moving their hair behind their ear. For example, the second feedback is a success tone, different from an error tone indicating that the sensor is occluded. In some embodiments, the second feedback is non-verbal (e.g., consists of one or more tones). In some embodiments, in accordance with a determination that an error other than occlusion has been resolved, the second feedback indicates that the error has been resolved. Example errors include a low battery error, a low lighting error, and an incorrect orientation error. As an example, a first tone is used to indicate that the occlusion is removed, and a second tone is used to indicate that the error has been resolved. In some embodiments, the second feedback is different than the verbal indication of the action the user can perform to correct the occlusion. Providing feedback indicating that the occlusion is removed provides improved feedback about a state of the wearable device.

It should be understood that the particular order in which the operations in FIGS. 13A-13B have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 1000, 1100, and 1200) are also applicable in an analogous manner to method 1300 described above with respect to FIGS. 13A-13B. For example, the inputs, gestures, functions, and feedback described above with reference to method 1300 optionally have one or more of the characteristics of the inputs, gestures, functions, and feedback described herein with reference to other methods described herein (e.g., methods 1000, 1100, and 1200). For brevity, these details are not repeated here.

The operations described above with reference to FIGS. 10A-10D, 11A-11C, 12A-12C, and 13A-13B are, optionally, implemented by components depicted in FIGS. 1A-1D, 2, and/or 3A-3E. For example, detection operations 1002, 1102, and 1202, feedback operations 1026, 1128, and 1314 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1D, 2, and/or 3A-3E.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at a wearable audio output device:
while outputting audio content, detecting a gesture performed by a hand of a user of the wearable audio output device; and
in response to detecting the gesture:
in accordance with a determination that the gesture is detected within a respective distance of a side of the user's head and is a first type of hand gesture determined based at least in part on a shape of the hand during performance of the gesture, performing a first operation corresponding to the gesture; and
in accordance with a determination that the gesture is not the first type of hand gesture determined based at least in part on the shape of the hand during performance of the gesture, forgoing performing the first operation.

2. The method of claim 1, further comprising, in response to detecting the gesture and in accordance with a determination that the gesture is detected more than the respective distance of the side of the user's head, forgoing performing the first operation.

3. The method of claim 1, further comprising, in response to detecting the gesture and in accordance with a determination that the gesture is detected within the respective distance of the side of the user's head and is a second type of hand gesture determined based at least in part on the shape of the hand during performance of the gesture, performing a second operation corresponding to the gesture, wherein the second operation is different from the first operation.

4. The method of claim 3, including, in response to detecting the gesture and in accordance with a determination that the gesture is not the second type of hand gesture determined based at least in part on the shape of the hand during performance of the gesture, forgoing performing the second operation.

5. The method of claim 3, further comprising, in response to detecting the gesture and in accordance with a determination that the gesture is detected more than the respective distance of the side of the user's head, forgoing performing the second operation.

6. The method of claim 1, wherein the gesture comprises an air gesture.

7. The method of claim 1, wherein the gesture is detected via one or more image sensors.

8. The method of claim 1, wherein the gesture is detected by the wearable audio output device.

9. The method of claim 1, wherein the wearable audio output device is an ear-worn device.

10. The method of claim 1, further comprising:
detecting an end of the gesture, and
in response to detecting the end of the gesture, ceasing to perform the first operation.

11. The method of claim 10, wherein detecting the end of the gesture comprises detecting a change in the shape of the hand.

12. The method of claim 10, wherein detecting the end of the gesture comprises detecting the hand being further than the respective distance of the side of the user's head.

13. The method of claim 1, wherein the gesture comprises a cupping gesture.

14. The method of claim 1, wherein the gesture comprises an air pinch gesture.

15. The method of claim 1, wherein the gesture comprises a double air pinch gesture.

16. The method of claim 1, wherein the gesture comprises an air pinch and twist gesture.

17. The method of claim 1, wherein the gesture is detected within a gesture region.

18. The method of claim 17, further comprising:
detecting the hand of the user entering the gesture region; and
in response to detecting the hand of the user entering the gesture region, providing first feedback indicating that the hand has entered the gesture region.

19. The method of claim 17, further comprising:
detecting the hand of the user exiting the gesture region; and
in response to detecting the hand of the user exiting the gesture region, providing second feedback indicating that the hand has left the gesture region.

20. The method of claim 1, wherein the first operation comprises adjusting a volume of audio output at the wearable audio output device.

21. The method of claim 1, wherein the first operation comprises adjusting a magnitude of ambient sound from the physical environment.

22. The method of claim 1, wherein the first operation comprises adjusting playback of media content.

23. The method of claim 1, further comprising:
detecting the hand of the user entering a gesture region; and
in response to detecting the hand of the user entering the gesture region, activating a gesture detection state for the wearable audio output device, wherein the gesture is detected while the gesture detection state is active.

24. The method of claim 1, further comprising:
detecting a second gesture performed by the user's head; and
in response to detecting the second gesture, activating a gesture detection state for the wearable audio output device, wherein the gesture is detected while the gesture detection state is active.

25. A wearable audio output device, comprising:
one or more processors; and
memory storing one or more programs, wherein the one or more programs are configured to be executed by the one or more processors, the one or more programs including instructions for:
while outputting audio content, detecting a gesture performed by a hand of a user of the wearable audio output device; and
in response to detecting the gesture:
in accordance with a determination that the gesture is detected within a respective distance of a side of the user's head and is a first type of hand gesture determined based at least in part on a shape of the hand during performance of the gesture, performing a first operation corresponding to the gesture; and
in accordance with a determination that the gesture is not the first type of hand gesture determined based at least in part on the shape of the hand during performance of the gesture, forgoing performing the first operation.

26. A computer-readable storage medium storing one or more programs, the one or more programs comprising instructions that, when executed by a wearable audio output device, cause the wearable audio output device to:
while outputting audio content, detect a gesture performed by a hand of a user of the wearable audio output device; and
in response to detecting the gesture:
in accordance with a determination that the gesture is detected within a respective distance of a side of the user's head and is a first type of hand gesture determined based at least in part on a shape of the hand during performance of the gesture, perform a first operation corresponding to the gesture; and
in accordance with a determination that the gesture is not the first type of hand gesture determined based at least in part on the shape of the hand during performance of the gesture, forgo performing the first operation.
